(19) United States
(12) Patent Application Publication
(10) Pub. No.: US 2021/0373602 A1
(43) Pub. Date: Dec. 2, 2021

(54) FOLDABLE VIRTUAL REALITY DEVICE

(71) Applicant: Sang Kyu MIN, Seoul (KR)

(72) Inventor: Sang Kyu MIN, Seoul (KR)

(21) Appl. No.: 16/334,839

(22) PCT Filed: Sep. 22, 2017
(86) PCT No.: PCT/KR2017/010468

§ 371 Date: Nov. 6, 2020

(30) Foreign Application Priority Data
Sep. 22, 2016 (KR) 10-2016-0121606
Oct. 7, 2016 (KR) 10-2016-0129717
Nov. 2, 2016 (KR) 10-2016-0145190
Nov. 2, 2016 (KR) 10-2016-0145191
Nov. 18, 2016 (KR) 10-2016-0154214
Dec. 13, 2016 (KR) 10-2016-0169579
Jan. 20, 2017 (KR) 10-2017-0009755
Sep. 22, 2017 (KR) 10-2017-0122189

(51) Int. Cl. G06F 1/16; H04B 1/3827; H04M 1/02

(52) U.S. Cl. CPC G06F 1/1647; H04B 1/385; H04B 2001/3866; G06F 1/1624; H04M 1/0266

(57) ABSTRACT

A foldable virtual reality device is mounted on the section of the main body that includes the display and a side of the main body so that it can rotate, is switched in close-contact state with the front surface and the bottom surface of the main body, includes a screen member and a switching body that includes an ocular plate mounted to the screen member, moves the ocular plate between the close-contact state of the display and the ocular plate and the separation state maintaining a predetermined distance, and can implement virtual reality function by the display when the ocular plate is in separation state.

### TECHNICAL FIELD

The present invention is on a virtual reality device, more particularly, on a foldable virtual reality device in the form of a cell phone case in which modules capable of providing virtual reality experience are assembled.

### BACKGROUND ART

Virtual Reality refers to an interface between a human being and a computer that artificially create a certain environment or situation, allowing the user to feel as if they are actually interacting with the surrounding environment or situation. Virtual reality is also referred to artificial reality, cyberspace, virtual worlds, virtual environment, synthetic environment, artificial environment, augmented reality, mixed reality, and more.

The purpose of using virtual reality is to allow people to view and manipulate environment that is hard to experience on a daily basis. Applicable fields are education, remote controlling, remote satellite surface mapping, analysis of exploration data, and scientific visualization.

Recently, due to the widespread of smartphones, virtual reality is regaining attention. For example, there are Gear VR created jointly by SamSung and Occulus, LG's ‘G3 VR’, and Google's ‘cardboard’. These products allow the experience of virtual reality in conjunction with smart phone, and the price is cheaper than the preexisting VR device.

### DISCLOSURE OF THE INVENTION

### Technical Problem

The present invention provides a foldable virtual reality device that is portable and allows a virtual reality or augmented reality to be implemented right at a desired time and place.

More specifically, the present invention provides a cell phone case that includes a virtual reality function.

### Technical Solution

According to an exemplary embodiment of the present invention, a foldable virtual reality device converts to a main body including display and to a rotatable state mounted on a side of the main body adherent to the main body's front or back side. It also includes a screen member and an ocular plate mounted on the screen member, wherein the screen member in close contact with one side of the main body, moves the ocular plate between the state of close contact and the isolated state maintaining a small distance. When the ocular plate is in isolation condition, virtual reality function can be performed through display.

### Advantageous Effects

The foldable virtual reality device according to the present invention can be utilized as a portable device by combining the virtual reality module with a portable structure so that the virtual reality function can be performed regardless of the place and time. As the functions that can be performed by the virtual reality function increase, and the convenience of the user is also expected to improve.

In addition, when the main body is mounted reversibly, it is possible to use the device both as a general monitor and a virtual reality monitor in one display.

In addition, it is possible to form a structure in which the ocular plate can be maintained at a variable length from the main body by the screen member, and the light blocking screen function for blocking the inflow of external light by the same structure can be implemented at the same time, allowing high-quality slide movement and robustness to be obtained at the same time.

The effectiveness of this characteristic will double by forming the screen barrel into a double wall, and the user convenience will be further increased through the formation of the deflected air vents and the lightweight.

### BRIEF DESCRIPTION OF THE FIGURES

FIG. 1 is a perspective view of a folding virtual reality device and a cell phone attached thereto according to an embodiment of the present invention.

FIG. 2 is a dissected perspective view of the folding virtual reality device and the cell phone shown in FIG. 1.

FIG. 3 is a cross-sectional view of the folding virtual reality device and the cell phone of FIG. 1 in close contact with each other.

FIG. 4 is a cross-sectional view of the folding virtual reality device and the cell phone of FIG. 1

FIG. 5 is a sectional view illustrating a screen member of a folding virtual reality device according to an exemplary embodiment of the present invention.

FIG. 6 is a closeup sectional view illustrating a screen member of the folding virtual reality device according to an embodiment of the present invention.

FIG. 7 is a closeup side view illustrating a screen member of a folding virtual reality device according to an exemplary embodiment of the present invention.

FIG. 8 is a side view illustrating a folding virtual reality device according to an embodiment of the present invention.

FIG. 9 is rear perspective view illustrating a rear view of a folding virtual reality device according to an exemplary embodiment of the present invention.

FIG. 10 is a perspective view of a foldable virtual reality device according to an embodiment of the present invention and a cell phone installed on it.

FIG. 11 is a dissected perspective view showing the folding virtual reality device of FIG. 10 from the rear.

FIG. 12 is a side view of the folding virtual reality device of FIG. 10.

FIG. 13 is a sectional closeup view illustrating a configuration of a distance adjusting unit of the folding virtual reality device according to an exemplary embodiment of the present invention.

FIG. 14 is a perspective view illustrating a folding virtual reality device according to an embodiment of the present invention.

FIG. 15 is a side view for explaining the switching process of the folding virtual reality device of FIG. 14.

FIG. 16 is a side view for explaining the expansion state of the folding virtual reality device of FIG. 14.

FIG. 17 is a perspective view for explaining a folding virtual reality device according to an embodiment of the present invention.

FIG. 18 is a side view for explaining the switching process of the folding virtual reality device of FIG. 17.

FIG. 19 is a side view for explaining an expanded state of the folding virtual reality device of FIG. 17.

FIG. 20 is a perspective view for explaining a folding virtual reality device according to an embodiment of the present invention.

FIG. 21 is a side view for explaining the switching process of the folding virtual reality device of FIG. 20.

FIG. 22 is a side view for explaining an expanded state of the folding virtual reality device of FIG. 20.

FIG. 23 is a perspective view for explaining a folding virtual reality device according to an embodiment of the present invention.

FIG. 24 is a side view for explaining the switching process of the folding virtual reality device of FIG. 23.

FIG. 25 is a side view for explaining the expansion state of the folding virtual reality device of FIG. 23.

FIG. 26 is a closeup sectional view for explaining a folding virtual reality device according to an embodiment of the present invention.

FIG. 27 is a closeup sectional view for explaining the operation of the folding virtual reality device of FIG. 26.

FIG. 28 is a closeup sectional view for explaining a folding virtual reality device according to an embodiment of the present invention.

FIG. 29 is a sectional view illustrating a folding virtual reality device according to an embodiment of the present invention.

FIG. 30 is a sectional view for explaining a folding virtual reality device according to an embodiment of the present invention.

FIG. 31 is a sectional view illustrating a folding virtual reality device according to an embodiment of the present invention.

FIG. 32 is a sectional view illustrating a folding virtual reality device according to an embodiment of the present invention.

FIG. 33 is a perspective view illustrating a folding virtual reality device according to an embodiment of the present invention.

FIG. 34 is a side view for explaining the operation of the screen member in the folding virtual reality device of FIG. 33.

FIG. 35 is a side view for explaining an expanded state of the folding virtual reality device of FIG. 33.

FIG. 36 is a perspective view for explaining a folding virtual reality device according to an embodiment of the present invention.

FIG. 37 is a back view illustrating a folding virtual reality device according to an embodiment of the present invention.

FIG. 38 is a perspective view of a folding virtual reality device according to an embodiment of the present invention.

FIG. 39 is a perspective view of a folding virtual reality device according to an embodiment of the present invention.

FIG. 40 is a perspective view for explaining a folding virtual reality device according to an embodiment of the present invention.

FIG. 41 is a side view for explaining an example of use of the folding virtual reality device of FIG. 40.

FIG. 42 is a perspective view for explaining a folding virtual reality device according to an embodiment of the present invention.

FIG. 43 is a perspective view showing a screen member in a folding virtual reality device according to an embodiment of the present invention.

FIG. 44 is a perspective view for explaining a state in which the ocular plate is moved inward in the folding virtual reality device of FIG. 43.

FIG. 45 is a perspective view illustrating a closed state of a folding virtual reality device according to an embodiment of the present invention.

FIG. 46 is a perspective view flow chart illustrating the process of switching the folding virtual reality device of FIG. 45.

FIG. 47 illustrates a case where the folding virtual reality device of FIG. 45 is in a full state.

FIG. 48 is a back view for explaining a folding virtual reality device according to an embodiment of the present invention.

FIG. 49 is a view for explaining a folding virtual reality device according to an embodiment of the present invention.

FIG. 50 is a view for explaining the operation mechanism of the folding virtual reality device of FIG. 49.

FIG. 51 is a side view block diagram illustrating a folding virtual reality device according to an embodiment of the present invention.

FIG. 52 (a) illustrates a folding virtual reality device according to an embodiment of the present invention.

FIG. 52 (b) shows the folding virtual reality device of FIG. 52 (a).

FIG. 53 is a cross-sectional view of the folding virtual reality device of FIG. 52 and the cell phone in close contact with each other.

FIG. 54 is a sectional view for explaining the separation state of the folding virtual reality device of FIG. 52.

FIG. 55 is a side view of a folding virtual reality device according to an embodiment of the present invention.

FIG. 56 is a plan view of the folding virtual reality device of FIG. 55.

FIG. 57 is a perspective view of a folding virtual reality device according to an embodiment of the present invention.

FIG. 58 is a perspective view of the folded virtual reality device of FIG. 57.

FIG. 59 is a side view for explaining an expanded state of the folding virtual reality device of FIG. 57.

FIG. 60 is a view showing a screen member of the folding virtual reality device according to an embodiment of the present invention.

FIG. 61 is a view illustrating a screen member of the folding virtual reality device according to an embodiment of the present invention.

FIG. 62 is a view illustrating a screen member of the folding virtual reality device according to an embodiment of the present invention.

FIG. 63 is a side view that shows a state in which the foldable virtual reality device is used according to an embodiment of the present invention.

FIG. 64 is a rear perspective view block diagram of a folding virtual reality device according to an embodiment of the present invention.

FIG. 65 is a side view for explaining a folding virtual reality device according to an embodiment of the present invention.

FIG. 66 is a front perspective view illustrating a storage state of a foldable virtual reality device, according to an embodiment of the invention.

FIG. 67 is a side view for explaining a display state of the folding type virtual reality device of FIG. 66.

FIG. 68 is a rear perspective view for explaining the display state of the folding type virtual reality device of FIG. 66.

FIG. 69 is a rear perspective view for explaining a folding-type eye blinker formed on an ocular plate of a folding type virtual reality device according to an embodiment of the present invention.

FIG. 70 is a rear perspective view for explaining a state in which the folding-type eye blinker of FIG. 69 is folded.

FIG. 71 is a side view for explaining a foldable virtual reality device according to an embodiment of the present invention.

FIG. 72 is a perspective view illustrating a folding type virtual reality device according to an embodiment of the present invention.

FIG. 73 is a sectional view for explaining the operation of the bottom cover in the folding type virtual reality device of FIG. 72.

FIG. 74 is a perspective view for explaining a side screen, an ocular plate and a bottom cover which are folded at the same time among folding type virtual reality device according to an embodiment of the present invention.

FIG. 83 is a view for explaining a modification process of the portable virtual reality device of FIG. 81.

FIG. 84 is a view showing the nose receiving part in the portable virtual reality device according to the embodiment of the present invention.

FIG. 85 is a side view of a portable virtual reality device according to an embodiment of the present invention.

FIG. 86 is a view for explaining a portable state of a portable virtual reality device according to an embodiment of the present invention.

FIG. 87 is a view for explaining the stereoscopic state of the portable virtual reality device of FIG. 86.

FIG. 88 is a view for explaining a portable virtual reality device according to an embodiment of the present invention.

FIG. 89 is a block diagram showing a configuration of a flexible terminal device according to an embodiment of the present invention. 90 is a view for explaining the basic structure of a display unit constituting a flexible terminal device according to an embodiment of the present invention.

FIGS. 91 to 93 are views for explaining an example of a method of detecting a form transformation in a flexible terminal device according to an embodiment of the present invention.

FIGS. 94 and 95 are views showing an example of a terminal device according to an embodiment of the present invention.

FIGS. 96 to 98 are views for explaining a case where a display extension is performed in the terminal device of the present invention.

FIGS. 99 and 100 are views showing a support plate drawn out together with a sliding member according to an embodiment of the present invention.

FIG. 101 is a view showing a sliding member and a support plate according to an embodiment of the present invention.

FIG. 102 is a view showing a configuration for supporting a second display unit according to another embodiment of the present invention.

FIGS. 103 and 104 are views showing a case where the VR means is configured according to another embodiment of the present invention.

FIGS. 105 to 109 are views for explaining a screen fixing means constituted inside the screen box of the VR means according to the embodiment of the present invention.

FIG. 110 (a) is a view showing a virtual present cell phone case including a screen fixing means according to an embodiment of the present invention.

FIG. 110 (b) is a side view of the virtual reality cell phone case shown in FIG. 110 (a).

FIGS. 111 to 115 are diagrams illustrating various embodiments of the present invention.

FIG. 116 is a view illustrating a configuration of a terminal device according to another embodiment of the present invention.

FIG. 117 is a view illustrating the structure of Deep Neural Networks (DNN).

FIG. 118 is a view illustrating the structure of Convolutional Deep Neural Networks (CNN).

FIG. 119 is a view illustrating a process of calculating a product.

FIG. 120 is a view illustrating a sub-sampling process.

FIG. 121 is a view illustrating a drone and a protective case according to an embodiment.

FIG. 122 is a view for explaining a method of compositing an object and a background according to an embodiment.

### BEST MODE

According to an exemplary embodiment of the present invention, a foldable virtual reality device converts to a main body including display and to a rotatable state mounted on a side of the main body adherent to the main body's front or back side. It also includes a screen member and an ocular plate mounted on the screen member, wherein the screen member in close contact with one side of the main body, moves the ocular plate between the state of close contact and the isolated state maintaining a small distance. When the ocular plate is in isolation condition, virtual reality function can be performed through display.

The folding virtual reality device according to the present invention can include a cell phone function by adding a voice communication module, but can also be connected to the outside via another wired/wireless network without voice communication module, or may include only a virtual reality or augmented reality function. Foldable virtual reality device is portable and can be used as a general cell phone or a handset, that can also perform a virtual reality function regardless of place and time. For example, various operating systems such as Android, Windows, Linux, and OPENELEC can be used as an operating system for the folding virtual reality device. Even when the folding virtual reality device is not irrelevant to the virtual reality function, applications such as communication, messaging, multimedia, map, game can be stored and driven. It is also possible to modify and operate the virtual application or the augmented reality while driving a general application.

As the functions that can be implemented by the virtual reality function are increased, the effectiveness of the virtual reality function will also be increased. However, carrying a separate device like the conventional, the needs would not be fully satisfied.

Accordingly, it is an object of the present invention to provide a structure in which a screen member can hold an ocular plate of a variable length from a main body, and at the same time the screen member includes a number of screen boxes which are stacked and fixed to each other while being rearwardly moved, blocking the inflow of external light.

In the present specification, the expression “rearward” or “rearward” can be understood as the direction toward the user's face when the folding virtual reality device is driven.

In the folder type virtual reality device, the screen member can switch the ocular plate into a close contact state and a separated state through methods such as volume reduction, enlargement, fixation, movement, separation and folding. In order to facilitate portability, the screen member can be maintained in reduced, folded or fixed state.

In addition, although the screen member can be operated manually, it can also be operated through electric signals, and by a power transmission device.

The virtual reality function using the display of the main body and the ocular plate in the separated state can be implemented in various ways. For example, a stereoscopic effect can be performed by dividing a virtual reality display into left and right and using a pair of ocular lenses as in a conventional card board, but it is also possible to divide and display an image up and down according to a virtual reality system. In addition, polarizing glasses for mounting a polarizing lens on an ocular plate or a shutter glass for opening and closing left and right ocular lenses on an ocular plate with a time difference can be applied to the present invention. In addition to virtual reality implementation or stereoscopic display, various combinations of display and lens combinations can be implemented.

While not using the virtual reality feature, it is necessary that the ocular plate maintain close contact with the main body, and while using the virtual reality function, it should be separated by the main body, maintaining the predetermined distance. For this purpose, the ocular plate should be able to form a variable distance rather than being fixed to the main body. To this end, the screen member can move the ocular plate between the attached and detached states in a variety of ways.

For example, the screen member can be embodied as plural screen barrel, and the mutual frictional and clamping forces of the screen barrels can be utilized to maintain the spacing between the display and the contact plate of the inverted main body, blocking the outer light. Alternatively, a screen member may be interposed between the main body and the ocular plate moving the ocular plate between the close contact state and the separated state and can also additionally provide a shield for blocking the inflow of external light.

When the screen member is performed as a screen barrel, the screen barrel may be formed as a single wall structure, but it can also be provided with a double wall structure for a solid support and light weight. That is, for the double wall structure, the screen barrel may include an inner wall and an outer wall, with a minimum space formed in between.

In addition, in order to solve heat and electromagnetic waves generated from the virtual reality display, ventilation holes may be formed in the screen barrel. However, since light can directly enter from the outside through the ventilation hole, a first ventilation hole is formed in the inner wall of the screen barrel of the double wall structure, and a second ventilation hole is formed in the outer wall. Thus, the first ventilation hole and the second ventilation hole do not overlap, in other words are dislocated in order to prevent light from directly entering from the outside.

Since the screen member only serves the purpose of effectively blocking external light, it is also possible to partially open while not distracting its original function in addition to completely blocking the main body and the ocular plate.

In order to more realistically perform the virtual reality function, the virtual reality device may further include a fixing member capable of fixing the virtual reality device to the user's face. The fastening member may be provided in various forms such as an earring form of a conventional mask, a hook portion of a spectacle, a helmet mount or an elastic band.

The switching body is rotatable on either side of the long side and the short side of the main body. The switching body can be closely attached to the display while rotating around one side of the main body according to the user's need, and the virtual reality function can be performed while expanding the ocular plate in a separated state.

In the present embodiment, the “display” may be one of the displays mounted on the main body, or may be a display installed in front of the main body, and may be added to the virtual reality or augmented reality.

According to an exemplary embodiment of the present invention, a foldable virtual reality device includes a main body including a display and guide rails formed side by side; and a switching body which is slidably mounted on a guide rail of the main body and is switched into a state of close contact with a front surface and a rear surface of the main body. The screen member and a tilting plate mounted on the screen member, moves the ocular plate between an adhering state in which the ocular plate is closely attached to the display and a detached state in which the ocular plate maintains a predetermined distance. In a state in which the ocular plate is detached to the surface of the main body, the virtual reality function can be performed through the display.

The guide rail may be formed along a long side surface or a short side surface of the main body, and the changeover body may be detached from the main body and then converted to the front or rear surface of the main body and reinstalled in the main body.

According to an exemplary embodiment of the present invention, a foldable virtual reality device includes: a main body including a display; and a switching body which is switched to a state of being in close contact with the front and rear surfaces of the main body, and a screen member and a ocular plate mounted on the screen member, wherein the switching body is slidable and rotatable with respect to the main body. The main body of the display can be switched between the front face and the back face of the main body and the screen body can be switched between a close state in which the contact plate is in close contact with the display, moving the ocular plate between states and when the ocular plate is in a separated state, performs the virtual reality function through display.

The folding type virtual reality device may further include a rail body rotatably mounted on the main body and coupling the switching body to allow sliding movement, and the rail body may be mounted on the long side or the short side of the main body.

According to an exemplary embodiment of the present invention, a collapsible virtual reality device comprises: a main body including a display; and a switching body which is detached and attached to the front and back surfaces of the main body, and a screen member and an ocular plate mounted on the screen member. The ocular plate is moved between a close contact state in which the ocular plate is closely attached to the display and a separate state in which a predetermined distance is maintained, and when the ocular plate is in a detached state, a virtual reality function can be performed through the display.

The switching body can use at least one from the detachable button, magnet button, coupling projection-groove structure, or a suction plate to be detachably attached to the main body

According to an exemplary embodiment of the present invention, a foldable virtual reality device includes a main body; a pair of image emitting units formed on one surface of the main body; and an ocular lens mounted at a close distance to each angle of the image emitting unit, performing virtual reality function through the image emitting unit. may

Here the image emitting unit can be a display or a projector. In the case of display, the image can be played at a high resolution, and in the case of a projector, a function of projecting a specific image toward the retina can be performed.

The image emitting unit and the ocular lens can maintain a fixed distance and can keep the device thin and compact. The image emitting unit and the ocular lens can be configured to have a barrel member for accommodating the image emitting unit and the ocular lens to correspond to the facial structure. The barrel member may also be formed withdrawable from the main body.

The ocular lens may further include an ocular lens mounted on the ocular lens. The ocular lens may be switched between a flat state in which the ocular lens is in close contact with the main body and a bending state corresponding to the user's eye. The shape can be changed by using a shape modification by a shape memory alloy, the deformation of the tube structure due to air entering, or an electric application.

According to an exemplary embodiment of the present invention, a foldable virtual reality device includes a main body including a virtual reality display; an ocular plate capable of maintaining a variable distance from the main body; and a screen member which is interposed between the main body and the ocular plate and moves the ocular plate between a state in which the ocular plate is in close contact with the main body and a state in which the ocular plate maintains the predetermined distance. The shape of the ocular plate can be changed to move the ocular plate in an adhering state or in an idle state through the entry and exit of air through the air tube. When the ocular plate is in a separated state, a virtual reality function can be performed through the main body's virtual reality display.

The screen member may further include a bi-directional pump for automatically introducing air into the screen member, wherein the screen member may be formed as a closed tube space between the display and the screen member. The inner space may be formed as a closed tube space to be expanded or contracted, or the flow path space partially formed in a frame shape among the screen members may be formed as a closed tube space to be expanded or contracted.

Apart from this, the screen member may be provided as a left and right binocular shape, and the ocular plate may be provided independently from the left and right in correspondence with the separated screen member.

According to an exemplary embodiment of the present invention, a foldable virtual reality device comprises: a main body including a virtual reality display; A ocular plate capable of maintaining a variable distance from the main body; And a screen member interposed between the main body and the ocular plate and moving the ocular plate between a state in which the ocular plate is closely contacted with the main body and a state in which the ocular plate maintains a predetermined distance. The shape of the ocular plate can be changed so that the ocular plate is moved in an adhering state or in a spaced state while the pieces are folded together. When the ocular plate is in a separated state, a virtual reality function can be realized through a realistic display. Here, the screen member may be formed using paper or a synthetic resin panel.

According to an exemplary embodiment of the present invention, a foldable virtual reality device comprises: a main body including a virtual reality display; An ocular plate capable of maintaining a variable distance from the main body; And a screen member interposed between the main body and the ocular plate, the ocular lens member moving the ocular plate between a state in which the ocular plate is in close contact with the main body and a state in which the ocular plate maintains the predetermined distance; Wherein the screen member is provided using a roll screen and, when the ocular plate is in a separated state, the virtual reality function can be implemented through the virtual reality display of the main body. The roll shed may be provided in a plurality, and the ends of the roll shed may also be provided to partially overlap.

According to an exemplary embodiment of the present invention, a foldable virtual reality device includes: a main body including a virtual reality display; A ocular plate capable of maintaining a variable distance from the main body; And a screen member interposed between the main body and the ocular plate, the ocular lens member moving the ocular plate between a state in which the ocular plate is in tight contact with the main body and a state in which the ocular plate maintains the predetermined distance; Wherein the ocular plate or the screen member includes an indentation corresponding to a user's nose and can implement a virtual reality function through a virtual reality display of the main body when the ocular plate is in a spaced apart state.

The main body may include at least one camera module mounted on a surface facing the virtual reality display, and may be implemented by adding an augmented reality.

The screen member may include a plurality of screen barrels which are stacked and fixed to each other while being superposed on each other, and scratch may be formed in the screen barrel corresponding to the indentations.

Here, the screen barrel may be formed in a double wall structure including an inner wall and an outer wall spaced from the inner wall, the screen box having a double wall includes a first vent hole formed on the inner wall and a second vent hole formed on the outer wall. The first ventilation hole and the second ventilation hole are formed so as to be shifted from each other, thereby blocking light from entering from the outside.

The screen member is interposed between the main body and the ocular plate and is provided between the main body and the ocular plate for moving the ocular plate between the contact state and the separated state, and a light blocking screen to block the entry of light.

As described above, the ventilation hole can be formed in the screen member, but the ventilation hole can also be formed in the ocular plate.

According to an exemplary embodiment of the present invention, a foldable virtual reality device comprises: a main body including a virtual reality display; An ocular plate capable of maintaining a variable distance from the main body; A screen member interposed between the main body and the ocular plate and moving the ocular plate between a state in which the ocular plate is in close contact with the main body and a state in which the ocular plate maintains a predetermined distance; And a central band extending from a side of the main body or ocular plate and a central band extending from a central upper portion of the main body or ocular plate and partially fixed to the horizontal band for fixing the main body and the ocular plate to the user & ; And when the ocular plate is in a separated state, the virtual reality function can be performed through the display of the main body.

The ends of the center bands branch in a Y-shape to form the first branch line and the second branch line, and the ends of the branched first branch line and the second branch line can be fixed to horizontal bands, respectively. The center band may include at least one tension line transversely connecting the first branch line and the second separation line.

The screen members may include a plurality of screen barrels which are stacked and fixed back to each other overlaid with one another, and the horizontal and the center bands can be withdrawn from being built into the main body or eye plate.

According to an exemplary embodiment of the present invention, a foldable virtual reality device includes a main body including a virtual reality display; An ocular plate capable of maintaining a variable distance from the main body and incorporating a battery for operating the main body; And a screen member interposed between the main body and the ocular plate and moving the ocular plate between the main body and the ocular plate, wherein the ocular plate is in close contact with the ocular plate; And when the ocular plate is in a separated state, a virtual reality function can be performed through the display of the main body.

Here, the ocular plate may further include at least one from camera, a main board, and an antenna for a folding virtual reality device, and may include a fixing member for temporarily fixing the folding virtual reality device to the user's face.

According to an exemplary embodiment of the present invention, a foldable virtual reality device includes a main body including a virtual reality display; An ocular plate capable of maintaining a variable distance from the main body; And a screen member which is interposed between the main body and the ocular plate, and moves the ocular plate between the main body and the ocular plate in a close contact state in which the ocular plate is closely contacted and in a separated state in which the predetermined distance is maintained, The ocular plate moves together when the screen member is switched to the extended state, and when the screen member is in the extended state, the ocular plate moves along the screen member in a state where the screen member is extended. It is possible to move and fix back and forth inside, and when the ocular plate is in a separated apart state, the virtual reality function can be performed through the display of the main body.

The ocular plate or the screen member may further include an indentation corresponding to the nose of the user, and the screen member may include a plurality of screen barrels which are stacked and fixed to each other while being rearwardly interlaced.

According to an exemplary embodiment of the present invention, a foldable virtual reality device comprises: a main body including a virtual reality display; An ocular plate capable of maintaining a variable distance from the main body while moving between a close contact state in which the main body is closely contacted and a separated state in which a small positive distance is maintained; And the main body is mounted on the rear edge of the main body so that it can rotate and covers the ocular plate in a close-contact state in a ‘closing’ state and to block light entering between the ocular plate and the main body in a separated state in the ‘blooming’ state, and a display unit including a plurality of flip covers, wherein when the ocular plate is in a separated state, a virtual reality function can be performed through a display of the main body.

In the present invention, the flip cover can be opened in full with the ocular plate, in the process of moving the ocular plate away from the user. Alternatively, after the flip cover is opened in a fully opened state, the plate may be moved in a separated state under the guidance of the flip cover in full bloom.

The screen member may further include a support shaft to support a shielding film, and a shielding film for shielding gaps between the flip covers in a full state, wherein the corners of the ocular plate are supported by a support shaft. The slide can be engaged. and the ocular plate can be guided by the support shaft or moved apart with the support shaft as described above.

According to an exemplary embodiment of the present invention, a foldable virtual reality device includes a main body including a virtual reality display; An ocular plate capable of maintaining a variable distance from the main body while moving between a close contact state in which the main body is closely contacted and a separated state in which a predetermined distance is maintained; And a screen member including a first side body connecting one side of the main body and the ocular plate, and a second side body connecting the main body and the other side of the ocular plate, wherein the main body, the ocular plate and the second side body are connected in order to form a closed folding structure, and when the ocular plate is in close contact, the inner surface of the main body, the first side body, the ocular plate, wherein the main body, the first side body, the eyelet plate, and the second side body form square pillars to maintain a cubic shape when the ocular plate is in a separated state, Virtual reality functions can be performed through the display of the main body.

The screen member may further include a folding lid to block the plane, and bottom of the open square pillar in the separated state, and may be configured to block the open face facing the instant at the same time as the folding box.

At least one of the first side body and the second side body should be provided with a speaker, a secondary display or a keyboard to enable various uses of the side body.

According to an exemplary embodiment of the present invention, a foldable virtual reality device includes a main body including a virtual reality display; A ocular plate capable of maintaining a variable distance from the main body while moving between a close contact state in which the main body is closely contacted and a spaced state in which a small positive distance is maintained; and a spring support structure for elastically supporting a light shielding film and a light shielding film blocking the main body and the ocular plate, wherein when the ocular plate is in a separated state, the virtual reality function can be performed.

The light shielding film may be formed using cloth, span, silicon thin film, or the like capable of blocking light, and may be provided in the form of a hollow column or a truncated cone. The spring support structure may be formed to correspond to the entire cross-sectional shape of the light blocking film and may be formed to support the inner or outer surface of the light blocking film as a whole, and may include a plurality of springs provided in a long column shape inside the light blocking film, or may be formed to support the light blocking film at a plurality of points.

According to an exemplary embodiment of the present invention, a foldable virtual reality device comprises: a main body including a virtual reality display; An ocular plate capable of maintaining a variable distance from the main body while moving between a close contact state in which the main body is closely contacted and a separated state in which a small positive distance is maintained; And a screen member made of a foam material interposed between the main body and the ocular plate. When the ocular plate is in a separated state, a virtual reality function can be performed through the display of the main body.

The screen member may be formed of various foamable materials such as sponge or memory foam and is compressed between the ocular plate and the main body when the ocular plate is in close contact with the ocular plate and is separated from the main body so that the compressed screen member can be restored to its original shape and the inside can be returned to the hollow shape.

According to an exemplary embodiment of the present invention, the protective case for implementing the implantable virtual reality device may further include a main frame for detachably adapt the main body.

According to another exemplary embodiment of the present invention, a foldable virtual reality device includes a main body, an ocular plate capable of maintaining a variable distance from the main body, a main body disposed between the main body and the ocular plate, a distance adjusting member which moves the ocular plate between a close contact state in which the ocular plate is in close contact and a separate state in which the ocular plate is kept in a predetermined distance, a distance adjusting member which is extended from the ocular plate in the separated state, a screen member that forms a darkroom space in front of the plate, and a virtual reality display mounted on the front surface of the screen member opposite the ocular plate and for performing a virtual reality function through the darkroom space.

The folding virtual reality device according to the present invention may include a cell phone function by adding a voice communication module, but may also be connected to an external unit through another wired/wireless network without a voice communication module, which allows functions such as watching videos, listening to music, maps, finances, and more. Of course, it is possible to include only virtual reality or augmented reality functions without the above separate functions. The foldable virtual reality device is portable and can be used as a general cell phone or a terminal device, and can perform a virtual reality function regardless of place and time.

Although the utility of the virtual reality will increase due to the increase in the functions that can be performed through the virtual reality function, it is not possible to carry such a necessity by carrying a separate auxiliary device like the conventional one.

Accordingly, it is possible to form a structure capable of maintaining a variable length of the ocular plate from the main body by the distance adjusting member, wherein the screen member is extended from the ocular plate to form a dark room capable of performing a virtual reality function, a virtual reality display can be mounted in front of the member.

The screen members may simultaneously include a plurality of screen barrels which are slide-moved and fixed backward while being superimposed on each other, thereby functioning as a light shielding screen for shielding the inflow of external light.

The virtual reality function using the display of the main body and the ocular plate in the separated state can be implemented in various ways. For example, a stereoscopic effect can be realized by dividing a virtual reality display into left and right and using a pair of ocular lenses as in a conventional card board, but it is also possible to divide and display an image up and down according to a virtual reality system. In addition, polarizing glasses for mounting a polarizing lens on an ocular plate or a shutter glass for opening and closing left and right ocular lenses on an ocular plate with a time difference can be applied to the present invention. Moreover, a variety of display and lens combinations for virtual reality implementations and stereoscopic displays can be performed.

The ocular plate must maintain close contact with the main body while not using the virtual reality function, and should be able to maintain a predetermined distance separated from the main body while using the virtual reality function. For this purpose, the ocular plate should be able to form a variable distance rather than being fixed with respect to the main body. To this end, the distance control member can be adjusted in distance using an expandable antenna structure, an air tube, a foldable link, and the distance control member can be operated manually or by a hydraulic cylinder, a pneumatic cylinder, It is also possible to automatically operate using a memory metal or the likes of it.

The screen member may be embodied as several screen barrels, which can maintain the distance between the virtual reality display and the ocular plate using mutual friction and clamping forces of the screen barrels. Alternatively, the screen member may be interposed between the main body and the ocular plate and may separately have a light shielding screen to shield the inflow of external light.

When the screen member is presented as a screen barrel, the screen barrel may be formed as a single wall structure, but it can also be provided with a double wall structure for a solid support structure and light weight. That is, for the double wall structure, the screen barrel may include an inner wall and an outer wall, and a minimum space may be formed between the inner and the outer wall.

Since the screen member only effectively blocks external light for immersion, it is also possible to partially open the line which does not undermine its original function in addition to completely blocking the darkroom space.

According to an exemplary embodiment of the present invention, a foldable augmented reality device includes a main body, an ocular plate capable of maintaining a variable distance from the main body, a main body having a main body and an ocular plate, a distance adjusting member for moving the ocular plate between a close contact state in which the plate is in close contact with a predetermined distance and a distance maintaining state in which the plate is in close contact with the ocular plate, a camera module mounted on at least one of the main body and the ocular plate and mounted on the front surface of the screen member in opposition to the ocular plate and configured to enhance the augmented reality function through the darkroom space.

According to an exemplary embodiment of the present invention, the folding image viewing device includes a main body, an ocular plate capable of maintaining a variable distance from the main body, a main body, and an ocular plate interposed between the main body and the ocular plate, a distance adjusting member for moving the ocular plate between a contact state in which the ocular lens is in close contact with the ocular lens body and a separated state in which the ocular lens holder maintains a predetermined distance between the ocular lens body and the ocular lens body, and a display mounted on the front surface of the screen member facing the ocular plate.

In accordance with another exemplary embodiment of the present invention, a foldable virtual reality device is also referred to as a collapsible virtual reality device, and the collapsible virtual reality device includes a main body including a virtual reality display, and an ocular plate connected to the other end of the rear cover so that it can rotate, wherein the ocular plate is folded on the inner surface of the rear cover, in the display state in which the rear cover and the ocular plate are opened, the ocular plate is spaced a predetermined distance from the virtual reality display of the main body, thereby performing the virtual reality function.

The user can use the virtual reality device according to the present embodiment for various purposes. The folding type virtual reality device includes at least one display and drives various applications so that the functions of a conventional cell phone or a terminal device can be performed. That is, it can be used as a general cell phone or a multimedia device in a storage state. The user can then transform the display into a display state that performs the virtual reality by unfolding the back cover and the ocular plate. In this case, the virtual reality display is placed opposed to the ocular plate, and the virtual reality function can be performed through the ocular lens of the ocular plate.

In order to form a darkroom space between the main body and the ocular plate in the display state, a bellows type arc screen interposed between the rear cover and the main body may be further included.

In addition, it may further include a rear cover and a side screen covering the side surface of the main body, wherein the side screen is folded between the back cover and the main body in the storage state forming a dark space between the plates.

Here, the side screen may be connected to the side of the ocular plate, and the ocular plate and the side screen may be unfolded at the same time as the screen is switched from the storage state to the display state.

It may further include a bottom cover that covers the bottom of the darkroom space in the display state, and the bottom cover may be connected to the main body or the ocular plate one against the bottom cover so that it can rotate, and it can support between the ocular plate and the main body while one side is hung on the main body.

A foldable blinker may be mounted on the ocular plate to block external light from entering the user's eyes. Although the foldable blinker can be provided in various forms, it can be kept in a thinly adhered state in the storage state, and expanded or deformed to the intended shape in the display state, thereby effectively shielding the external light.

For example, the foldable vehicle compartment includes an upper plate for blocking the upper portion around the eyes, a side plate for blocking the side surface around the eyes, and a lower plate for blocking the lower portion around the eyes, making it possible to have a tendency to elastically overlap the rear surface of the ocular plate by using a structure such as a spring mounted on the hinge. The side plates are extended to support the space between the upper and lower plates to form a three-dimensional structure of the foldable vehicle compartment. In order to switch to storage state, the upper and lower plates are folded to the rear of the ocular plate, allowing the lower plate to be folded together.

According to an exemplary embodiment of the present invention, a foldable augmented reality device includes a main body including a display and at least one camera module, a rear cover connected at one end to the main body so that it can rotate, and the ocular plate that is kept in a folded state on the back surface of the main body together with the back cover in a folded state on the inner surface of the back cover so that the back cover and the ocular plate is in the unfolded display state, and the ocular plate is spaced a predetermined distance from the display of the main body, thereby realizing the augmented reality function.

According to an exemplary embodiment of the present invention, a folding type image viewing device includes a main body including a display, a rear cover connected at one end to the main body so that it can rotate, and a rear cover connected to the other end of the rear cover so that it can rotate wherein the ocular plate is kept in a folded state on the back surface of the main body together with the back cover in a folded state on the inner surface of the back cover and the back cover and the ocular plate are stored in the unfolded display state, that may be spaced a predetermined distance from the display of the main body.

According to an exemplary embodiment of the present invention, a foldable virtual reality device includes a main body including a virtual reality display, a back cover having one end connected to the main body so that it can rotate, a back cover interposed between the back cover and the main body, and an ocular plate provided on one side of the arc-shaped screen, wherein the ocular plate is in a state of being kept in tight contact with the back surface of the main body together with the rear cover in a state of being in tight contact with the inner surface of the rear cover in the display state in which the rear cover and the ocular plate are opened, the ocular plate can be separated from the main body of the virtual reality display by a predetermined distance to perform the virtual reality function.

According to another exemplary embodiment of the present invention, the virtual reality device is configured to be portable and may include a flexible display. A portable virtual reality device including a flexible display includes a flexible display on the front side and a virtual reality display on the rear side, a main body that is deformable in three dimensions along with a flexible display, and an ocular lens for the virtual reality function, and an ocular plate having a function of being detached and maintaining a predetermined distance from the virtual reality display corresponding to the main body.

According to one exemplary embodiment of the present invention, a portable virtual reality device including a flexible display includes a main body that includes a flexible display on the front side and a virtual reality display on the back side, and a sterically deformable side with the flexible display, and an ocular plate including an ocular lens for a virtual reality function and corresponding to a three-dimensionally deformed main body, the ocular plate having a function of maintaining a predetermined distance from the virtual reality display, a holding function and a variable function, and the virtual reality display of the main body is deformed in three dimensions so as to bend the main body so as to face the ocular lens of the ocular plate and is connected to the other side of the main body and the other side of the ocular plate that includes more connection bodies in a way so that it can fold. The ocular plate and the connecting body are in close contact with the back surface of the main body in a portable state for carrying, and the main body, ocular plate and connecting body bent in the three-dimensional state for the virtual reality function form a hollow rectangular column shape, making it possible to implement the functions as a virtual reality device.

The user has the virtual reality device according to the present embodiment and can use it for various purposes. The portable virtual reality device includes a flexible display and can operate various applications to perform the functions of a conventional cell phone or a terminal device. That is, it can be used as a general cell phone or a multimedia device in such a portable state. Then, when the user presses the sides of the device with his or her hand or apply gravity to transform the portable virtual reality device including the main body, the ocular plate, and the connecting body into a hollow rectangular pillar shape.

In this case, the virtual reality display is placed opposed to the ocular plate, and the virtual reality function can be performed through the ocular lens of the ocular plate. In addition, the user can utilize a virtual reality function in a solid state of a hollow rectangular pillar shape, and can easily switch to a portable state by closely contacting the main body and the ocular plate.

A foldable blinker can be mounted on the ocular plate to block external light from entering the user's eyes. Although the foldable blinker can be provided in various forms, while in portable state it can be kept in a thinly adhered state, then can be expanded or deformed into an intended shape in a stereoscopic state, thereby effectively shielding external light.

For example, the foldable blinker includes an upper plate for blocking the upper portion around the eyes, a side plate for blocking the side surface around the eyes, and a lower plate for blocking the lower portion around the eyes. It can tend to elastically overlap the rear surface of the ocular plate by using a structure such as a spring mounted on the hinge portion. The side plates are unfolded and supported between the upper and lower plates to form a three-dimensional structure of the foldable blinker. In order to switch to a portable state, the support plates are folded back to the rear surface of the ocular plate, and the lower plate can be folded together.

According to an exemplary embodiment of the present invention, a portable virtual reality device including a flexible display includes a main body that includes a flexible display on the front side and a virtual reality display on the rear side, and a sterically deformable side with the flexible display, and an ocular plate having an ocular lens for a virtual reality function and corresponding to a sterically deformed main body, the ocular lens having a function of detaching, maintaining and varying a predetermined distance from the virtual reality display, a nose contacting portion corresponding to the user's nose downward of the virtual reality display and a side face contacting portion covering the face side of the user's eyes around the user's eyes to both sides of the virtual reality display. The nose contacting portion and the side face contacting portion may be deformed while maintaining the overall curved surface corresponding to the shape of the user's face.

In this embodiment, the ocular plate is brought into close contact with the virtual reality display in a portable state, and in a steric state for the virtual reality function, the eyelash plate can be located in the rear space away from the virtual reality display.

The device may further include a fixed length link connecting the upper part of the ocular plate and the upper part of the main body, and a variable length link connecting the lower part of the ocular plate and the lower part of the main body, The ocular plate can be kept detached from the virtual reality display.

The main body includes a V-shaped portion formed in front of the nose receiving portion to maintain the convex shape of the nose receiving portion, A forming link added to the body, and a hollow fixing table for selectively covering the connection portion of the forming link to fix the state in which the forming link is arranged in a line.

The plastic deformation pieces embedded in the main body may be included around the bending line of the main body to guide the bending of the main body. Such a structure may be applied equally or similarly to other embodiments.

According to an exemplary embodiment of the present invention, a portable virtual reality device including a flexible display includes a main body that includes a flexible display on the front side and a virtual reality display on the back side and is deformable in three dimensions with a flexible display, and a ocular plate having an ocular lens for a virtual reality function and corresponding to a sterically deformed main body, the ocular lens having a function of detaching, maintaining and varying a predetermined distance from the virtual reality display, and a side accommodating portion that covers the face side of the user's eyes can be formed on both sides of the virtual reality display by the concavely deforming main body. In a portable state, the ocular plate is brought into close contact with the virtual reality display, and in a steric state for the virtual reality function, the ocular plate can be located on the opposite side of the rear space away from the virtual reality display.

The device further includes a screen member for guiding the ocular plate between the portable state and the stereoscopic state, and the screen member can block the upper and lower portions of the user's eye area.

In the portable virtual reality device according to the present invention, the main body may include a voice communication module to include a cell phone function. However, the main body may be connected to the outside via another voice communication network without a voice communication module. The virtual reality device of the present invention is portable and can be used as a general cell phone or a terminal device, and can perform a virtual reality function regardless of place and time. For example, a variety of operating systems such as Android, Windows, Linux, and OPENELEC can be used as an operating system for using a foldable virtual reality device. Even when the foldable virtual reality device is not performing a virtual reality function, it can still perform and store functions such as communication, messaging, multimedia, and games. It is also possible to drive a general application and modify it suitable to a virtual reality or an augmented reality.

As used herein, the term “rearward” or “rearward” can be understood as meaning a direction toward the user's face at the time of driving.

The virtual reality function using the main body virtual reality display and the separation ocular plate can be implemented in various ways. For example, a stereoscopic effect can be performed by dividing a virtual reality display into left and right and a pair of ocular lenses as the conventional card board, but it is also possible to divide and display an image up and down according to a virtual reality system. In addition, the present invention can be applied to a polarizing glasses system in which a polarizing lens is mounted on an ocular plate, or a shutter glass system in which right and left ocular lenses are opened and closed with a time difference from the ocular plate. In addition to this, a variety of display and lens combinations for stereoscopic display can be implemented.

According to another exemplary embodiment of the present invention, the terminal device comprises: a terminal main body portion having a first display portion formed with circuits for providing an image signal through the first display portion; and a roll storage unit formed at one side of the first display unit and extending integrally with the first display unit to accommodate a second display unit of a flexible material, and a sliding member configured to be able to slide out as the area is enlarged.

### [Mode]

Hereinafter, preferred embodiments of the present invention will be described in detail with reference to the accompanying drawings, but the present invention is not limited to or limited by the embodiments. Note that, in this description, the same numbers refer to substantially the same elements and can be described with reference to the contents described in the other drawings under such a rule, and contents which are judged to be obvious to the persons skilled in the art or repeated may be omitted.

The terminology used herein is for the purpose of describing the embodiments and is not intended to be limiting of the invention. In the present specification, the singular form includes plural forms unless otherwise specified in the specification. “comprises” and/or “comprising” used in the specification do not exclude the presence or addition of one or more other elements in addition to the stated element. Like reference numerals refer to like elements throughout the specification and “and/or” include each and every combination of one or more of the elements mentioned. Although “first”, “second”, and the like are used to describe various components, these components are not limited by these terms, of course. These terms are used only to distinguish one component from another. Therefore, it goes without saying that the first component mentioned below may be the second component within the technical scope of the present invention.

Unless defined otherwise, all terms (including technical and scientific terms) used herein may be used in a sense that is commonly understood by one of ordinary skill in the art to which this invention belongs. In addition, commonly used predefined terms are not ideally or excessively interpreted unless explicitly defined otherwise.

As used herein, the term “part” or “module” refers to a hardware component such as software, FPGA, or ASIC, and the “component” or “module” performs certain roles. However, “part” or “module” is not meant to be limited to software or hardware. A “part” or “module” may be configured to reside on an addressable storage medium and configured to play back one or more processors. Thus, by way of example, “a part” or “module” refers to components such as software components, object-oriented software components, class components and task components, and processes, Microcode, circuitry, data, databases, data structures, tables, arrays, and variables, as used herein.

The terms spatially relative, “below”, “beneath”, “lower”, “above”, “upper” May be used to easily describe a correlation between one component and other components as described above. Spatially relative terms should be understood in terms of the directions shown in the drawings, including the different directions of components at the time of use or operation. For example, when inverting an element shown in the Figures, an element described as “below” or “beneath” of another element may be placed “above” another element. Thus, the exemplary term “below” can include both downward and upward directions. The components can also be oriented in different directions, so that spatially relative terms can be interpreted according to orientation.

In this specification, the virtual reality and the virtual reality video are not limited to the VR (Virtual Reality) and the VR video but may be a virtual reality (VR), a virtual reality video, an Augmented Reality (MR), Mixed Reality and Mixed Reality video, and also includes all kinds of videos including real, virtual, real, and virtual images, including but not limited to, augmented reality images and mixed reality do.

Embodiments of the method of utilizing the virtual reality device disclosed herein may also be applied to various types of virtual reality devices such as Virtual Reality (VR), Augmented Reality (AR), Mixed Reality (MR) It will be understood by those of ordinary skill in the art that the present invention can be applied to all.

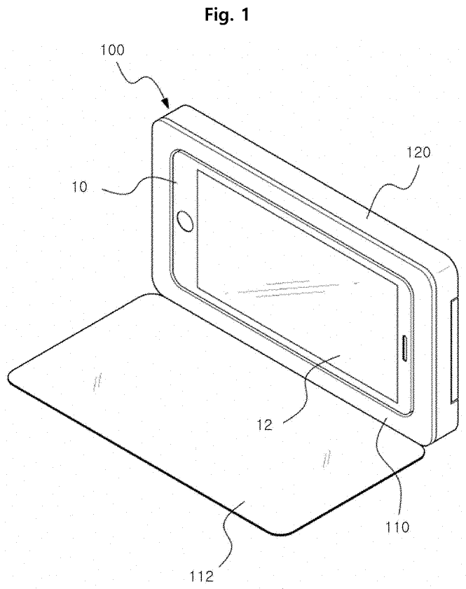

Hereinafter, a first embodiment of a folding virtual reality device will be described with reference to FIGS. 1 to 56.

In the disclosed embodiment, the foldable virtual reality device may be configured in the form of a case capable of receiving (or releasably coupling) the display device. For example, the folding virtual reality device can be configured in the form of a cell phone case that accommodates a cell phone (e.g., a smart phone) and can view a virtual reality image using a screen of the cell phone.

In another embodiment, the foldable virtual reality device may be provided with a display device (for example, a smart phone) integrally.

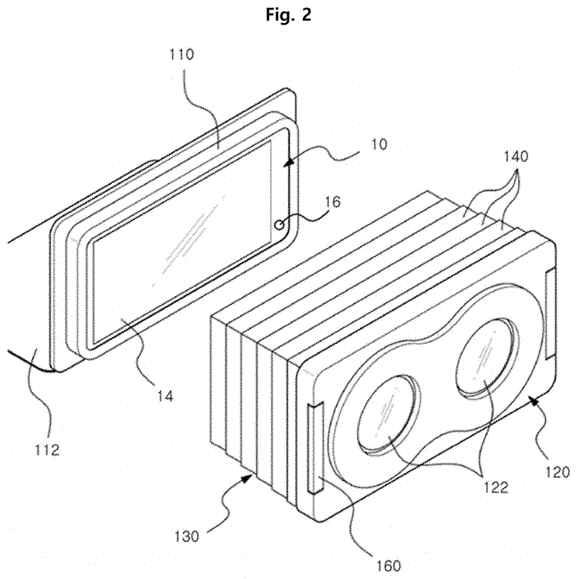

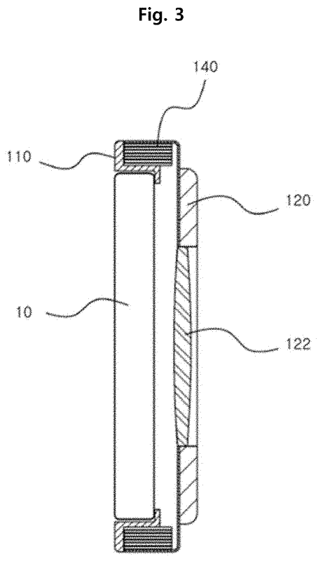

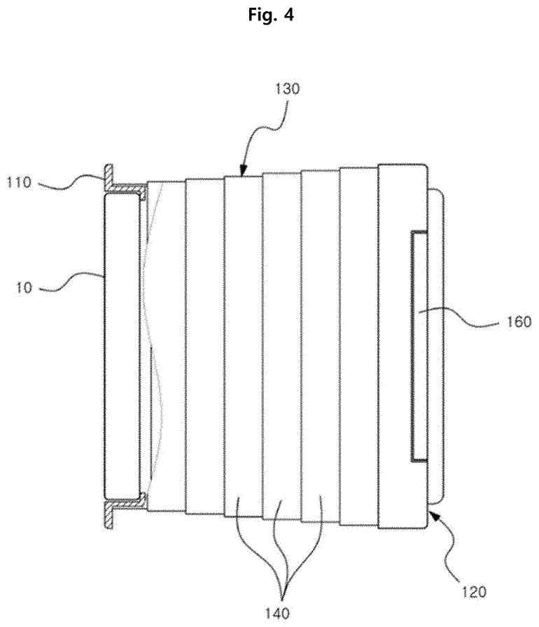

FIG. 1 is a perspective view of a folding virtual reality device and a cell phone attached thereto according to an embodiment of the present invention. FIG. 2 is a dissected perspective view of a folding virtual reality device and a cell phone shown in FIG. 1. FIG. 3 is a cross-sectional view of the foldable virtual reality device and the cell phone of FIG. 1 in close contact, and FIG. 4 is a cross-sectional view of the foldable virtual reality device and the cell phone of FIG. 1.

Referring to FIGS. 1 to 4, the foldable virtual reality device (100) according to the present embodiment is coupled to a cell phone (10), that is, the cell phone (10) is accommodated. In response to the cell phone (10), the folding virtual reality device (100) includes a casing (110), an ocular plate (120), and a screen member (130).

In the disclosed embodiment, the cell phone (10) is understood to be collectively referred to as a computing device including at least one processor and a display. For example, the cell phone (10) may mean both a smart phone, a tablet PC, and the body of a virtual reality device.

The cell phone (10) includes a main display (12) installed on the front side and a virtual reality display (14) installed on the rear side of the cell phone (10). The cell phone (10) includes a main display (12) or other buttons, can perform basic call, application operation, and the like. In addition, the rear virtual reality display (14) may provide a virtual reality function to the user together with the ocular plate (120). The virtual reality display (14) can be operated through user's operation or movement detection of the ocular plate (120) and the like.

Furthermore, the camera module 16 can be mounted on the front or rear surface of the cell phone (10). The camera module (16) can be used for capturing an external image and can be used for implementing functions such as an augmented reality (AR) and a mixed reality (MR). One or more camera modules (16) may be provided and a plurality of directions may be provided to simultaneously photograph at least a portion of the front, side, top, bottom, and back sides, and a fisheye lens type can also be provided. Camera modules and augmented reality applications can be equally applied to other embodiments of the present invention.

The cell phone (10) according to the disclosed embodiment may include at least one of the above-described components (e.g., at least one processor, the main display 12, the virtual reality display 14 and the camera module 16) of the cell phone body.

The cell phone body may be made of a metal material including plastic or aluminum and other alloys but is not limited thereto. In addition, the cell phone body is generally, but not limited to, a rectangular parallelepiped or a rectangular parallelepiped shape.

The casing (110) can adopt the cell phone (10). Specifically, in this specification, the casing (110) can hold the cell phone body of the cell phone (10) by fixing it. The manner in which the casing (110) fixes and accommodates the cell phone body of the cell phone (10) is not limited, and various methods of preventing the cell phone body from easily separating from the casing (110) can be applied.

In one embodiment, the casing (110) may include a penetration for opening the display rearward. The penetrating portion may be formed as one hole or two or more holes. As shown in the Figure, the front cover (112) may be formed on one side of the front surface of the casing (110), as in other cell phone cases.

For example, the casing (110) can be wrapped around the side of the cell phone body using a protective frame. The protective frame may be made of a material capable of providing a frictional force equal to or greater than a predetermined reference value to the side surface of the cell phone body so as to prevent the cell phone body from slipping or may be made of a stretchable material so as to fix the cell phone body with the restoring force of the protective frame. In addition, the protective frame may have a structure in which a corner of one side is curved inward or protruded at least so as to prevent the cell phone body from falling out structurally. The protective frame may also be configured to be openable and closable to open one corner of the protective frame and close the open edge after receiving the cell phone body so that the cell phone body is secured within the protective frame. In addition, the protective frame may fix the cell phone body to the protective case using at least one protrusion configured to fit at least one groove provided in the cell phone body. The above-described embodiments are provided by way of example, and the method used for securing and accommodating the cell phone body to the protective case, that is, the casing (110), is not limited thereto.

In one embodiment, the cell phone case including the casing (110) may include at least one processor and a display and may perform the functions of the cell phone (10).

The ocular plate (120) includes a pair of ocular lenses (122) that allow the user to view the image displayed on the virtual reality display (14) through the ocular lens (122). The ocular lens (122) can adjust the focus through a fine rotation operation, and the width of the ocular lens (122) can be adjusted to correspond to the distance between the eyes. In addition, a cushion corresponding to the face shape or a light shielding structure capable of additionally shielding the light shielding around the ocular lens (122) can be added.

In one embodiment, at least a portion of the ocular plate (120) may include a heating or cooling means to allow the ocular plate (120) to warm in cold weather or cool in hot weather.

The heating means, or the cooling means included in the ocular plate (120) may be interlocked with the virtual reality video so that the ocular plate (120) may be warmed or cooled corresponding to the type and scene of the virtual reality video.

The screen member (130) is mounted on the rear surface of the casing (110) that houses the cell phone (10) or the cell phone (10) and includes a plurality of screen barrels (140). The screen barrels (140) may be formed in a rectangular shape corresponding to the shape of the casing (110) that accommodates the handphone (10) or the cell phone (10) or may have an 8-shape, or the like.

In the screen member (130), since the screen barrel (140) slides with a certain degree of friction like a metal antenna, it can be stopped at an arbitrary position and can maintain a variable distance. In addition, since the four sides of the screen barrel (140) can be cut off from the outside, the external light can be effectively blocked.

In addition, the cell phone (10) can input or output various functions through the rear virtual reality display (14) or another display provided separately. For example, the user can input numbers through display touch or voice input, create documents, confirm address locks, and utilize messaging applications. Furthermore, as a multimedia device, it is possible to additionally implement video watching, music listening, and the like. In the case where only one virtual reality display (14) is installed in the cell phone (10), various functions as described above can be implemented through the virtual reality display (14), and the screen unit (130) can be temporarily used.

It is also possible to use a separate display in addition to the casing (110) that accommodates the cell phone (10) or the cell phone (10) and a separate display can be used to perform the functions separated from the virtual reality display or may be used together. In addition, when a separate display is added to the virtual reality display (14), it is possible to implement the same contents as the virtual reality display (14) being used by the user or contents associated therewith through a separate display. In this case, the wearer using the virtual reality device can form information exchange with the other users or people nearby or can form various sympathy.

The technical features described in this embodiment are applicable to other embodiments, and those skilled in the art can make modifications according to other embodiments by using ordinary creative ability.

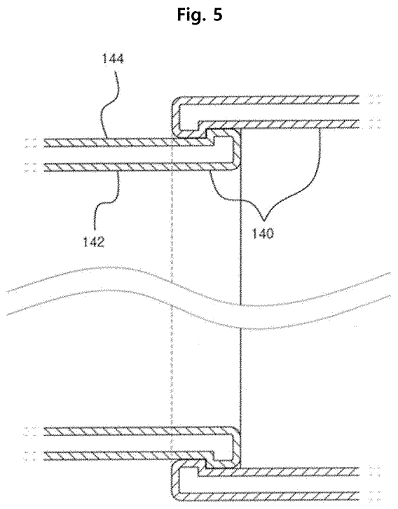

FIG. 5 is a cross-sectional view illustrating a screen member of a folding virtual reality device according to an embodiment of the present invention.

Referring to FIG. 5, the screen barrel (140) constituting the screen member (130) may be formed in a double wall structure. The screen barrel (140) forming the double wall includes an inner wall (142) and an outer wall (144) and can maintain a distance that is spaced from the inner wall (142) and the outer wall (144) in all or a part of the area. Since the screen barrel (140) forms a double wall structure, the screen barrel (140) can maintain a weight that is significantly lighter than the single wall structure and can form a solid structure as compared with the single wall structure.

The technical features described in this embodiment are applicable to other embodiments, and those skilled in the art can make modifications according to other embodiments by using ordinary creative ability.

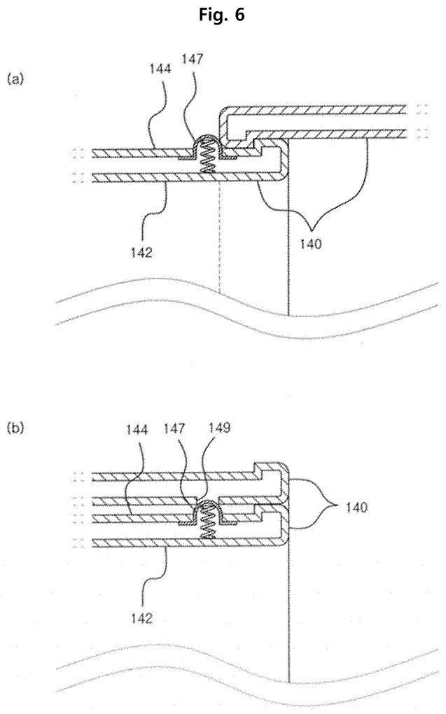

FIG. 6 is a closeup sectional view of a folding virtual reality device according to an embodiment of the present invention.

Referring to FIG. 6, in the screen barrel 140, a close contact state or a separated state. And may further include elastic projections (147) protruding from the inner wall for fixing. The elastic projections (147) support the end portions of the other screen barrels (140) so that the screen barrels (140) can be prevented from overlapping each other under a certain force.

The elastic projections (147) are engaged with the projection receiving grooves (149) formed in the other screen barrels (140) so that the screen projections (147) can be fixed immovably.

In this embodiment, the elastic projection (147) is formed to protrude from the inner wall (142) of the screen barrel (140). However, the elastic projection (147) may also protrude from the outer wall or the inner/outer wall, they may be designed to be spaced apart from each other in a direction perpendicular to the stretching direction so as not to interfere with operation. In addition to being supported by the spring, the elastic projection (147) may be resiliently supported by its own elasticity, such as a leaf spring.

The technical features described in this embodiment are applicable to other embodiments, and those skilled in the art will be able to modify the embodiment in accordance with the ordinary creative ability.

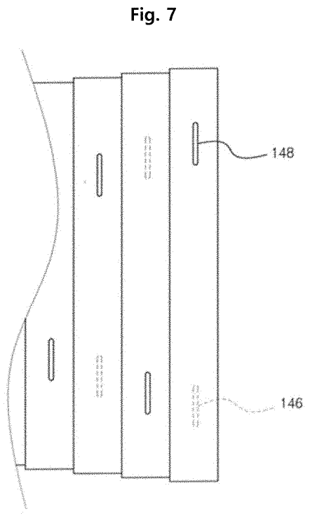

FIG. 7 is a partially enlarged side view illustrating a screen member of a folding virtual reality device according to an embodiment of the present invention.

Referring to FIG. 7, as described in FIG. 5, the screen barrel (140) of the screen member (130) may be formed in a double wall structure. In the case of such a double wall, other effects besides merely implementing a light weight can be obtained. For example, when the ventilation hole is formed in the screen member (130), the first ventilation hole (146) and the second ventilation hole (148) may be formed so as not to overlap with each other to prevent light from entering from the outside.

Specifically, in the screen case (140) having the double wall structure, the first vent hole (146) is formed in the inner wall (142) and the second vent hole (148) is formed in the outer wall (144), The first ventilation hole (146) and the second ventilation hole (148) do not overlap each other, that is, they are shifted from each other, so that light can be prevented from entering from the outside.

In this embodiment, the ventilation hole is formed in the screen barrel (140). However, in some cases, the ventilation hole may be formed only on the ocular plate (120) or on the ocular plate (120).

Referring again to FIGS. 2 to 4, the screen member (130) is interposed between the casing (110) accommodating the cell phone (10) or the cell phone (10) and the ocular plate (120), and the ocular plate (120) the external light can be prevented from being introduced while it is in the separated state.

In the present embodiment, the size of the screen barrel (140) gradually increases backward and increases or decreases in the back-and-forth direction. However, conversely, the size of the screen barrel may be gradually decreased, or the size of the screen barrel may be increased, or it could decrease after a while of increasing.

Though it is preferable that the screen barrel (140) cut off the external light on four sides for immersion, but it is also possible that the cell phone (10) or the cell phone (10) adopting casing (110) and the ocular plate (120) to be partially blocked.

The technical features described in this embodiment are applicable to other embodiments, and those skilled in the art will be able to modify the embodiment in accordance with the ordinary creative ability.

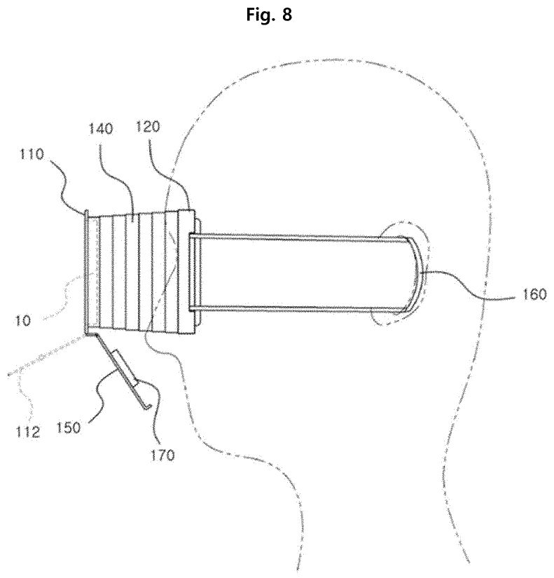

FIG. 8 is a side view for explaining a folding virtual reality device according to an embodiment of the present invention.

Referring to FIG. 8, similar to the previous embodiment, the folding virtual reality device includes a casing (110), an ocular plate (120), and a screen member (130) that accommodate a cell phone (10), and an additional the rear cover (150) can be included.

The rear cover may be used to protect the ocular plate (120) and may be used as a casing (110) or an ocular plate (120) that accommodates the cell phone (10), or the cell phone (10) while being used.

In the case where the rear cover (150) is formed on the casing (110) accommodating the cell phone (10) or the cell phone 10, in addition to protecting the ocular plate (120), in addition to the content of the virtual reality, and a wind generating part (170) for generating a wind can be additionally formed.

In order to more realistically realize the virtual reality function, the virtual reality device may further include a fixing member (160) that can fix the virtual reality device in a separated state to the user's face. The fixing member (160) may be provided in the form of an earring of a general mask and is normally prepared on both sides of the ocular plate (120) and may be pulled backward to the user's ears and hooked to the user's ear. Of course, it is also possible to form the casing (110) that accommodates the cell phone (10) or the cell phone (10).

The fixing member 160 may be provided in the form of a spectacle hanger or may be provided in the form of an elastic band fixed to the user's head.

The technical features described in this embodiment are applicable to other embodiments, and those skilled in the art will be able to modify the embodiments in accordance with the ordinary inventive skill.

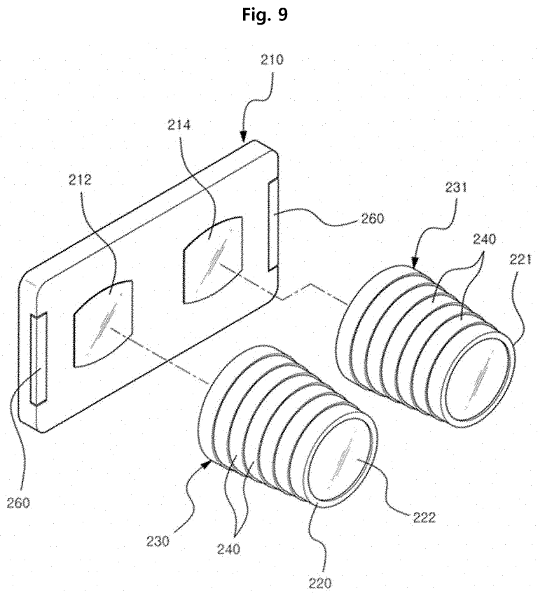

FIG. 9 is a rear perspective view of a folding virtual reality device according to an embodiment of the present invention.

FIG. 9, the foldable virtual reality device (200) according to the present embodiment includes a main body (210), a first ocular plate (220), a second ocular plate (221), a first screen member (230), and a second screen member (231).

The main body (210) includes a first virtual reality display (212) and a second virtual reality display (214) that are installed on the rear side of the main body (210). The main body (210) includes first and second virtual reality displays (212) and (114), etc., can be used to perform basic operations, application operations, and the like.

In the main body (210), the first and second virtual reality displays (212) and (214) are mounted on the rear surface, and the first and second ocular plates (220) and (221) include ocular lenses (222), respectively. So that the image displayed on the virtual reality displays (212) and (214) can be enlarged and viewed. The ocular lens (222) can adjust the focus through a fine rotation operation and can independently adjust the focus using the first and second screen members (230) and (231) or adjust the focus in the up and down and left and right directions It is also possible to fine-tune it. In addition to this, a light blocking structure for blocking the cushion corresponding to the face shape and the light blocking around the ocular lens (222) can be added.

The first and second screen members (230) and (231) are mounted on the rear surface of the main body (210) and are provided with a plurality of screen barrels (240). The screen barrel (240) may be formed in a cylindrical shape or may be formed in various shapes such as an ellipse, a rectangle, and a polygon.

In the first and second screen members (230) and (231), since the screen barrel (240) is slide-moved with a certain degree of friction like the metal antenna, it is possible to stop at an arbitrary position. Further, since the screen barrel (240) can cut off four surfaces from the outside, the external light can be effectively blocked.

The technical features described in this embodiment can be applied to other embodiments as well. And those skilled in the art can make modifications according to other embodiments by using their ordinary creative ability.

For example, in the embodiment shown in FIG. 9, the main body (210) may be configured as a case that accepts a cell phone and can be connected to the accommodated cell phone by a wired or wireless connection. In this case, the virtual reality displays (212) and (214) may be configured to be a through-hole or a viewable member so that the screen displayed on the virtual reality display of the cell phone is exposed to the outside. In another embodiment, the virtual reality displays (212) and (214) may be constituted by a display device capable of displaying a virtual reality screen obtained by connecting the main body (210) to a cell phone in a wired or wireless manner.

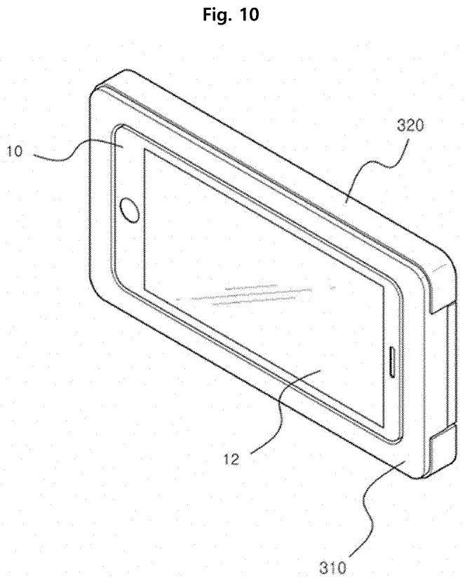

FIG. 10 is a perspective view of a folding type virtual reality device and a cell phone mounted thereon according to an embodiment of the present invention, FIG. 11 is a dissected perspective view of the folding type virtual reality device of FIG. 10 from the rear, (10) folding virtual reality device.

Referring to FIGS. 10 to 12, the folding virtual reality device (300) according to the present embodiment includes a casing (310), an ocular plate (320), and a screen member (330) that accommodate a cell phone (10).

The cell phone (10) includes a display (12) installed on the front surface and a virtual reality display (14) installed on the rear surface of the cell phone (10). The cell phone (10) is connected to the cell phone (10) through the front main display (12), the virtual reality display (14) on the rear side can provide a virtual reality function to the user together with the ocular plate (120) in addition.

In the present embodiment, the cell phone (10) cannot change the direction in the casing (310). However, if the casing (310) is implemented as an inner frame and a main frame, as will be described later.

The ocular plate (320) includes a pair of ocular lenses (322) through which the user can view the images displayed on the reversed display (312). The ocular lens (322) can adjust the focus through a fine rotation operation, and the width of the ocular lens (322) can be adjusted to correspond to the distance between the eyes. In addition, a cushion corresponding to the face shape or a light shielding structure capable of further blocking the light can be added to the periphery of the ocular lens (322).

The screen and the distance adjusting member (330) include a distance adjusting unit (331) and a light blocking screen (340). The distance adjusting unit 331 includes a first link. The other end of the second link (334) is connected to the ocular plate (320) so that it can rotate. The other end of the first link (332) is connected to the casing (310) so that it can rotate.

The four combinations including the first link (332) and the second link (334) connect the ocular plate (320) at the four corners of the casing (310) and the first link (332) and the second link (334)) can be moved in a spaced state or in a close contact state while being spread in a straight line or bent in a V-shape.

The technical features described in this embodiment are applicable to other embodiments, and those skilled in the art can make modifications according to other embodiments by using ordinary creative ability.

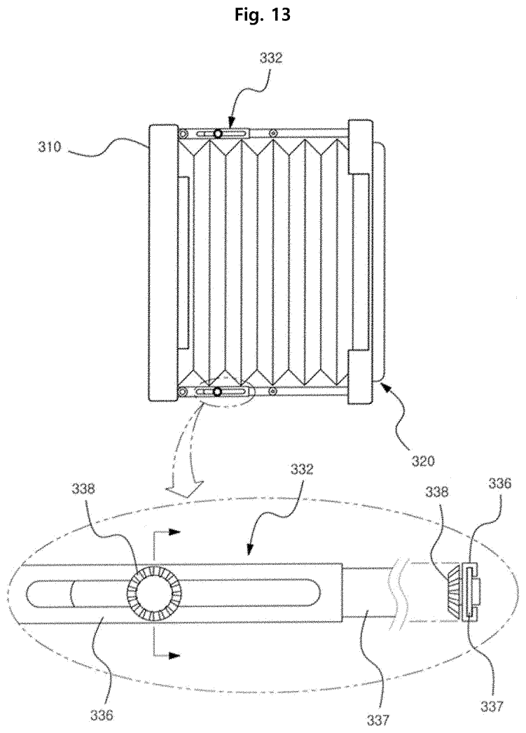

FIG. 13 is a partially enlarged view for explaining a distance control member of the folding virtual reality device according to an embodiment of the present invention.

Referring to FIG. 13, the first link (332) can be provided to allow length adjustment and fixing. To this end, the first link (332) includes two or more rods (336), (337) capable of adjusting the overlapping lengths, and at least one of the rods (336), (337) has a long hole formed therein in the longitudinal direction, Fine adjustment screws (338) can be mounted to adjust and secure the overlapping lengths between the rods (336) and (337).

In addition, a plurality of latching jaws may be formed at predetermined intervals in the long holes to adjust the overlap length of the rods while moving the latching jaws.

By adjusting the overlapping distance, it is possible to adjust the distance as required, and by adjusting the four link combinations independently, it is possible to adjust the angle of the ocular lens display and the deviation of the display with respect to the horizontal axis.

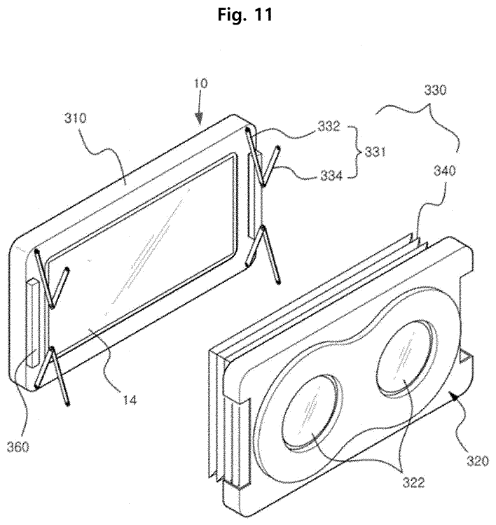

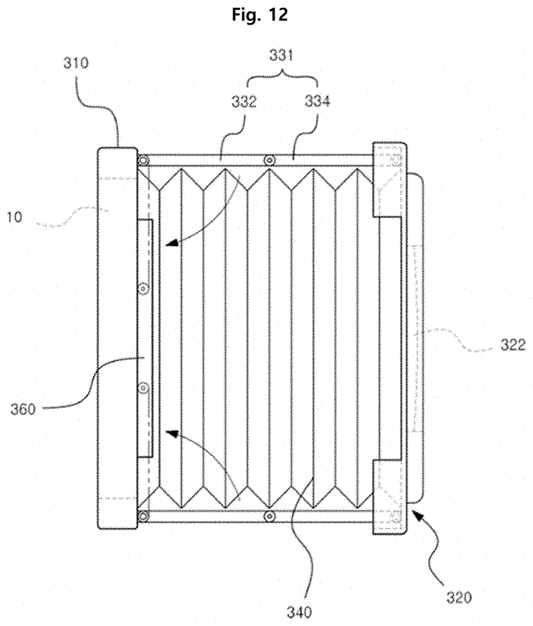

Referring again to FIGS. 11 and 12, the light blocking screen (340) is interposed between the casing (310) and the ocular plate (320), and while the ocular plate (320) is in the separated state, can be blocked.

In this embodiment, the light blocking screen (340) is formed in a bellows shape, and both ends thereof are fixed to the casing (310) and the ocular plate (320), respectively, to form a substantially complete dark room. However, the light blocking screen (340) may be formed of a stretchable material rather than a bellows. It may be designed to be fixed to one side and to be fixed to the other side until the state of separation is reached.

The light shielding screen (340) though is preferable to be shielded from the four sides for external light for immersion, but it is also possible that the casing (310) and the ocular plate (320) may be partially blocked.

Further, in order to more realistically perform the virtual reality function, it may further include a fixing member (360) capable of fixing the virtual reality device in the separated state to the user's face. The fixing member (360) may be provided on the casing (310) in the form of an earring of a conventional mask and is usually provided on both sides of the rear side of the casing (310) and is drawn backward to the user's convenience.

The fixing member (360) may be provided in the form of a spectacle hanger or may be provided in the form of an elastic band fixed to the user's head.

In one embodiment, when at least a portion of the anchoring member (360) is positioned behind the user's head, the anchoring member (360) may further include at least one camera provided behind the user's head.

The virtual reality device according to the disclosed embodiment can display a back image of a user's head on a virtual reality screen when a dangerous situation is detected using at least one camera provided behind the user's head.

In addition, when a user is playing a game using the virtual reality device, according to the disclosed embodiment, it is possible to provide virtual reality images at various points of time using at least one camera provided behind the user's head.

The technical features described in this embodiment are applicable to other embodiments, and those skilled in the art will be able to modify the embodiments in accordance with the ordinary creative ability.

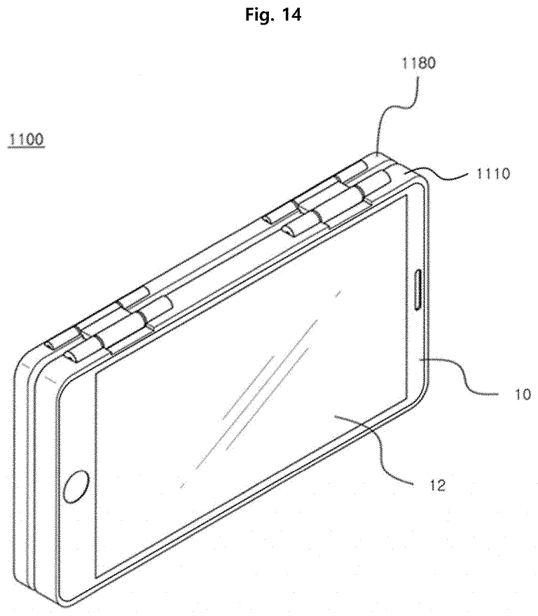

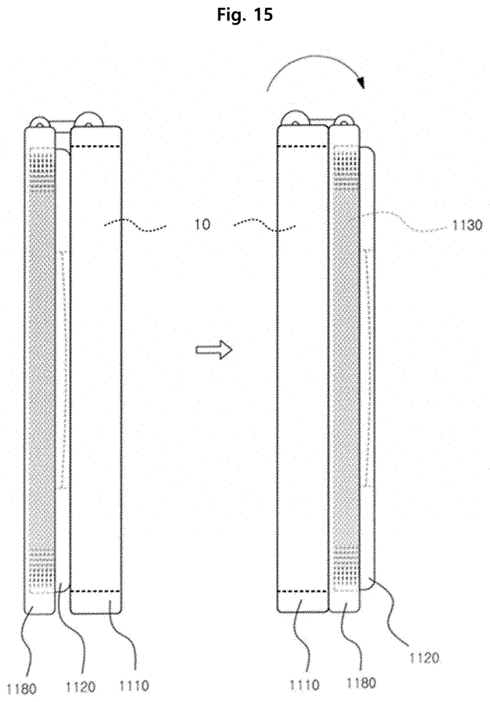

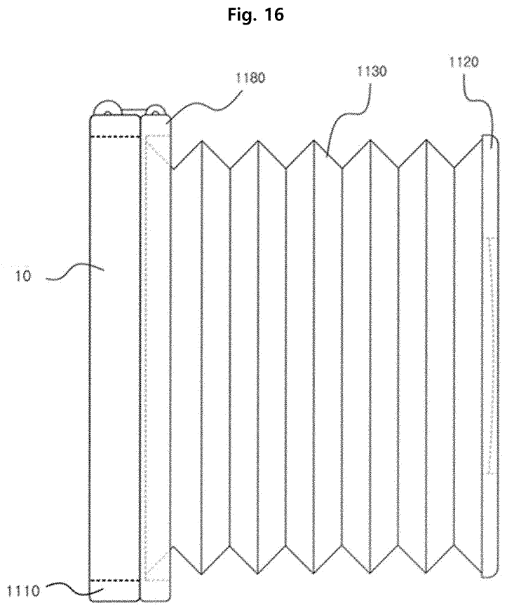

FIG. 14 is a perspective view for explaining a folding virtual reality device according to an embodiment of the present invention, FIG. 15 is a side view for explaining a conversion process of the folding virtual reality device of FIG. 14, FIG. 16 is a side view for explaining the expansion state of the folding virtual reality device of FIG. 14.

Referring to FIGS. 14 to 16, the folding virtual reality device according to the present embodiment includes a casing (1110) that accommodates a cell phone (10) including a display (12), and a casing (1110) that is provided on one side of the casing (1110) and a changeover body (1180 (that is mounted so that it can rotate. The switching body (1180) rotates at one side of the casing (1110) to be in tight contact with the front and back surfaces and includes a screen member (1130) and an ocular plate (1120) mounted on the screen member (1130).

In another embodiment according to FIGS. 14-16, the folding virtual reality device comprises a cell phone (10) including a display (12) and a switching body (1180) mounted on one side of the cell phone so that it can rotate. The switching body (1180) is rotated on one side of the cell phone (10) and is in a state of close contact with the front and back surfaces and may include a screen member (1130) and an ocular plate (1120) mounted on the screen member (1130).

As shown in FIG. 14, the switch body (1180) can move to the back and front of the casing (1110) using a multi-axis hinge or a single-axis hinge. The display (12) of the cell phone (10) accommodated in the casing (1110) can display an image or a user interface for multimedia when the switching body (1180) remains in close contact with the rear surface of the casing (1110) and when a communication module is mounted on the casing (1110) or the switching body (1180), it can also function as a communication device.

Then, when the switching body (1180) is brought into close contact with the front surface of the casing (1110) the ocular plate 1120 can be extended in a spaced apart state as shown in FIG. 15, and the screen member (1130) can also be expanded in the form of a bellows, or the like. Apart from this, it may also be provided to be compressed or elongated using a plurality of screen barrels, as described in the previous embodiments.

Although not shown, the screen member (1130) can maintain a detached state, in which case the link members shown in FIGS. 11 to 13 may be used, and a hydraulic cylinder, various types of actuators such as a pneumatic cylinder, an antenna lever, a solenoid, a coil spring, and a shape-based alloy can be used, and such a spacing device or a distance adjusting portion can be mounted outside or inside the screen member (1130).

In a state in which the screen member (1130) is in close contact with the front surface of the casing (1110) (that is, in a state of being in tight contact with the front surface of the cell phone (10) accommodated in the casing (1110), the ocular plate (1120), and the screen member can be extended to a detached state. Moreover, as described above, the virtual reality function can be implemented through the display (12) when the ocular plate (1120) is in a detached state.

In the present embodiment, the switching body (1180) rotates at the longitudinal side of the casing (1110), but the switching body (1180) can be mounted to rotate at the opposite longitudinal side of the casing (1110), and it can also be mounted to rotate at the non-end side.

The technical features described in this embodiment are applicable to other embodiments, and those skilled in the art will be able to modify the embodiments in accordance with the ordinary inventive skill.

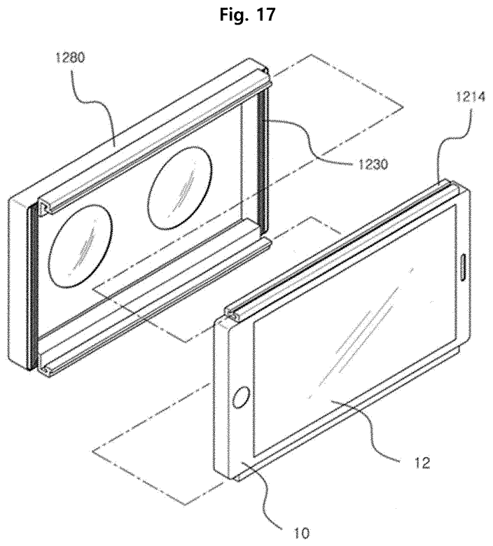

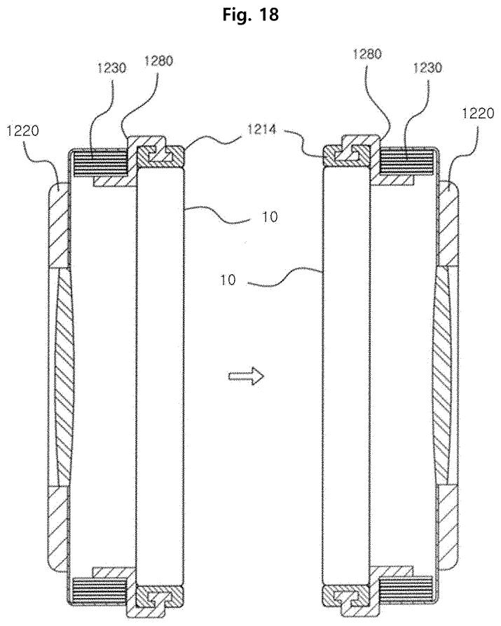

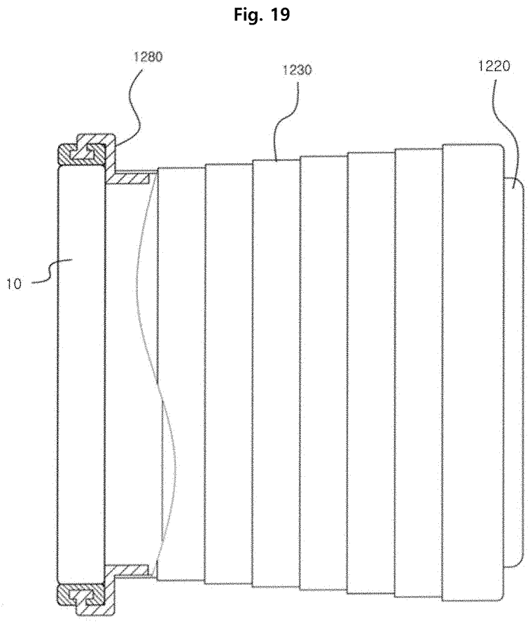

FIG. 17 is a perspective view for explaining a folding virtual reality device according to an embodiment of the present invention, FIG. 18 is a side view for explaining a switching process of the folding virtual reality device of FIG. 17, FIG. 19 is a side view for explaining the expansion state of the folding virtual reality device of FIG. 17

Referring to FIGS. 17 to 19, the folding virtual reality device according to the present embodiment includes a guide rail (1214) which is attached or detachably attached to a side face of a cell phone (10) including a display (12), and a switch body (1280) mounted on the rail (1214) so that it can slide. In one embodiment, the guide rail (1214) may be provided on one side of a casing (not shown) that can receive the cell phone (10).

In one embodiment, the cell phone (10) may be provided with a guide rail (1214) coupled to the side thereof as an integral part thereof.

The switching body (1280) can be detached or mounted while sliding along the guide rail (1214), and the guide rail (1214) can also be formed in a back-and-forth symmetrical manner so as to be brought into close contact with the front surface and the rear surface. The switch body (1280) may include a screen member (1230) and an ocular plate (1220) mounted to the screen member (1230).

As shown in FIG. 18, the switching body (1280_can be moved to the back face and the front face of the cell phone (10) with the front and rear directions different in the guide rail (1214). The display (12) of the cell phone (10) may display an image or a user interface for multimedia and the cell phone (10) may display the video or user interface for the multimedia, or when the communication module is mounted on the switching body (1280), it can also function as a communication device.

As shown in FIG. 19, the ocular plate (1220) can be extended in a spaced apart state, and the screen member (1230) can also be expanded using a plurality of screen barrels.

Although not shown, the screen member (1230) can maintain a spacing state by using its own frictional force, and besides, a hydraulic cylinder, a pneumatic cylinder, an antenna lever, a solenoid, a coil spring, a shape, and a distance adjusting unit can be mounted on the outside or the inside of the screen member (1230).

In a state in which the screen member (1230) is in close contact with the front face of the cell phone (10) on which the display (12) is formed, the ocular plate (1220) and the screen member (1230) can be extended in a spaced apart state. Furthermore, as described above, the virtual reality function can be implemented through the display (12) when the ocular plate (1220) is in a detached state.

In the present embodiment, the switching body (1280) is detachably attached along the guide rail (1214) formed on the long side of the cell phone (10), but the switching body (1280) forms the short side guide rail rather than the long side, and can be detached and attached while moving in a direction parallel to the side surface.

The technical features described in this embodiment are applicable to other embodiments, and those skilled in the art will be able to modify the invention in accordance with other embodiments by using ordinary creative ability.

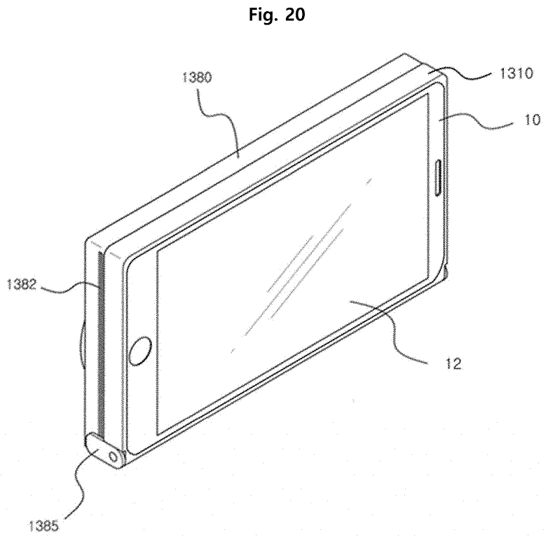

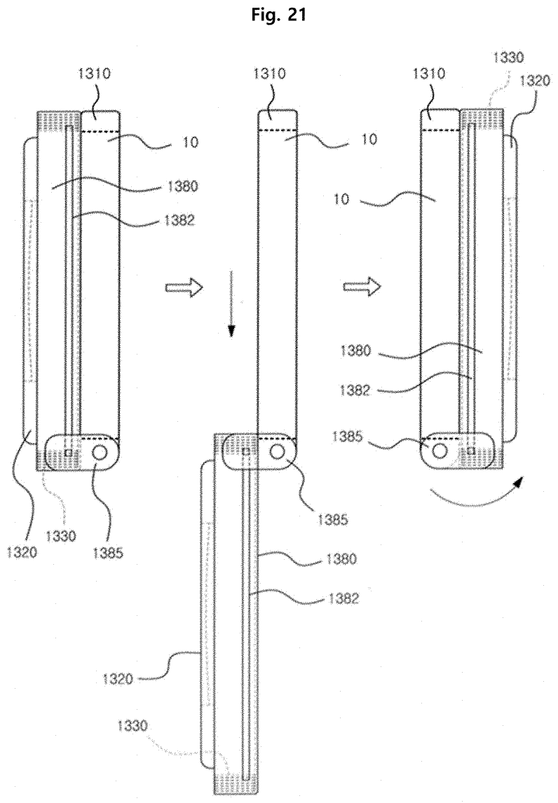

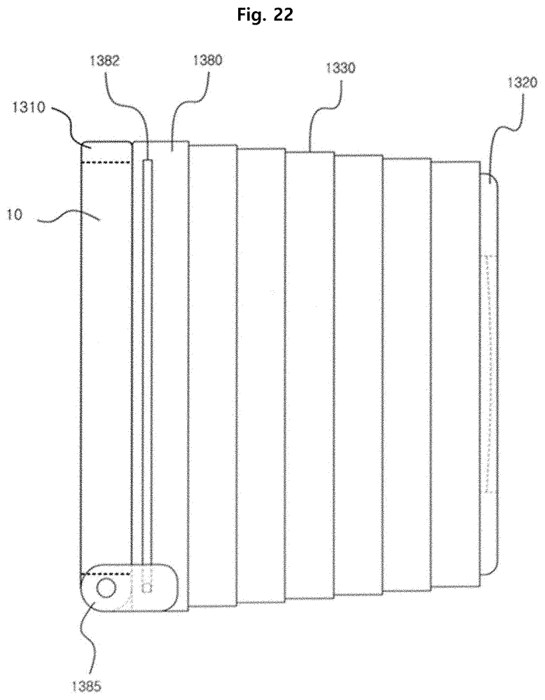

FIG. 20 is a perspective view for explaining a folding virtual reality device according to an embodiment of the present invention, FIG. 21 is a side view for explaining a switching process of the folding virtual reality device of FIG. 20, FIG. 22 is a side view for explaining the expansion state of the folding virtual reality device of FIG. 20.

In FIGS. 20 to 22, the folding virtual reality device according to the present embodiment includes a casing (1310) for accommodating a cell phone (10) including a display (12), and a switching body (1380) for sliding and rotating of the casing (1310). The switching body (1380) may include a screen member (1330) and an ocular plate (1320) attached to the screen member (1330).

In another embodiment according to FIGS. 20 to 22, the foldable virtual reality device is mounted on the cell phone (10) including the display (12) and the cell phone (10) so as to be able to slide and rotate and a switching body (1380). The switching body (1380) may also include a screen member (1330) and an ocular plate (1320) mounted to the screen member (1330).

The casing (1310) and the switching body (1380) are interconnected via a rail body (1385). Specifically, the rail body (1385) is mounted on one side of the casing (1310) so that it can rotate and is connected to the switching body (1380) via a rail (1382) so that it can slide. Accordingly, the switching body (1380) is capable of sliding and rotating relative to the casing (1310) and can be switched between the front and back surfaces of the main body (1380).

As shown in FIG. 21, the switching body (1380) can slide along the rail body (1385) and is rotatable with the rail body (1385). Therefore, it is possible to move to the back face and the front face of the cell phone (10) accommodated in the casing (1310) and the casing (1310) by varying the forward and backward directions through the slide movement and the rotation movement. The display (12) of the cell phone (10) housed in the casing (1310) is rotated in the vertical direction when the switching body (1380) is kept in close contact with the back surface of the cell phone (10) accommodated in the casing (1310) and the casing (1310). And it may function as a communication device when a communication module is mounted in the casing (1310) or the switching body (1380).

Then as shown in FIG. 22, when the switching body (1380) is kept in close contact with the front surface of the cell phone (10) accommodated in the casing (1310) and the casing (1310), the ocular plate (1320) and the screen member (1330) can be expanded using a plurality of screen barrels.

Although not shown, the screen member (1330) can maintain a detached state by using its own frictional force and can be used as a spacing device or a distance adjusting portion, such as a hydraulic cylinder, a pneumatic cylinder, an antenna lever, a solenoid, or the like may be used. The detaching device or the distance adjusting portion may be mounted on the outside or the inside of the screen member (1330).

In a state in which the screen member (1330) is in close contact with the front face of the cell phone (10) accommodated in the casing (1310) and the casing (1310), the ocular plate (1320) and the screen member (1330) are extended Moreover, as described above, the virtual reality function can be performed through the display (12) when the ocular plate (1320) is in a detached state.

In the present embodiment, the switching body (1380) is switched by the rail body (1385) mounted on the longitudinal side of the main body (1310), but the switching body (1380) is provided with the rail. It is also possible to form a body or other structure, and to switch the position on the short side.

The technical features described in this embodiment are applicable to other embodiments, and those skilled in the art will be able to modify the embodiment in accordance with the ordinary creative ability.

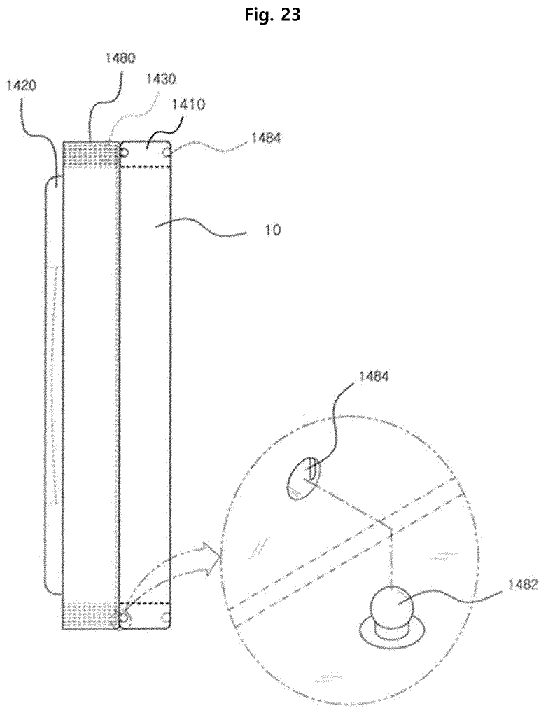

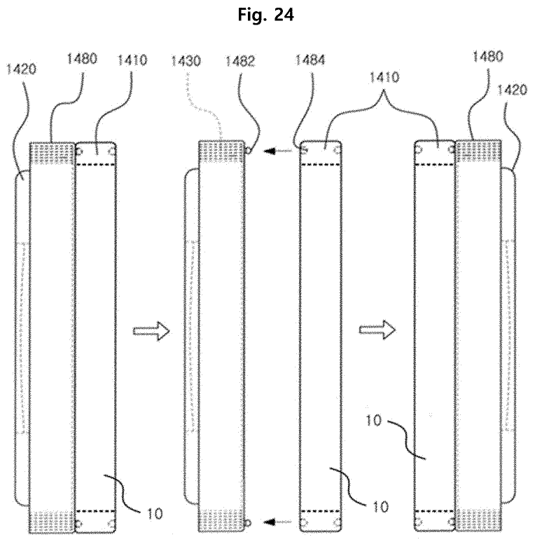

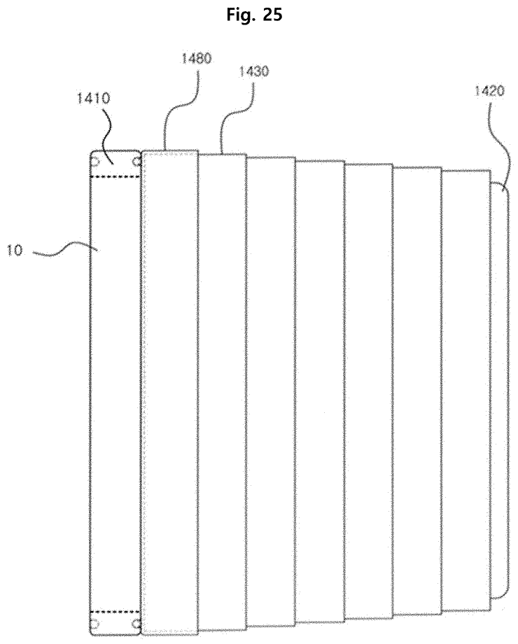

FIG. 23 is a perspective view for explaining a folding virtual reality device according to an embodiment of the present invention, FIG. 24 is a side view for explaining a switching process of the folding virtual reality device of FIG. 23, FIG. 25 is a side view for explaining the expansion state of the folding virtual reality device of FIG. 23.

Referring to FIGS. 23 to 25, the folding virtual reality device according to the present embodiment includes a casing (1410) that accommodates a cell phone (10) including a display (12), and a casing (1410) that is provided on the front and back surfaces of the casing (1410) and a switching body (1480) which is switched off and on. The switching body (1480) may include a screen member (1430) and an ocular plate (1420) mounted to the screen member (1430).

The casing (1410) and the switching body (1480) can be mutually bound and separated using the detachable buttons (1482) and (1484) and the same front and rear binding relationship can be established to switch the front and back sides can be mounted in the same manner. In addition to the detachable buttons (1482) and (1484), the casing (1410) and the switching body (1480) can be detachably attached to each other using at least one of a magnet buttons, a coupling protrusion-groove structure, and a suction plate.

As shown in FIG. 24, the switching body (1480) can be mounted on the rear face and the front face of the casing (1410) with the front and rear direction being different using the detachable buttons (1482) and (1484). The display (12) of the cell phone (10) may display an image or a user interface for multimedia and may include a casing (1410) or a switch (1410).

When the communication module is mounted on the body (1480), it can function as a communication device as shown in FIG. 25, and the ocular plate (1420) can be extended in a spaced apart state, and the screen member (1430) can be separated from the screen member (1430). Furthermore, when the switching body (1480) is kept in close contact with the front surface of the casing (1410), can also be expanded using a plurality of screen barrels.

Although not shown, the screen member (1430) can maintain a spacing state by using its own frictional force, and can be used as a detaching device or a distance adjusting portion such as a hydraulic cylinder, a pneumatic cylinder, an antenna lever, a solenoid, and the distance separating unit may be mounted on the outside or the inside of the screen member (1430).

In addition, in a state in which the screen member (1430) is in close contact with the front surface of the casing (1410) on which the display is formed, the ocular plate (1420) and the screen member (1430) can be extended in a detached state. Moreover, as described above, when the ocular plate (1420) is in the separated state, the virtual reality function can be performed through the display.

The technical features described in this embodiment are applicable to other embodiments, and those skilled in the art will be able to modify the embodiment in accordance with the ordinary creative ability.

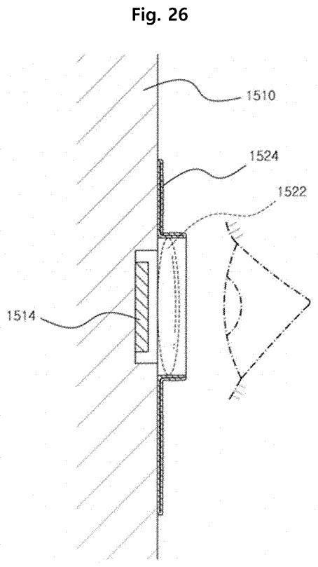

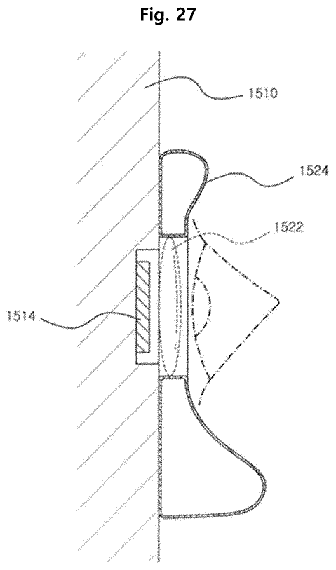

FIG. 26 is a partially enlarged cross-sectional view for explaining a folding virtual reality device according to an embodiment of the present invention, and FIG. 27 is a partially enlarged cross-sectional view for explaining the operation of the folding virtual reality device of FIG. 26.

Referring to FIG. 26 and FIG. 27, the virtual reality device according to the present embodiment includes a main body (1510), a pair of video emitting units (1514) formed on one surface of the main body (1510), and an ocular lens (1522) mounted at a close distance to each of the light emitting portions (1514).

In one embodiment according to FIGS. 26 and 27, the main body (1510) includes a casing that accommodates a cell phone and a cell phone. In another embodiment, main body (1510) may be a computing device that includes at least one processor and a display.

The video emitting unit (1514) may be a display or a projector. In this embodiment, the video light emitting unit (1514) can display an image at a high resolution as a display and can provide an enlarged image through the ocular lens (1522). However, in another embodiment, the image-emitting unit can function as a projector that projects a specific image through the ocular lens to the retina.

In the present embodiment, the video emitting portion (1514) and the ocular lens (1522) are fixed and may not require the function of the screen member to move the ocular plate in close contact and detached as in the previous embodiment as the proximity distance. Therefore, the folding virtual reality device according to the present embodiment can be kept thin and compact.

In addition, the folding virtual reality device may further include an eyecup (1524) mounted on an ocular lens. The eyecup (1524) is for blocking unnecessary light from entering the ocular lens (1522) and can be concave corresponding to the face shape around the eye.

In this embodiment, the eyecup (1524) is a deformable structure that can be converted into a flat state in which it is in close contact with the main body (1510) and a bent state corresponding to the shape of the eye around the face, the shape can be changed by using tube shape deformation due to air entering and leaving, deformation caused by shape memory alloy, deformation due to electric application, or others.

The technical features described in the present embodiment can be applied to other embodiments. Those relevant to the field of technology can use the ordinary creative ability to modify them according to other embodiments.

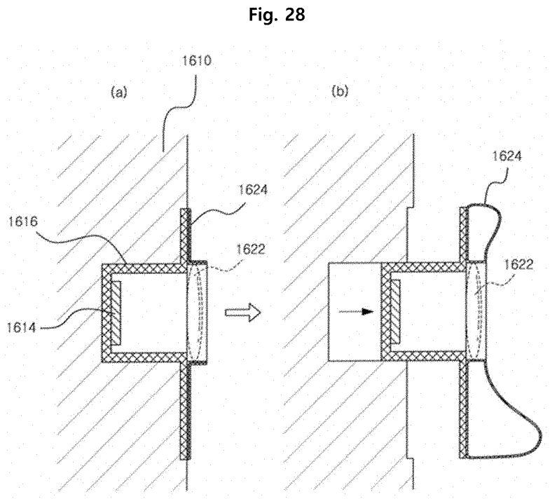

FIG. 28 is a partially enlarged sectional view illustrating a foldable virtual reality device according to an embodiment of the present invention.

In an embodiment according to FIG. 28, the main body (1610) includes a cell phone and a casing that accommodates cell phone. In another embodiment, the main body (1610) may be a computing device that includes at least one processor and a display.

Referring to FIG. 28, the virtual reality device according to the present embodiment includes a main body (1610), a pair of image light emitting area (1614) formed on one side of the main body (1610), an ocular lens (1622) mounted on each of the image light emitting area (1614) at a close distance, and a barrel member (1616) that includes image light emitting area (1614) and ocular lens (1622).

The image light emitting area (1614) may be a display or a projector. In the present embodiment, the image light emitting area (1614) can show an image at a high resolution as a display and provide an enlarged image through an ocular lens (1622). However, in another embodiment, the image light emitting area can function as a projector to project a specific image to the retina through an ocular lens.

In the present embodiment, the image light emitting area (1614) and the ocular lens (1622) maintain the fixed distance, which may not require the function of the screen member for moving the ocular plate in the close contact state and the separated state as in the previous embodiment. Therefore, the foldable virtual reality device according to the present embodiment can remain thin and compact.

As illustrated in FIG. 28 (b), the barrel member (1616) can move the image light emitting area (1614) along with the ocular lens (1622) and can be separated from the left and right. The foldable virtual reality device can correspond to the shape of the face and its bending such as nose, the ocular lens (1622) can be closely attached to the main body (1610) along with the barrel member (1616) and can be drawn out from the main body (1610).

In addition, the foldable virtual reality device can further include an eyecup (1624) mounted on the ocular lens (1622). The eyecup (1624) is for blocking unnecessary light from entering the ocular lens (1622), and may be formed corresponding to the shape of the face around the eyes.

In the present embodiment, the eyecup (1624) is a transformable structure and it can be changed to a bent state corresponding to planar shape of the face with eyes closely adhered to the main body (1610). At this time, the eyecup (1624) enables the shape to transform using tube type transformation due to air entry, shape memory alloy transformation, electric field transformation, or the like.

The technical features described in the present embodiment can be applied to other embodiments. Those relevant to the field of technology can use the ordinary creative ability to modify them according to other embodiments.

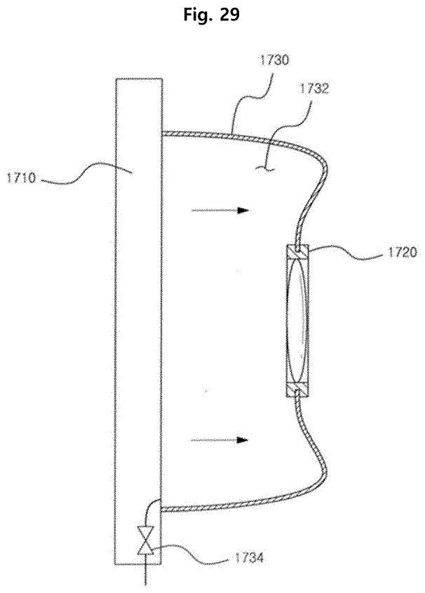

FIG. 29 is a sectional view illustrating a foldable virtual reality device according to an embodiment of the present invention.

In an embodiment according to FIG. 29, the main body (1710) includes a cell phone and a casing that accommodates cell phone. In another embodiment, the main body (1710) may be a computing device that includes at least one processor and a display.

Referring to FIG. 29, the foldable virtual reality device includes a main body (1710) including a virtual reality display, an ocular plate (1720) which is capable of maintaining a variable distance from the main body (1710), and a screen member (1730) interposed between a main body (1710) and an ocular plate (1720). The screen member (1730) can move the ocular plate (1720) between the main body (1710) and the ocular plate (1720) which is in close contact and separated state maintaining a predetermined distance.

The screen member (1730) can be changed into shape so that the ocular plate (1720) moves through the air in and out as an air tube in a close contact state or a separated state. When the ocular plate (1720) is in the separated state, the virtual reality function can be implemented through the virtual reality display of the main body (1710).

Various methods can be applied to blow air into the screen member (1730). As an example, air can be blown through the nozzle of the tube into the mouth or through a separate manual pump. However, in the present embodiment, it can further include a bidirectional pump 1734 for allowing air to automatically enter the screen member (1730).

In addition, the screen member (1730) may be expanded and reduced as a whole by forming a space between the display and the screen member as a closed tube space (1732). It can blow air using a pump 1734 as well as form substantive vacuum for easy storage by deflating air so that the screen member (1730) can closely contact with the display of the device

The technical features described in the present embodiment can be applied to other embodiments. Those relevant to the field of technology can use the ordinary creative ability to modify them according to other embodiments.

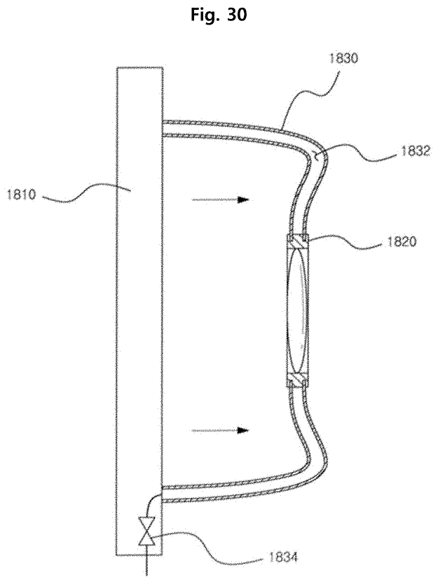

FIG. 30 is a sectional view illustrating a foldable virtual reality device according to an embodiment of the present invention.

In an embodiment based on FIG. 30, the main body (1810) includes a cell phone and a casing that accommodates cell phone. In another embodiment, the main body (1810) may be a computing device that includes at least one processor and a display.

Referring to FIG. 30, the foldable virtual reality device includes a main body (1810) including a virtual reality display, an ocular plate (1820) which is capable of maintaining a variable distance from the main body (1810), and a screen member (1830) interposed between a main body (1810) and an ocular plate (1820). The screen member (1830) can move the ocular plate (1820) between the main body (1810) and the ocular plate (1820) which is in close contact and separated state maintaining a predetermined distance.

The screen member (1830) can be changed into shape so that the ocular plate (1820) moves through the air in and out as an air tube in a close contact state or a separated state. When the ocular plate (1820) is in the separated state, the virtual reality function can be implemented through the virtual reality display of the main body (1810).

Various methods can be applied to blow air into the screen member (1830). As an example, air can be blown through the nozzle of the tube into the mouth or through a separate manual pump. However, in the present embodiment, it can further include a bidirectional pump 1834 for allowing air to automatically enter the screen member (1830).

In addition, the screen member (1830) is formed in a double-walled structure and the inner space of the screen member (1830) may be expanded and reduced as a whole by forming inner space as a closed tube space (1832). It can blow air using a pump 1834 as well as form substantive vacuum for easy storage by deflating air so that the screen member (1830) can closely contact with the display of the device.

The technical features described in the present embodiment can be applied to other embodiments. Those relevant to the field of technology can use the ordinary creative ability to modify them according to other embodiments.

FIG. 31 is a sectional view illustrating a foldable virtual reality device according to an embodiment of the present invention.

Referring to FIG. 31, the foldable virtual reality device includes a main body (1910) including a virtual reality display, an ocular plate (1920) which is capable of maintaining a variable distance from the main body (1910), and a screen member (1930) interposed between a main body (1910) and an ocular plate (1920). The screen member (1930) can move the ocular plate (1920) between the main body (1910) and the ocular plate (1920) which is in close contact and separated state maintaining a predetermined distance.

In an embodiment based on FIG. 31, the main body (1910) includes a cell phone and a casing that accommodates cell phone. In another embodiment, the main body (1910) may be a computing device that includes at least one processor and a display.

The screen member (1930) can be changed into shape so that the ocular plate (1920) moves through the air in and out as an air tube in a close contact state or a separated state. When the ocular plate (1920) is in the separated state, the virtual reality function can be implemented through the virtual reality display of the main body (1910).

Various methods can be applied to blow air into the screen member (1930). As an example, air can be blown through the nozzle of the tube into the mouth or through a separate manual pump. However, in the present embodiment, it can further include a bidirectional pump 1934 for allowing air to automatically enter the screen member (1930).

In addition, the screen member (1930) is formed to have an air frame, and the airway space may be formed as a closed tube space (1932) that can be expanded and reduced as a whole. It can blow air using a pump (1934) as well as form substantive vacuum for easy storage by deflating air so that the screen member (1930) can closely contact with the display of the device.

The technical features described in the present embodiment can be applied to other embodiments. Those relevant to the field of technology can use the ordinary creative ability to modify them according to other embodiments.

FIG. 32 is a sectional view illustrating a foldable virtual reality device according to an embodiment of the present invention.

In an embodiment according to FIG. 32, the main body (2110) includes a cell phone and a casing that accommodates cell phone. In another embodiment, the main body (2110) may be a computing device that includes at least one processor and a display.

Referring to FIG. 32, the foldable virtual reality device includes a main body (2110) including a virtual reality display, a pair of ocular plates (2120, 2121) which is capable of maintaining a variable distance from the main body (2110), and screen members (2130), (2131) interposed between a main body (2110) and ocular plates (2120, 2121). In the present embodiment, the screen members (2130, 2131) are provided separately from left and right and the ocular plate (2120) can also be provided separately

In addition, in case of the same pumps, it can be simultaneously expanded and contracted. However, when the pumps are provided independently from the left and right, they may be adjusted so that the tiny adjustment of the left and right is possible. Also, although the same pump is used, the left and right can be adjusted by using the intermediate valve.

Describing one side first, the screen member (2130) can move the ocular plate (2120) between the main body (2110) and the ocular plate (2120) which is in close contact and separated state maintaining a predetermined distance. The screen member (2130) can be changed into shape so that the ocular plate (2120) moves through the air in and out as a n air tube in a close contact state or a separated state. Of course, the other side can work the same way.

When the ocular plates (2120, 2121) are in the separated state, the virtual reality function can be implemented through the virtual reality display of the main body (2110).

In the present embodiment, similar to the embodiment of FIG. 29, the screen members (2130, 2131) may form a closed tube space between the display and the screen member to expand and contract as a whole. However, the screen member can be formed in a double-walled structure, similar to the embodiment of FIG. 30, and an air frame can also be formed on the screen member, similar to the embodiment of FIG. 31.

The technical features described in the present embodiment can be applied to other embodiments. Those relevant to the field of technology can use the ordinary creative ability to modify them according to other embodiments.

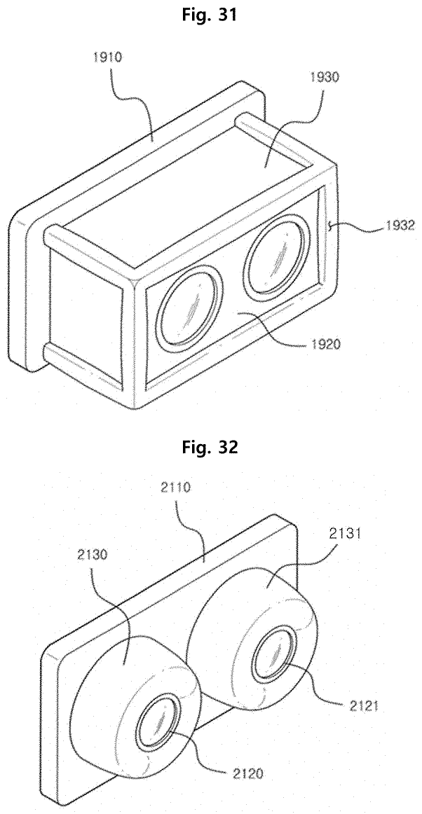

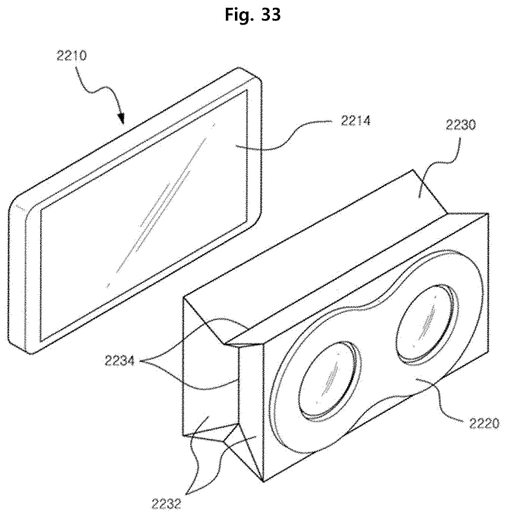

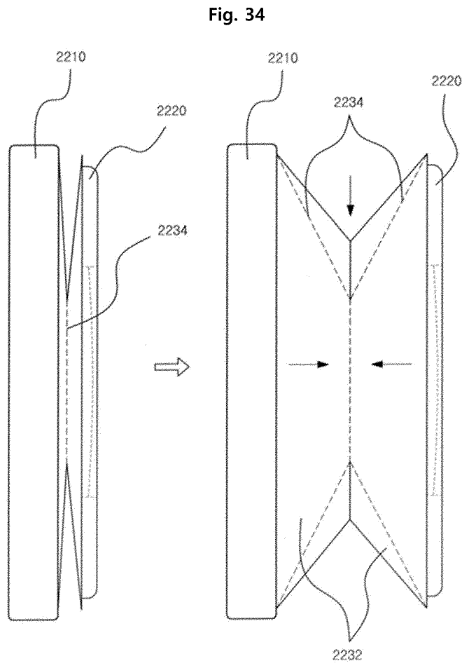

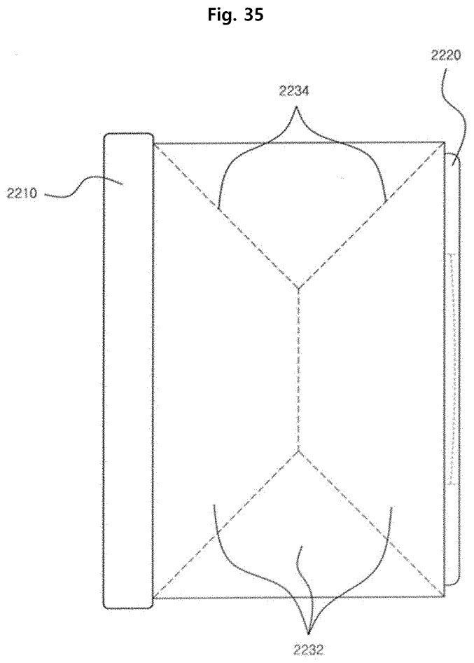

FIG. 33 is a perspective view illustrating a foldable virtual reality device according to an embodiment of the present invention, FIG. 34 is a lateral view illustrating the operation of the screen member in the foldable virtual reality device of FIG. 33, and FIG. 35 is a lateral view illustrating the expanded state of the foldable virtual reality device.

Referring to FIG. 33 to 35, the foldable virtual reality device includes a main body (2210) including a virtual reality display (2214), an ocular plate 2220 which is capable of maintaining a variable distance from a main body (2210), and a screen member (2230) interposed between a main body (2210) and an ocular plate 2220. The screen member (2230) can move the ocular plate 2220 between the main body (2110) and the ocular plate 2220 which is in close contact and separated state maintaining a predetermined distance.

In an embodiment according to FIG. from 33 to 35, the main body (2210) includes a cell phone and a casing that accommodates cell phone. In another embodiment, the main body (2210) may be a computing device that includes at least one processor and a display.

The screen member (2230) is provided using pieces (2232) connected via folding line 2234 and the shape can be changed so that the ocular plate 2220 moves in close contact or in a separated state while the pieces (2232) are folded to each other. When the ocular plate 2220 is in the separated state, the virtual reality function can be implemented through the virtual reality display (2214) of the main body (2210). When the ocular plate 2220 is in the separated state, the virtual reality function can be implemented through the virtual reality display (2214) of the main body (2210).

In the present embodiment, the screen member (2230) can be formed with a composite material using a synthetic resin panel, a metal thin film, and a rubber, or using paper, or the like. Also, the screen member (2230) may be flatly attached like box-folding method and then expanded to be separated state.

In the present embodiment, the screen member (2230) are formed in a rectangular box shape. The pieces (2232) are connected so that the upper and lower plates are easily folded in half, and the upper and lower edges of the left and right plates are folded in half. However, the screen member (2230) can be folded and expanded in various three-dimensional shapes and the combination of pieces can be variously changed. For example, the pieces may be connected so that the left and right plates are simply folded in half and the upper and lower edges of the upper and lower plates are folded in half.

The technical features described in the present embodiment can be applied to other embodiments. Those relevant to the field of technology can use the ordinary creative ability to modify them according to other embodiments.

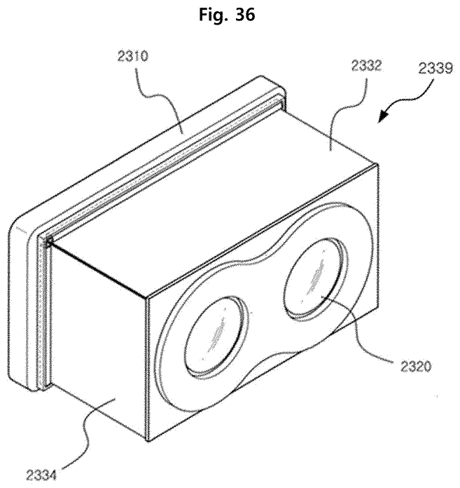

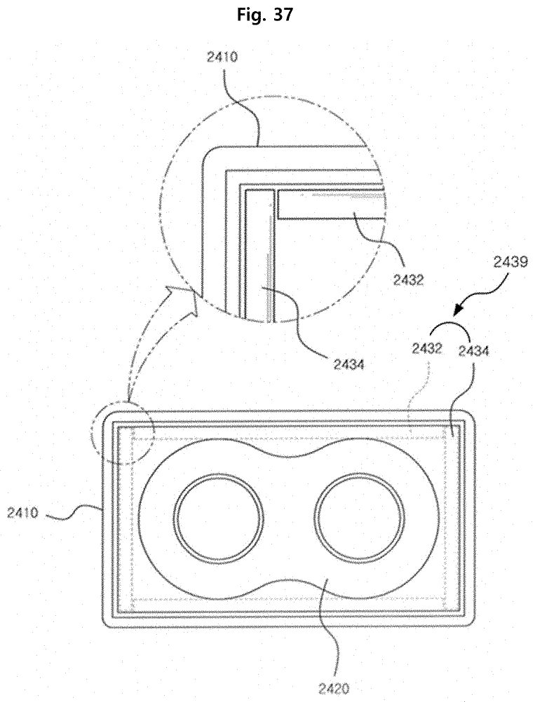

FIG. 36 is a perspective view illustrating a foldable virtual reality device according to an embodiment of the present invention and FIG. 37 is a rear view illustrating a foldable virtual reality device according to an embodiment of the present invention.

Referring to FIG. 36, the foldable virtual reality device according to the present embodiment includes a main body (2310) including a virtual reality display, an ocular plate (2320) which is capable of maintaining a variable distance from the main body (2310), and a screen member (2339) interposed between a main body (2310) and the ocular plate (2320). The screen member (2339) can move the ocular plate (2320) between the main body (2310) and the ocular plate (2320) which is in close contact and separated state maintaining a predetermined distance.

In an embodiment according to FIG. 36, the main body (2110) includes a cell phone and a casing that accommodates cell phone. The screen member (2339) shown in FIG. 36 is connected to the casing included in the main body (2310).

In another embodiment, the main body (2310) may be a computing device that includes at least one processor and a display.

In the present embodiment, the screen member (2339) is provided using the roll screens (2332), (2334). When the ocular plate (2320) is in the separated state, the virtual reality function can be implemented through the virtual reality display of the main body (2310). In the present embodiment, 4 of the roll screens (2332, 2334) are provided in pairs of two.

The roll screens (2332, 2334) can release the wound screen backward while the ocular plate (2320) moves in the separated state and can provide restoring force by being automatically wound when the ocular plate (2320) is returned to the close contact state.

Although it is not shown in the Figure, the screen member (2330) can maintain the separated state and the link member shown in FIGS. 11 to 13 may be used. As a distance control unit, various actuators can be used such as a hydraulic cylinder, a pneumatic cylinder, an antenna rack, a solenoid, a coil spring, a shape memory alloy, or the like, and spacing device or a distance control unit can be mounted on the outside or inside of the screen member (2330).

Referring to FIG. 37, the foldable virtual reality device according to the present embodiment includes a main body (2410) including a virtual reality display, an ocular plate (2420) which is capable of maintaining a variable distance from the main body (2410), and a screen member (2439) interposed between a main body (2410) and the ocular plate (2420). The screen member (2439) can move the ocular plate (2420) between the main body 4310 and the ocular plate (2420) which is in close contact and separated state maintaining a predetermined distance.

In an embodiment according to FIG. 37, the main body (2410) includes a cell phone and a casing that accommodates cell phone. The screen member (2439) shown in FIG. 37 is connected to the casing included in the main body (2410).

In another embodiment, the main body (2410) may be a computing device that includes at least one processor and a display.

In the present embodiment, the screen member (2439) is provided using the roll screens (2432), (2434). When the ocular plate (2420) is in the separated state, the virtual reality function can be implemented through the virtual reality display of the main body (2410). In the present embodiment, 4 of the roll screens (2432), (2434) are provided in pairs of two.

The roll screens (2432), (2434) can release the wound screen backward while the ocular plate (2420) moves in the separated state and can provide restoring force by being automatically wound when the ocular plate (2420) is returned to the close contact state.

Although it is not shown in the Figure, the screen member (2430) can maintain the separated state and the link member shown in FIG. from 11 to 13 may be used. As a spacing device or a distance control unit, various actuators can be used such as a hydraulic cylinder, a pneumatic cylinder, an antenna rack, a solenoid, a coil spring, a shape memory alloy, or the like, and spacing device or a distance control unit can be mounted on the outside or inside of the screen member (2430).

In the present embodiment, the boundary of the vertical roll screen (2434) is formed so as to partially cover the boundary of the horizontal roll screen (2432) and the ends of the roll screens are partially overlapped so as to effectively block inflow of light from the outside.

In the present embodiment, the roll screens are drawn out from the main body. On the contrary to this, however, in another embodiment, it can be mounted so as to be drawn out of the ocular plate and the roll screen may be drawn out together at both the main body and the ocular plate so as to meet each other at an intermediate point. In addition, the roll screen may not be separated and the screen that forms the closed curved surface may be designed to be rolled up into a circular or a square core and drawn out simultaneously.

The technical features described in the present embodiment can be applied to other embodiments. Those relevant to the field of technology can use the ordinary creative ability to modify them according to other embodiments.

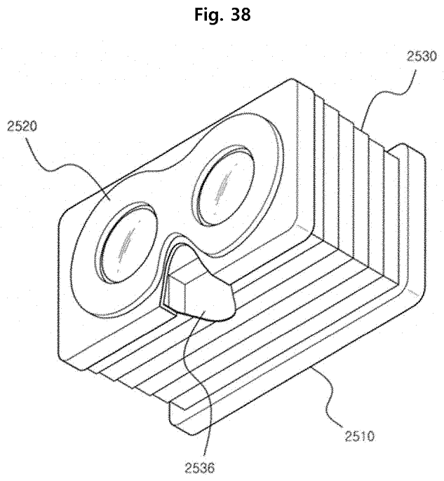

FIG. 38 is a bottom rear perspective view of a foldable virtual reality device according to an embodiment of the present invention.

Referring to FIG. 38, the foldable virtual reality device includes a main body (2510) including a virtual reality display, an ocular plate (2520) which is capable of maintaining a variable distance from the main body (2510), and a screen member (2530) interposed between a main body (2510) and the ocular plate (2520). The screen member (2530) can move the ocular plate (2520) between the main body (2510) and the ocular plate (2520) which is in close contact and separated state maintaining a predetermined distance.

In an embodiment according to FIG. 38, the main body (2510) includes a cell phone and a casing that accommodates cell phone. The screen member (2530) shown in FIG. 36 is connected to the casing included in the main body (2510).

In another embodiment, the main body (2510) may be a computing device that includes at least one processor and a display.

According to the present embodiment, an indentation (2536) can be formed in the ocular plate (2520) or screen member (2530) to accommodate the nose of the body. Therefore, when the ocular plate (2520) is in the separated state, the ocular plate (2520) can be brought into close contact with the face without engaging the nose of the user and the virtual reality function can be implemented through the display of the main body (2510).

For reference, other composition except for the indentation (2536) can be applied to the composition of the previous embodiment and it can also be provided including the indentation or the like of the composition that uses the switching body illustrated in FIG. from 14 to 25. As it is described, the technical features described in the present embodiment can be applied to other embodiments. Those relevant to the field of technology can use the ordinary creative ability to modify them according to other embodiments.

Further, a vent (2538) may be formed in the ocular plate around the ocular lens and the vent (2538) may function similar to that formed in the screen member.

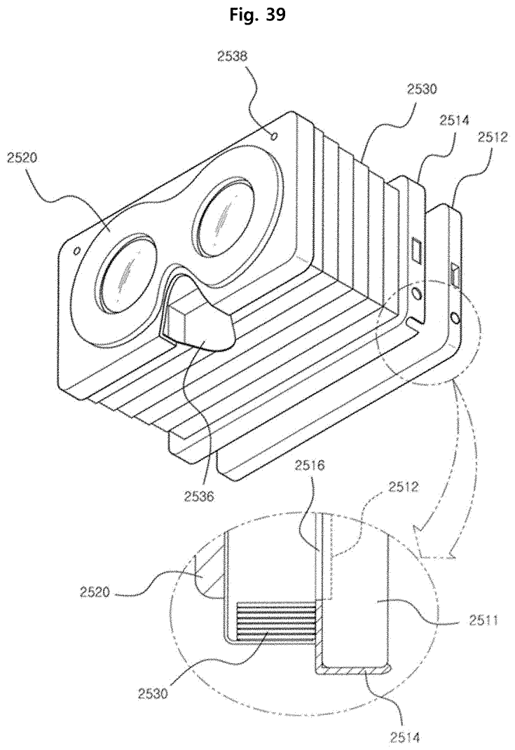

FIG. 39 is a bottom rear perspective view of a foldable virtual reality device according to an embodiment of the present invention.

Referring to FIG. 39, the cell phone (2511) is not directly connected to the screen member (2530), but the cell phone (2511) is indirectly capable of functioning as the virtual reality device through the protective case frame (2514) that accommodates the cell phone (2511).

In this case, the cell phone (2511) may be a terminal, a cell phone, or an electronic device without a foldable virtual reality device function and a through hole 2516 that corresponds to the display (2512) may be formed on the inner surface of the protective case frame (2514). Accordingly, the user normally mounts the display (2512) facing the outside of the case and switches the display (2512) of the cell phone (2511) to face inward to implement the virtual reality function so that the protective case frame (2514) can be fixed.

The technical features described in the present embodiment can be applied to other embodiments. Those relevant to the field of technology can use the ordinary creative ability to modify them according to other embodiments.

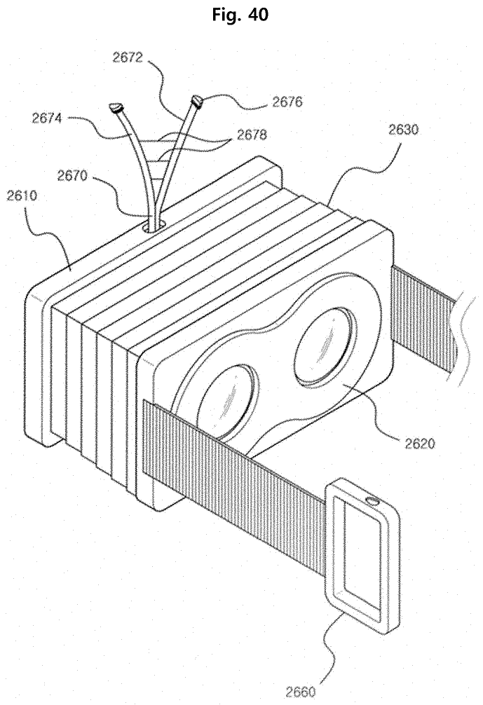

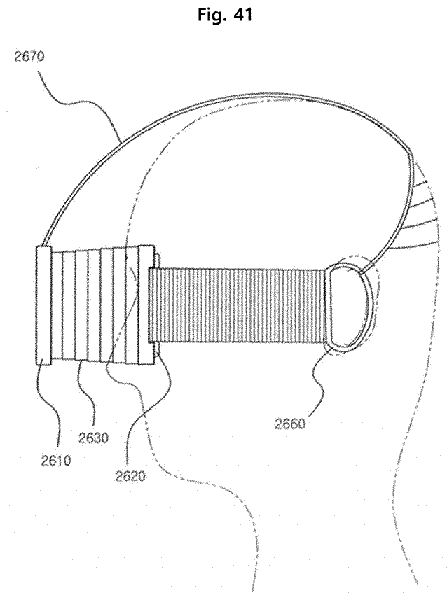

FIG. 40 is a perspective view illustrating a foldable virtual reality device according to an embodiment of the present invention and FIG. 41 is a lateral view describing an example of use of FIG. 40 foldable virtual reality device.

Referring to FIG. 40 and FIG. 41, the foldable virtual reality device includes a main body (2610) including a virtual reality display, an ocular plate (2620) which is capable of maintaining a variable distance from the main body (2610), a screen member (2630) interposed between a main body (2610) and an ocular plate (2620), and a fastening member for fixing a main body (2610) and ocular plate (2620) to the user's face.

In an embodiment according to FIG. 40 and FIG. 41, the main body (2610) includes a cell phone and a casing that accommodates cell phone. The screen member (2630) shown in FIG. 40 and FIG. 41 is connected to the casing included in the main body (2610).

In another embodiment, the main body (2610) may be a computing device that includes at least one processor and a display.

The screen member (2630) is for moving the ocular plate (2620) between the main body (2610) and the ocular plate (2620) which comes into close contact and separated state maintaining a predetermined distance as well as it can use various materials, structures, and operation principles illustrated in the previous embodiment.

The fastening member includes a horizontal band (2660) extending from the side of the main body or ocular plate and a center band (2670) which is partially fastened to the horizontal band (2660) and extends from the upper-center of the main body or ocular plate.

In the present embodiment, the horizontal band (2660) extends in connection with the ocular plate (2620) and is tied to the user's ear, left to right, but in other embodiments, it may extend from the main body and form a band so that they may be tied together at the back of the head.

The center band (2670) is also connected to the upper-center of the main body (2610), but may also be connected to the ocular plate.

In the present embodiment, the center band (2670) branches in a Y-shape to form a first branch line (2672) and a second branch line (2674). At the ends of those branched first (2672) and second (2674) branch lines, bonding ports (2676) may be formed to be fixed to the horizontal bond (2660), respectively.

In addition, the center band (2670) can include one or more tension lines (2678) that laterally connect the first branch line (2672) and the second branch line (2674). The tension line (2678) prevents the first branch line (2672) and the second branch line (2674) from being excessively apart so that the center band (2670) stably supports the back of the head without being taken off from the head.

The center band (2670) and the horizontal band (2660) may be separately connected to the main body (2610) or the ocular plate (2620), however as illustrated in the Figure, they remain built inside of the main body or the ocular pate and may be provided in a form that can be built in so as to be drawn out with a predetermined restoring force.

The technical features described in the present embodiment can be applied to other embodiments. Those relevant to the field of technology can use the ordinary creative ability to modify them according to other embodiments.

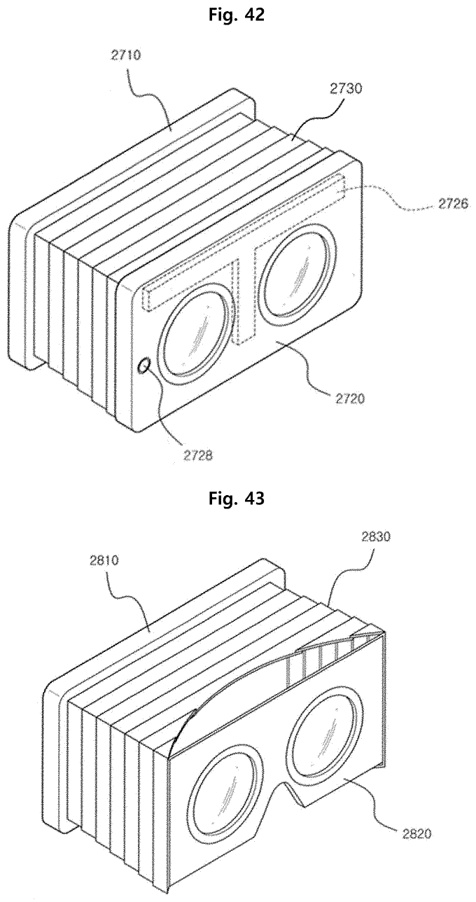

FIG. 42 is a perspective view illustrating a foldable virtual reality device according to an embodiment of the present invention

Referring to FIG. 42, the foldable virtual reality device according to the present embodiment includes a main body (2710) including a virtual reality display, an ocular plate (2720) that can maintain a variable distance from the main body (2710) and has built-in battery (2710) for operating the main body (2710), and a screen member (2730) interposed between a main body (2710) and ocular plate (2720). The screen member can move the ocular plate (2720) between the main body and the ocular plate (2720) which comes into close contact and separated state maintaining a predetermined distance. When the ocular plate (2720) is in the separated state, the virtual reality function can be implemented through the virtual display of the main body (2710).

In an embodiment according to FIG. 42, the main body (2710) includes a cell phone and a casing that accommodates cell phone. The screen member (2630) shown in FIG. 42 is connected to the casing included in the main body (2710).

In another embodiment, the main body (2710) may be a computing device that includes at least one processor and a display.

As described in the previous embodiment, the foldable virtual reality device can be fastened to the user's face using a fasten member. In other embodiment, accessories such as a display, a battery, and a camera may be mounted on the main body (2710). Since the main body (2710) is located the farthest from the main body (2710), a large load may be applied to the user.

However, in the present embodiment, relatively heavy parts such as the battery 2726 can be placed on the ocular plate (2720) and other accessories can be placed on the ocular plate. Therefore, only the display and related accessories that are lightweight can be placed on the main body (2710) and the parts that are functionally necessary but burdened with loads can also be mounted on the ocular plate.

Specifically, the ocular plate (2720) may further include at least one among a camera 2728, a main board, and an antenna for the foldable virtual reality device and may include a fasten member to temporarily fix the foldable virtual reality device to the user's face.

In the present embodiment, the screen member (2730) is for moving the ocular plate (2720) between the main body (2710) and the ocular plate (2720) which comes into close contact and separated state maintaining a predetermined distance as well as it can use the screen member of various materials, structures, and operation principles illustrated in the previous embodiment.

The technical features described in the present embodiment can be applied to other embodiments. Those relevant to the field of technology can use the ordinary creative ability to modify them according to other embodiments.

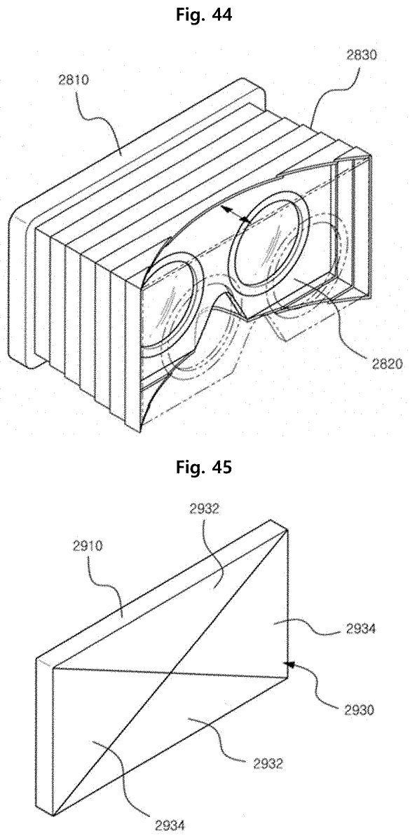

FIG. 43 is a perspective view for describing a state in which a screen member is expanded in a foldable virtual reality device according to an embodiment of the present invention and FIG. 44 is a perspective view describing a state in which the ocular plate is moved inward in the foldable virtual reality device of FIG. 43.

Referring to FIG. 43 and FIG. 44, the foldable virtual reality device includes a main body (2810) including a virtual reality display, an ocular plate (2820) which is capable of maintaining a variable distance from the main body (2810), and a screen member (2830) interposed between a main body (2810) and the ocular plate (2820). The screen member (2830) can move the ocular plate (2820) between the main body (2810) and the ocular plate (2820) which comes in close contact and separated state maintaining a predetermined distance.

In an embodiment according to FIG. 43 and FIG. 44, the main body (2810) includes a cell phone and a casing that accommodates cell phone. The screen member (2830) shown in FIG. 43 and FIG. 44 is connected to the casing included in the main body (2810).

In another embodiment, the main body (2810) may be a computing device that includes at least one processor and a display.

As illustrated in FIG. 43, in a state in which the screen member is extended, an indentation-receiving portion (2836) that corresponds to the contour of the end of facial side is formed and the ocular plate (2820) can move together when the screen member (2830) is switched to the extended state.

Additionally, as illustrated in FIG. 44, the ocular plate (2820) can be moved and fixed in the forward and backward directions within a predetermined range inside the screen member (2830) in a state in which the screen member (2830) is extended. When the ocular plate (2820) is suitably separated apart to implement the virtual reality function, i.e., in a separated state, the virtual reality function may be implemented through the display of the main body (2810).

For reference, in order to limit the distance of the ocular plate (2820), the wire may be further included connecting the ocular plate (2820) and the end of the screen member (2830). Wire can prevent the ocular plate (2820) from entering the inside beyond a predetermined distance when the screen member gets extended as illustrated in FIG. 43.

Herein, the ocular plate (2820) or the screen member (2830) may further include an indentation corresponding to the nose of the user and the screen member (2830) includes a plural screen boxes which slide-move and are fixed to each other while being stacked rearward.

Although the screen member (2830) in the present embodiment is implemented using a plural screen boxes, it is possible to use screen members of various materials, structures and operating principles that are described in the previous embodiments and it can be also applied to a structure that can be selective brought into close contact with the front or back surface of the main body using a switching body.

Further, among the multiple screen boxes, the screen box forming the screen member (2830) can be formed using rubber or soft synthetic resin so that they can maintain the mutual connection even when separated and it is possible to prevent a face from being scratched or a cool cold air being directly transmitted in a part that is touching the face.

The technical features described in the present embodiment can be applied to other embodiments. Those relevant to the field of technology can use the ordinary creative ability to modify them according to other embodiments.

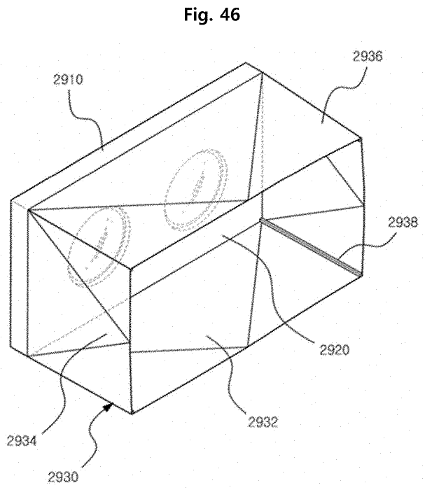

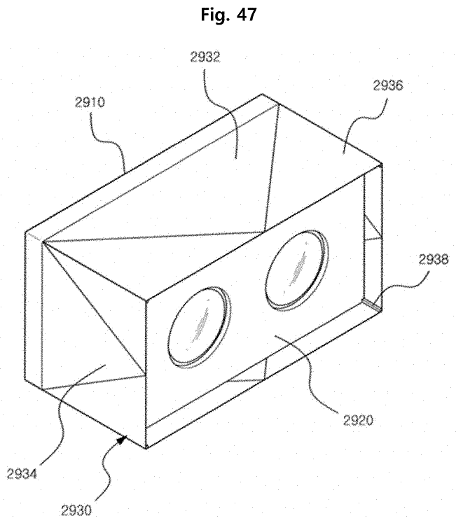

FIG. 45 is a perspective view for describing a closing state of the foldable virtual reality device according to an embodiment of the present invention, FIG. 46 is a perspective view for describing a process of switching the foldable virtual reality device of FIG. 45 to a blooming state, and FIG. 47 is a perspective view for describing a case where the foldable virtual reality device of FIG. 45 is in a blooming state.

Referring to FIG. from 45 to 47, the foldable virtual reality device includes a main body (2910) including a virtual reality display (not illustrated), an ocular plate (2920) which is capable of maintaining a variable distance from the main body (2910) which comes in close contact and separated state maintaining a predetermined distance from the main body (2910) while moving, and a screen member (2930) including flip covers (2932), (2934) which are mounted on the rear edge of the main body (2910) so that it can rotate.

In an embodiment according to FIG. from 45 to 47, the main body (2910) includes a cell phone and a casing that accommodates cell phone. The screen member (2930) shown in FIG. from 45 to 47 is connected to the casing included in the main body (2910).

In another embodiment, the main body (2910) may be a computing device that includes at least one processor and a display.

Four flip covers (2932) and (2934) are respectively mounted on four corners of the main body (2910). In the closing state, the flip covers (2932) and (2934) cover the ocular plate (2920) which comes into the close contact state and in the blooming state, the light that enters through the gap between the ocular plate and the main body (2910) in separated state can be blocked.

When the ocular plate (2920) is in the separated state the virtual reality function can be implemented through display of the main body (2910). In the closed state, the flip covers (2932) and (2934) cover the ocular plate (2920) so as to securely hold the device.

As described in FIGS. 46 and 47, the flip covers (2932) and (2934) are fully opened in a blooming state and then move to the separated state by the guidance of the flip covers (2932) and (2934) in which the ocular pate (2920) is in blooming state. In other cases, while the user moves the hidden ocular plate (2920) to the separated state, the flip covers (2932) and (2934) may be fanned out with the ocular plate (2920) in a blooming state

Seeing FIG. 46, the screen member (2930) includes the first flip cover (2932) in the horizontal direction and the second flip cover (2934) provided on the same surface as the first flip cover (2932) and the second flip cover (2934) can be opened in a blooming state as the first flip cover (2932) is opened.

In addition, a blocking film (2936) for blocking the gap between the first flip cover (2932) and the second flip cover (2934) in a blooming state may be further provided and support shaft (2938) may further be provided at the corner of the main body (2910) to support an elastic blocking film (2936). The support shaft (2938) may be designed so that the flip covers (2932) and (2934) are placed between their boundaries in a closed state.

The corner of the ocular plate (2920) can be bound to the support shaft (2938) to slide-move using a kind of rail structure and the ocular plate (2920) can be guided by the support shaft (2938) or can be moved to a separated state with the support shaft (2938).

The technical features described in the present embodiment can be applied to other embodiments. Those relevant to the field of technology can use the ordinary creative ability to modify them according to other embodiments.

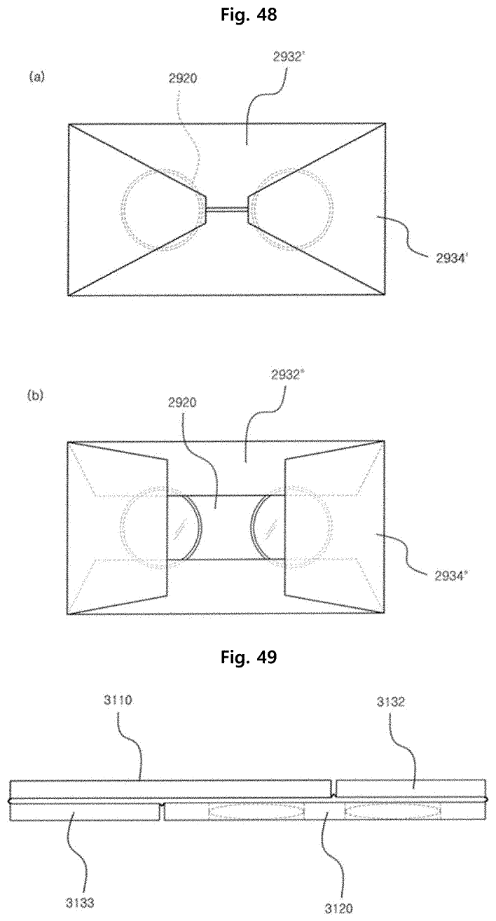

FIG. 48 is a rear view for describing a foldable virtual reality device according to an embodiment of the present invention.

Referring to FIG. 48 (a), the screen member includes the first flip cover (2932′) in the horizontal direction and the second flip cover (2934′) covering the first flip cover (2932′). Accordingly, the first flip cover (2932) can be opened and the second flip cover (2934′) on top can be switched to a blooming state while lifting up. The second flip cover (2934′) is lifted up first followed by lifting up the first flip cover (2932′).

In the present embodiment, the ocular plate (2920) can be moved to a separated state, i.e., rearward direction, while opening the first flip cover (2932′) first so that the second flip cover (2934′) may be opened simultaneously and switched to a blooming state.

Referring to FIG. 48 (b), the screen member may include the first flip cover (2932′) in the horizontal direction and the second flip cover (2934′) on top, which maintains the ocular plate (2920) in a closed and partially exposed state.

Accordingly, the first flip cover (2932′) and the second flip cover (2934′) can be switched into a blooming state while moving the partially exposed ocular plate (2920) in a separated state, i.e., in the rearward direction.

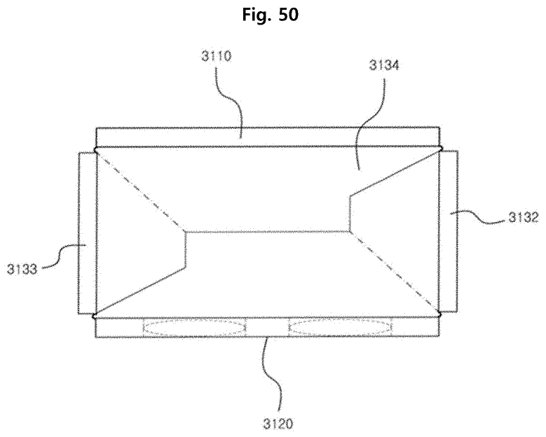

FIG. 49 is a plane view for describing a foldable virtual reality device according to an embodiment of the present invention and FIG. 50 is a plane view for describing an operating mechanism of the foldable virtual reality device of FIG. 49.

Referring to FIGS. 49 and 50, the foldable virtual reality device includes a main body (3110) including a virtual reality display, an ocular plate (3120) which is capable of maintaining a variable distance from the main body (3110) which comes in close contact and separated state maintaining a predetermined distance from the main body (3110) while moving, and a screen member including the first lateral body that connects the main body (3110) and the ocular plate (3120) as well as the second lateral body that connects the other side of the main body (3120) and the ocular plate (3120).

In an embodiment according to FIG. 49 and FIG. 50, the main body (3110) includes a cell phone and a casing that accommodates cell phone. The first lateral body (3132) and the second lateral body (3133) illustrated in FIG. 49 and FIG. 50 are connected to a casing included in the main body (2910).

In another embodiment, the main body (3110) may be a computing device that includes at least one processor and a display.

The main body (3110), the first lateral body (3132), the ocular plate (3120), and the second lateral body (3133) may be connected in order so as to form a closed folding structure. As illustrated in FIG. 49, the shape that the main body (3110), the first lateral body (3132), the ocular plate (3120), and the second lateral body (3133) are overlaid with each other with their inner surfaces being in mutually close contact can be maintained when the ocular plate (3120) is in a close contact state.

In the Figure, the main body (3110) and the first lateral body (3132) are formed on the same plane the ocular plate (3120) and the second lateral body (3133) are formed on the same plane. In some cases, however, the second lateral body (3133) and the main body (3110) may be switched to be located on the same plane.

The first lateral body (3132) or the second lateral body (3133) may form a lateral structure as a screen member, but may have various other functions. For example, the lateral body may be equipped with a speaker, auxiliary display or keyboard, etc., and the user may have the necessary lateral body facing the front if a speaker or auxiliary display or keyboard is required.

As illustrated in FIG. 50, the main body (3110), the first lateral body (3132), the ocular plate (3120), and the second lateral body (3133) form an approximately rectangular pillar and maintain the three-dimensional shape when the ocular plate (3120) is in a separated state. At this time, the ocular plate (3120) is posed so as to face the display (not shown) which is formed on the inner surface of the main body (3110) and a virtual reality function can be implemented through the virtual reality display of the main body (3110). Of course, another display or at least one camera may be further mounted on the front surface of the main body (3110).

Additionally, the screen member may further include a folding lid (3134) for blocking the plane and the bottom of the opened rectangular pillar in a separated state. The folding lid (3134) remains in a close contact state and become attached between the main body (3110) and the ocular plate (3120) in the folded state. Then, it opens up like the foldable box in a separated state and simultaneously blocks the opened side that it faces.

The technical features described in the present embodiment can be applied to other embodiments. Those relevant to the field of technology can use the ordinary creative ability to modify them according to other embodiments.

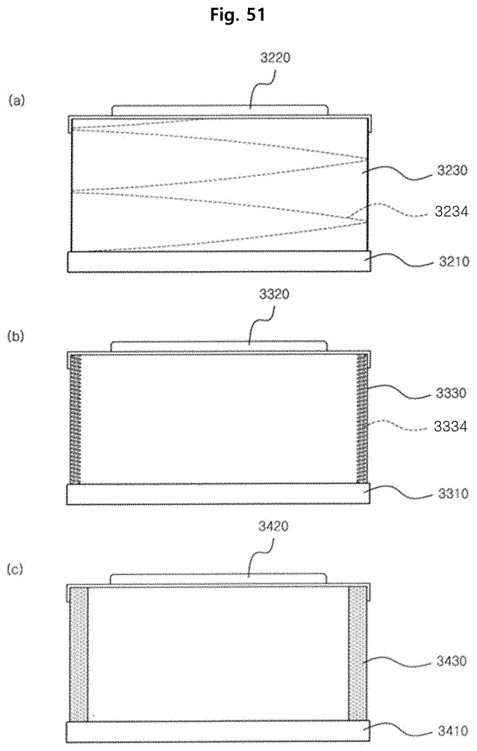

FIG. 51 is a lateral view for describing a foldable virtual reality device according to an embodiment of the present invention.

Referring to FIG. 51(a), the foldable virtual reality device includes a main body (3210) including a display (not illustrated), an ocular plate (3220) which is capable of maintaining a variable distance from the main body (3210) which comes in close contact and separated state maintaining a predetermined distance from the main body (3210) while moving, and a screen member (3230) including a light blocking film (3232) that blocks the gap between the main body (3210) and the ocular plate (3220) and a spring support structure (3234) that elastically supports a light blocking film (3232). When the ocular plate (3220) is in a separated state, the virtual reality function may be implemented through the display of the main body (3210).

In an embodiment according to FIG. 51(a), the main body (3210) includes a cell phone and a casing that accommodates cell phone. The screen member (3230) illustrated in FIG. 51 (a) is connected to the casing included in the main body (3210).

In another embodiment, the main body (3210) may be a computing device that includes at least one processor and a display.

The light blocking film (3232) may be formed using a cloth, span, silicon thin film, or the like that are capable of blocking light and may be provided in the form of a hollow pillar or a truncated cone. In the present embodiment, the spring support structure (3234) may be formed to correspond to the entire sectional shape of the light blocking film and may be formed to support the inner or outer surface of the light blocking film (3232) as a whole. It may be sewn along the inner surface of the light blocking film (3232) and compressed together with the light blocking film (3232). Then the ocular plate (3220) is released from the main body (3210) so that it can be projected in a pillar shape.

In the present embodiment, the light blocking film (3232) is formed as a single body, but in some cases may be provided separately from the left and right as a binocular shape. The technical features described in the present embodiment can be applied to other embodiments and those relevant to the field of technology can use the ordinary creative ability to modify them according to other embodiments.

Referring to FIG. 51(b), the foldable virtual reality device includes a main body (3310) including a display (not illustrated), an ocular plate (3320) which is capable of maintaining a variable distance from the main body (3310) which comes in close contact and separated state maintaining a predetermined distance from the main body (3310) while moving, and a screen member (3330) including a light blocking film (3332) that blocks the gap between the main body (3310) and the ocular plate (3320) and a spring support structure (3334) that elastically supports a light blocking film (3332). When the ocular plate (3320) is in a separated state, the virtual reality function may be implemented through the display of the main body (3310).

In an embodiment according to FIG. 51(b), the main body (3310) includes a cell phone and a casing that accommodates cell phone. The screen member (3330) illustrated in FIG. 51 (b) is connected to the casing included in the main body (3310).

In another embodiment, the main body (3310) may be a computing device that includes at least one processor and a display.

The light blocking film (3332) may be formed using a cloth, span, silicon thin film, or the like that are capable of blocking light and may be provided in the form of a hollow pillar or a truncated cone. In the present embodiment, the spring support structure (3334) includes plural springs that are provided in a long pillar shape inside the light blocking film and the plural springs may be formed to support the ocular plate (3320) at four corners. The spring support structure (3334) is compressed together with the light blocking film (3332) then the ocular plate (3320) is released from the main body (3310) so that it can be projected in a pillar shape.

As a spacing device or a distance control unit, various actuators can be used such as a hydraulic cylinder, a pneumatic cylinder, an antenna rack, a solenoid, a coil spring, a shape memory alloy, or the like, and spacing device or a distance control unit can be mounted on the outside or inside of the screen member (3330).

In the present embodiment, the light blocking film (3332) is formed as a single body, but in some cases may be provided separately from the left and right as a binocular shape. The technical features described in the present embodiment can be applied to other embodiments and those relevant to the field of technology can use the ordinary creative ability to modify them according to other embodiments.

Referring to FIG. 51(c), the foldable virtual reality device includes a main body (3410) including a display, an ocular plate (3420) which is capable of maintaining a variable distance from the main body (3410) which comes in close contact and separated state maintaining a predetermined distance from the main body (3410) while moving, and a screen member (3430) of foamable material interposed between a main body (3410) and an ocular plate (3420). When the ocular plate (3420) is in a separated state, the virtual reality function may be implemented through the display of the main body (3410).

In an embodiment according to FIG. 51(c), the main body (3410) includes a cell phone and a casing that accommodates cell phone. The screen member (3430) illustrated in FIG. 51 (c) is connected to the casing included in the main body (3410).

In another embodiment, the main body (3410) may be a computing device that includes at least one processor and a display.

The screen member (3430) may be formed using various foamable materials such as a sponge or a memory foam and may be compressed between the ocular plate (3420) and the main body (3410) when the ocular plate (3420) is in close contact state. The compressed screen member (3430) can be restored to its original shape and inner space is returned to the hollow shape when the ocular plate (3420) is separated from the main body (3410) and moves.

As the screen member (3430) is formed of a foamable material, the lightened screen member (3430) can be used. Even when the vent is not formed, the moisture can be prevented from being frosted or the internal temperature can be prevented from being increased while effectively blocking light.

In the present embodiment, the light blocking film (3332) is formed as a single body, but in some cases may be provided separately from the left and right as a binocular shape. The technical features described in the present embodiment can be applied to other embodiments and those relevant to the field of technology can use the ordinary creative ability to modify them according to other embodiments.

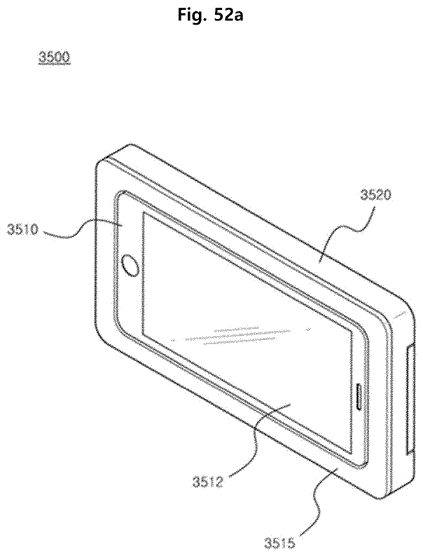

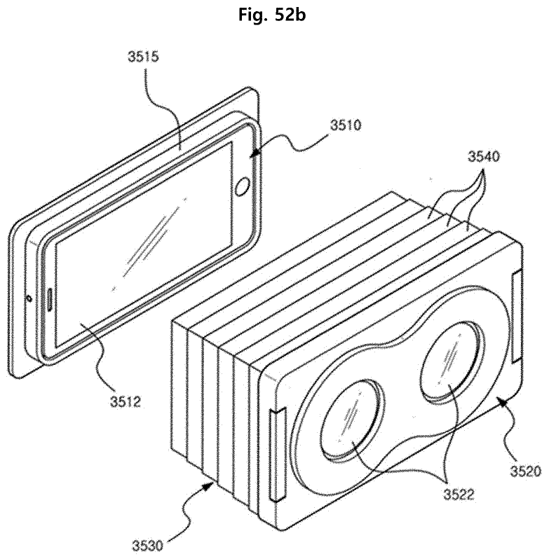

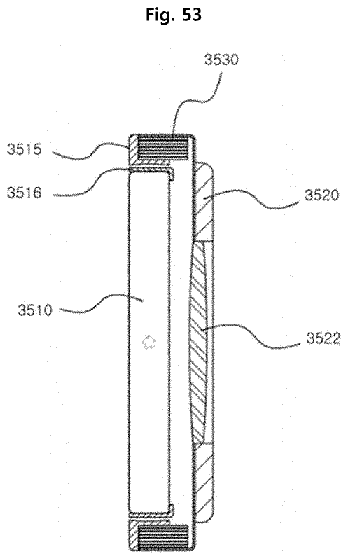

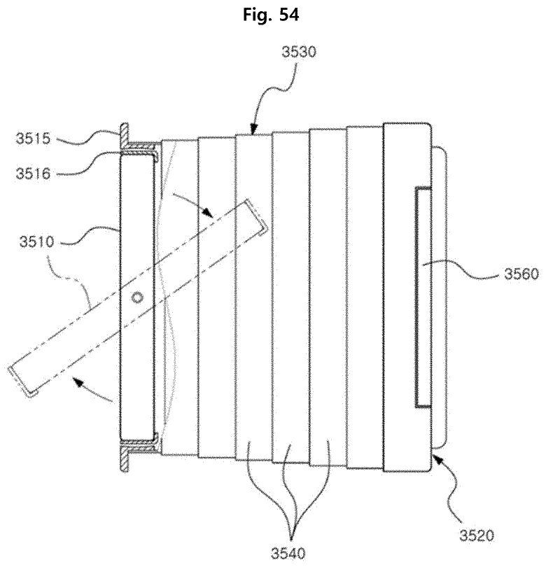

FIG. 52 (a) is a perspective view for describing a foldable virtual reality device according to an embodiment of the present invention, FIG. 52 (b) is an exploded perspective view which is illustrated in the rear describing the foldable virtual reality device, FIG. 53 is a sectional view of the foldable virtual reality device of FIG. 52 and the cell phone in a close contact state, and FIG. 54 is a sectional view for describing a separated state of the foldable virtual reality device of FIG. 52.

Referring to FIGS. 52 to 54, according to this embodiment, the foldable virtual reality device (3500) includes a cell phone body (3510), a main frame (3515), an inner frame (3516), an ocular plate (3520) and a screen member (3530).

The cell phone body (3510) includes a display (3512) disposed on the front surface, and may perform the making of a basic call, the running of an application, etc., through the manipulation of the display (3512) or another button, or the like.

The cell phone body (3510) is mounted inside the inner frame (3516), and the main frame (3515) accommodates the inner frame (3516) in an invertible manner.

Unlike the previous embodiment, the cell phone body (3510) can implement the virtual reality function using the display (3512) disposed on the front surface, without the virtual reality display on the rear surface. For this purpose, the inner frame (3516) accommodating the cell phone body (3510) may be mounted inside to the main frame (3515) in an invertible manner.

The inner frame (3516) accommodating the cell phone body (3510) may be mounted inside the main frame (3515), rotatable in 180 or 360 degrees, and the display (3512) may be fastened in the state of being oriented forward or rearward in response to the rotation of the inner frame (3516) accommodating the cell phone body (3510)

According to the embodiment, the inner frame (3516) may be fastened maintaining an angle of certain degrees. Therefore, the cell phone body (3510) is also fastened maintaining an angle of certain degrees in response to the inner frame angle. In effect, the cell phone body (3510) is fastened in an angle easy to be viewed using the display (3512) included in the cell phone body (3510).

A direction of the display (3512) may be detected through the rotated state of the cell phone body (3510) or the inner frame (3516) accommodating the cell phone body (3510). Also, the virtual reality function may be performed by user's manipulation, by detecting the rotated state of the cell phone body (3510) or the inner frame (3516) accommodating the cell phone body (3510), or by detecting the movement of the ocular plate (3520).

The ocular plate (3520) includes a pair of ocular lenses, and a user can view an image, displayed on the display (3512) which is reversed, via the ocular lenses (3522). The screen member (3530) is equipped on the rear surface of the main frame (3515), and may include a plurality of screen boxes (3540) configured to slide and be fixed while being laid over each other. The screen box (3540) may be formed in square Figure corresponding to the cell phone body, and also in oval or 8-Figure that corresponds to the eye shape.

In the screen member (3530), as the screen box (3540) slides with friction as a metal antenna does, it could be fixed at the random point, or maintain changeable distance. Also, as the screen box (3540) is able to screen the four sides from outside, it could effectively screen the light from outside.

The technical features explained in this embodiment may be applied to other embodiments, and a user may creatively adjust according to different embodiments. For example, whereas a plurality of the screen boxes (3540) form the screen member (3530) in this embodiment, in other cases, using the structure in which the main body (3510) rotates within the main frame (3515), bellows form (FIG. 12), slide interposition form (FIG. 18), fixed button form (FIG. 23), air tube form (FIG. 29), foldable screen form (FIG. 33), roll screen form (FIG. 36), foldable flip cover form (FIG. 47), elastic screen form (FIG. 51) may also accommodate the structure in which the main body reverses or rotates within the frame.

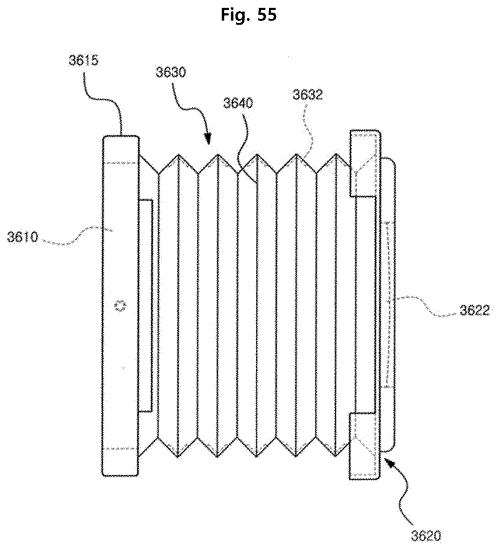

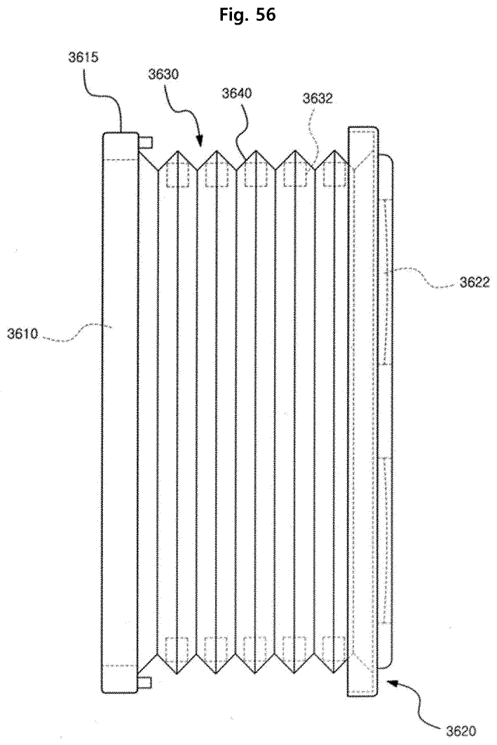

FIG. 55 is the side view of the foldable virtual reality device according to the first embodiment of this invention, and FIG. 56 is the ground plan of the foldable virtual reality device of FIG. 55.

Referring to FIGS. 55 and 56, the foldable virtual reality device according to this embodiment includes the cell phone body (3610) and a casing (3615) that accommodates the cell phone body (3610), an ocular plate (3620) and a screen member (3630). The screen member (3630) connects to the casing (3615)

The cell phone body (3610) includes a virtual reality display disposed on the rear surface. A camera module may be disposed on the front surface of the cell phone body (3610) for an augmented reality, etc., and supplementary displays may be additionally equipped for interlocking with the virtual reality display or operating the device for different purpose. The different purpose may include running applications for a phone call, internet, e-mail or message, map or navigation, or gaming.

The ocular plate (3620) includes a pair of ocular lenses (3622), and a user can view an image, displayed on the virtual reality display (3622) via the ocular lenses (3622)

Unlike the foldable virtual reality device illustrated in FIG. 10, the screen member (3630) according to this embodiment does not include a distance adjustment member, and may include a light blocking screen (3640) which can support by itself in an extended state.

The light blocking screen (3640) may be formed with materials that could be sustained by its own strength without any distance adjustment member, but in order to surely prevent any weight lag, the light blocking screen (3640) may additionally include supportive member (3632). The supportive member (3632) may be provided inside, outside, or within the screen, and, linked with the screen (3640), may support the extended form of the supportive member (3630).

In this embodiment, the light blocking screen (3640) is provided in bellows form, and the plastically deformable supportive member (3632) with a hinge function may be provided at the 4 points of the light blocking screen (3640) in bellows form. The supportive member (3632) may be deformed by exterior force, but in an extended state without the exterior force, it could sufficiently support the light blocking screen (3640) and the main body.

The plastically deformable supportive member (3632) is formed at the 4 points on the light blocking screen (3640), but there could be more or less, and the light blocking screen (3640) in bellows form may control its length by increasing or decreasing the depth of its peaks and valleys. For example, the supportive member (3632) could be formed with thickness less than 0.1 mm, thereby able to be installed within the light blocking screen (3640).

As explained above, the light blocking screen may be formed to sufficiently sustained by itself without distance adjustment member, without the supportive member. In this case, in order to prevent the separation of the ocular plate (3620) in a compressed state, the main body and the ocular plate (3620) may maintain the compact state without any separation using the fastener as a fixing button interposed between the main body and the ocular plate (3620).

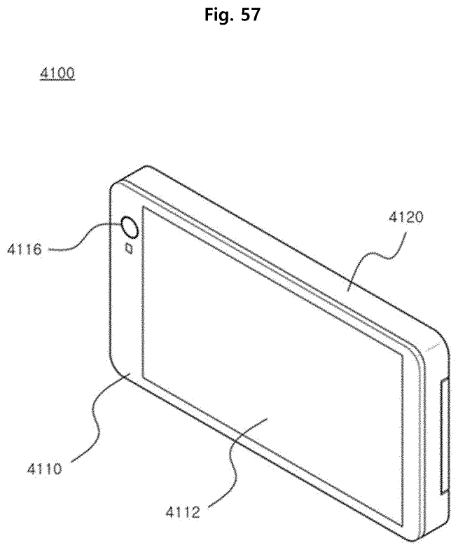

The following explains the second embodiment of the foldable virtual reality device referring to FIGS. 57 to 65.

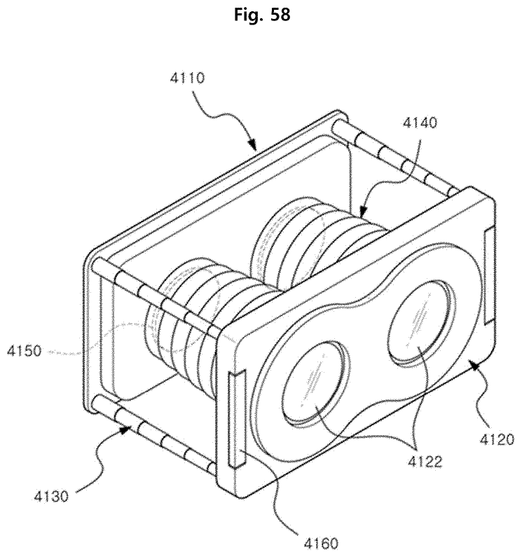

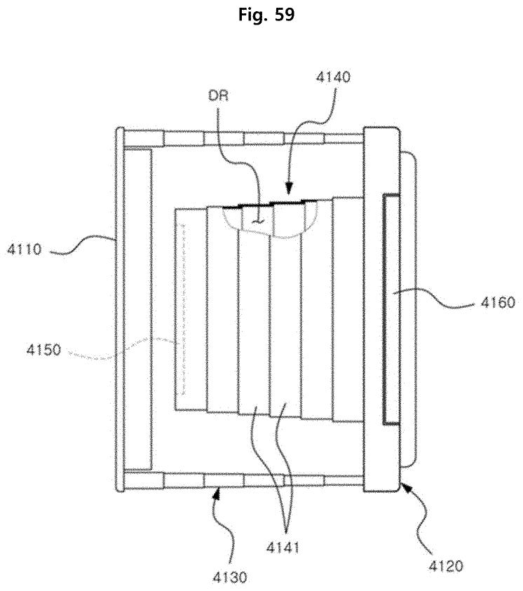

FIG. 57 is the perspective view on the first embodiment of the foldable virtual reality device. FIG. 58 is the perspective view to explain the extended state of the foldable virtual reality device in FIG. 57. FIG. 59 is the side view to explain the extended state of the foldable virtual reality device in FIG. 57.

Referring to FIGS. 57 to 59, according to this embodiment, the foldable virtual reality device (4100) includes a main body (4110), an ocular plate (4120), a distance adjustment member (4130), a screen member (4140) and a virtual reality display (4150). The main body (4110) includes the display (4112) disposed on the front surface, and may perform the making of a basic call, the running of an application, etc., through the manipulation of the display (4112) or another button, or the like.

Referring to the first embodiment in FIGS. 57 to 59, the main body (4110) includes a cell phone body and a casing that accommodates the cell phone body. The distance adjustment member (4130) illustrated in FIGS. 57 to 59 connects to the casing included in the main body (4110)

In other embodiments, the main body (4110) may be a computing device including at least one processor and display.

Also, the foldable virtual reality device (4100) may include a cell phone function by adding voice communicating module, but it may connect outside to another wire(less) network without any voice communicating module. It may also include other applications and functions like messaging, gaming, video, music streaming, map or finance.

Also, the display (4112) of the main body (4110) may conduct a separate function while in a state of implementing a virtual reality function. For example, it can implement a same or related content of a virtual reality display (4150) which a user is using. In this case, the user equipped with the virtual reality device may exchange information or emotion with other users or nearby people through the display (4112)

Also, a camera module (4116) may be fastened to the front surface of the main body (4110). The camera module (4116) may be used for a purpose of recording an outside image, or for implementing functions like augmented reality (AR) or mixed reality (MR). One or more camera modules (4116) may be provided, and its directions may also be provided in plurality to simultaneously record not only forward but also on side, upper side, underside, and rearward. It may also be provided in a form of a fisheye lens for 180 or 360-degree angle recording, and it may be fastened on the ocular plate (4120), not on the main body (4110)

The ocular plate (4120) includes a pair of ocular lenses (4122), and a user can view an image, displayed on the virtual reality display (4150) via ocular lenses (4122). The ocular lenses (4122) may adjust their focal point by minute rotation control, and adjust their interval to correspond to an interval between eyes. Also, the ocular plate (4120) may possess a function to separate, maintain and change the distance from the virtual reality display (4150) for a certain degree. Besides, there may be a facial cushion or additional light blocking structure added to the ocular lenses (4122)

The distance adjustment member (4130) is structured to extend lengthwise like an antenna, and the main body (4110) and the ocular plate (4120) may be connected in 4 points. The ocular plate (4120) along with the screen member (4140) and the virtual reality display (4150) may be distanced from the main body (4110) using the distance adjustment member (4130).

Though this embodiment uses the extendable antenna structure as the distance adjustment member, other options like air tube, spring, foldable link may also be used for distance adjustment. As illustrated, the distance adjustment member may be manually controlled, and it may also be automatically controlled using oil cylinder, air cylinder, electrical motor, shape memory metal.

The screen member (4140) is disposed on the front surface of the ocular plate (4120), and may include a plurality of screen boxes (3540) configured to slide and be fixed while being laid over each other. The right and left part of the screen member (4140) is provided separately, corresponding to each ocular lens (4122). It is formed in a shape of a binocular, thereby provided of dark room (DR) and the virtual reality display (4150) separately on right and left.

The screen box (4141) structured in a binocular form generally has a round cross section, but it may also has diverse shapes of cross sections like oval or polygon.

In the screen member (4140), as the screen box (4141) slides with friction as a metal antenna does, it could be fixed at the random point, or maintain changeable distance. Also, the screen box (4141) configures a dark room inside the screen member (4140), thereby effectively blocking the lights from outside.

The technical features explained in this embodiment may be applied to other embodiments, and a user may creatively adjust according to different embodiments.

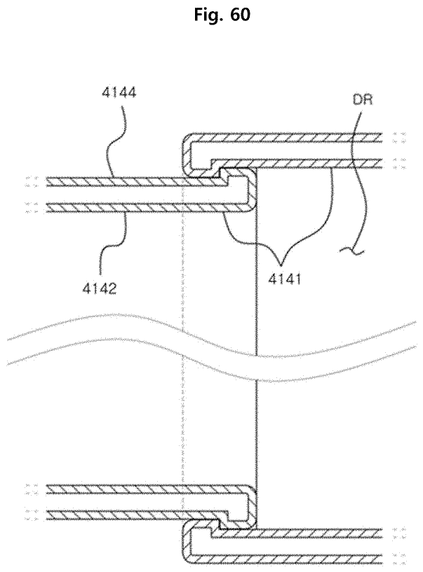

FIG. 60 is a cross section diagram to explain the screen member included in the virtual reality device of the first embodiment of this invention.

Referring to FIG. 60, the screen box (4141) that constitutes the screen member (4140) may be formed in a double wall structure. The screen box (4141) that constitutes the double wall includes the inner wall (4142) and the outer wall (4144), and it may maintain a certain distance in the whole or the partial area from the inner wall (4142) and the outer wall (4144). As the screen box (4141) forms the double wall structure, it is drastically light weighted and structurally solid compared to a single wall structure with a same thickness.

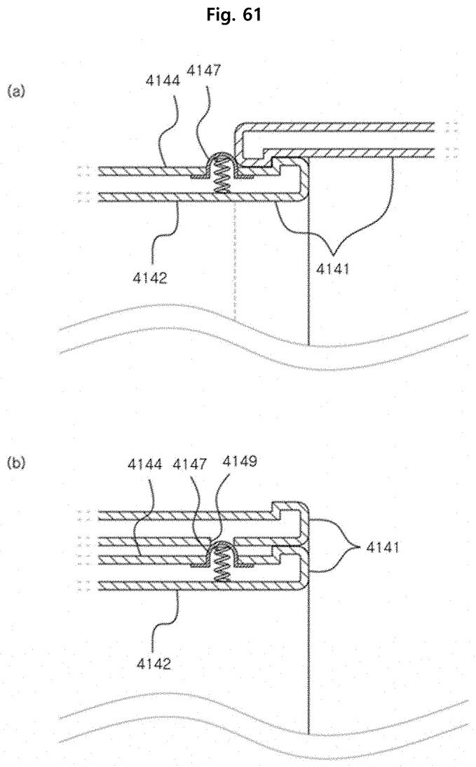

FIG. 61 is a partially magnified cross section diagram to explain the screen member included in the virtual reality device of the first embodiment of this invention.

Referring to FIG. 61, the screen box (4141) may further include an elastic protrusion (4147) protruding from the inner wall of the screen box in order to maintain a retracted state or extended state. In the extended state in which the screen box has been extended, the elastic protrusion (4147) supports an end of another screen box (4141), thereby fastening them in order to prevent the screen boxes (4141) from being laid over each other under certain degree of force.

Furthermore, in the retracted state in which the screen boxes (4141) have been laid over each other, the elastic protrusion (4147) is stuck in a protrusion reception hole (4149) formed in another screen box (4141), thereby fastening them in order to prevent the screen boxes (4141) from being laid over each other under certain degree of force.

Although the elastic protrusion (4147) protrudes from the inner wall (4142) of the screen box (4141) in the present embodiment, it may be formed in a structure in which it protrudes from the outer wall or both from the inner wall and from the outer wall. The elastic protrusion (4147) may be designed to be spaced apart from each other in a direction perpendicular to extension and retraction directions so as not to interfere with mutual operation. Furthermore, the elastic protrusions (4147) may be elastically supported by their own elasticity, as in the case of leaf springs, rather than being supported by springs.

The technical features explained in this embodiment may be applied to other embodiments, and a user may creatively adjust according to different embodiments.

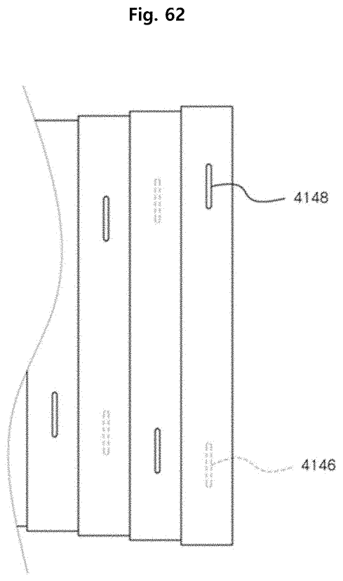

FIG. 62 is a partially magnified cross section diagram to explain the screen member included in the virtual reality device of the first embodiment of this invention.

Referring to FIG. 62, as explained in FIG. 60, the screen box (4141) of the screen member (4140) may be constituted in a double wall structure. This double wall structure may derive effects other than lightening its weight. For example, when making a ventilation hole in the screen member (4140), the light from outside may be blocked by designing the ventilation hole #1 and #2 not to overlap each other.

Specifically, in the double wall structured screen box (4141), while the ventilation hole #1 (4146) is made on the inner wall (4142) and the ventilation hole #2 (4148) on the outer wall (4144), as illustrated, the ventilation hole #1 (4146) and #1 (4148) may not be overlapped, which means not aligned, thereby blocking the lights from outside.

Though the present embodiment illustrates the ventilation hole made on the screen box (4141), the hole may be made also or only on the ocular plate (4120) in different cases.

The screen member (4240) is interposed between the main body (4110) and the ocular plate (4120), and it can be extended forward, which means towards the main body (4110), when the ocular plate (4120) is in an extended state.

In the present embodiment, the size of the screen box (4141) decreases gradually. The size may increase and then decrease in a front-back direction. Conversely, the size of the screen box may increase gradually. Alternatively, the size of the screen box may increase and then decrease. The opposite case is also possible.

Also, it is appropriate to block the light from outside in all 4 sides entering into the screen box (4141) for user's immersion. However, the interval between the main body (4110) and the ocular plate (4120) may be partially screened unless it does not seriously compromise the immersion.

The technical features explained in this embodiment may be applied to other embodiments, and a user may creatively adjust according to different embodiments.

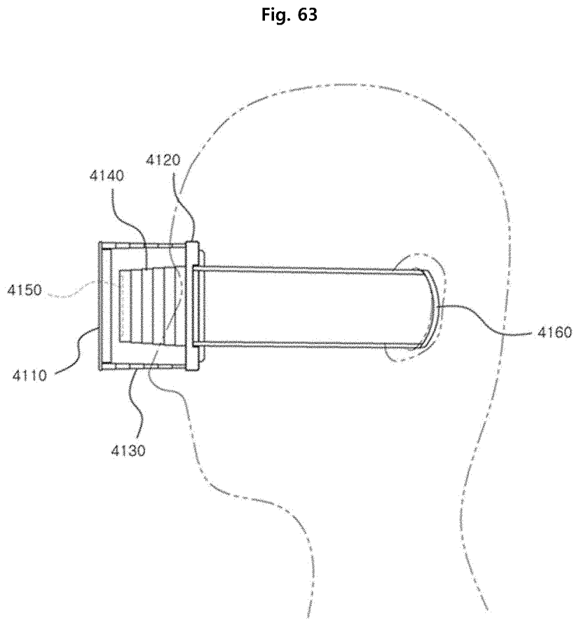

FIG. 63 is a side view diagram to explain the using state of the foldable virtual reality device of the first embodiment of this invention.

Referring to FIG. 63, the foldable virtual reality device includes a main body (4110), an ocular plate (4120), a distance adjustment member (4130), a screen member (4140), and a virtual reality display (4150). In order to implement a virtual reality function in a more realistic fashion, fastening member (4160) configured to fasten the virtual reality device in its extended state to the face of a user may be further included.

Referring to the embodiment of FIG. 63, the main body (4110) includes a cell phone body and a casing accommodating the cell phone body. The distance adjustment member (4130) connects to the casing included in the main body (4110)

In other embodiments, the main body (4110) may be a computing device including at least one processor and displays.

The fastening member (4160) may be provided in the form of the ear loops of a common mask. It may be normally prepared on both sides of the ocular plate (4120), and may be spread backward and fitted around the ears of a user for the convenience of the user. Alternatively, it will be apparent that the fastening member may be formed on the main body (4110).

The fastening member may be provided in the form of the temples of glasses, or may be provided in the form of an elastic band that is fastened to the head of a user.

The technical features explained in this embodiment may be applied to other embodiments, and a user may creatively adjust according to different embodiments.

FIG. 64 is a rear perspective view diagram to explain the foldable virtual reality device of the first embodiment of this invention.

Referring to FIG. 64, the foldable virtual reality device (4200) in the present embodiment includes a main body (4210), an ocular plate (4220), a distance adjustment member (4230), a screen member (4240), and a virtual reality display (4250). The main body (4210) includes the display (4212) disposed on the front surface. The ocular plate (4220) includes a pair of ocular lenses (4222). A user can view an image, displayed on the virtual reality display (4250) via the ocular lenses (4222).

Referring to the embodiment of FIG. 64, the main body (4210) includes a cell phone body and a casing accommodating the cell phone body. The distance adjustment member (4230) connects to the casing included in the main body (4210).

In other embodiments, the main body (4210) may be a computing device including at least one processor and displays.

However, a single screen member (4240) is equipped on the front surface of the ocular plate (4220), and itself includes an oval cross section, forming one dark room (DR) inside. The screen member (4240) may include a plurality of screen boxes (4241) configured to slide and be fixed while being laid over each other. As the screen box (4241) slides with friction as a metal antenna does, it could be fixed at the random point, or maintain changeable distance. Also, the screen box (4241) may be a double wall structure as was in the previous embodiment.

The distance adjustment member (4230) includes the link #1 (4232) and #2 (4234) that rotatably connects to the center. The link #1 (4232) rotatably connects to the main body (4210), and the link #2 (4220) rotatably connects to the ocular plate (4220)

The four combinations including the link #1 (4232) and #2 (4234) connects the ocular plate (4220) at the 4 edges of the main body (4210). The link #1 (4232) and #2 (4234) linearly spread or fold in V shape, thereby switching the ocular plate (4220) to an extended or retracted state.

The technical features explained in this embodiment may be applied to other embodiments, and a user may creatively adjust according to different embodiments.

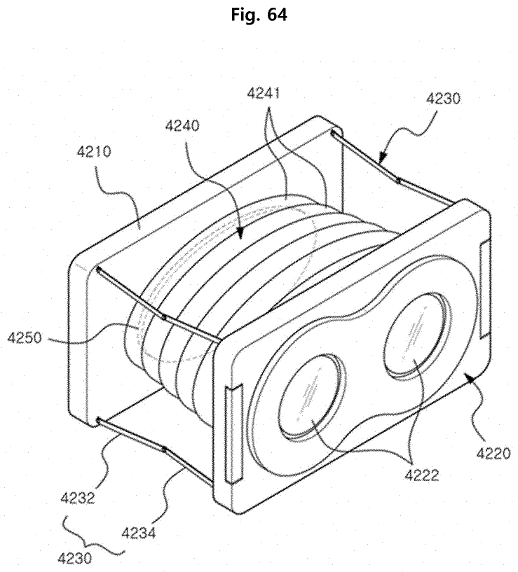

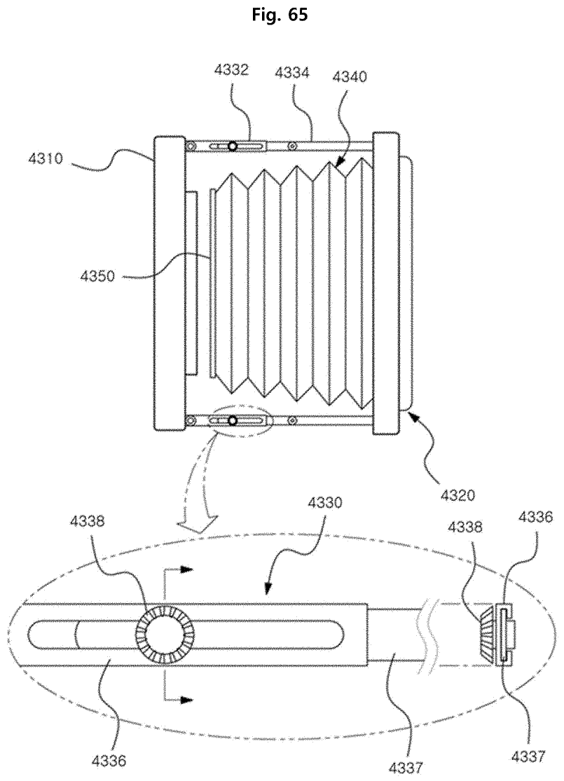

FIG. 65 is a side view diagram to explain the foldable virtual reality device of the first embodiment of this invention.

Referring to FIG. 65, according to the present embodiment, the foldable virtual reality device (4300) includes a main body (4310), an ocular plate (4320), a distance adjustment member (4330), a screen member (4340), and a virtual reality display (4350). The ocular plate (4320) includes a pair of ocular lenses (4322), and a user can view an image, displayed on the virtual reality display (4350) at the end of the dark room (DR) of the screen member (4340) via ocular lenses (4322). The main body (4310) of the present embodiment may include the display, but it may be skipped in different cases.

According to the embodiment of FIG. 65, the main body (4310) includes a cell phone body and the casing accommodating the cell phone body. The distance adjustment member (4330) illustrated in FIG. 65 connects to the casing included in the main body (4310)

In other embodiments, the main body (4310) may be a computing device including at least one processor and display.

Also, a single screen member (4340) is disposed on the front surface of the ocular plate (4320) in a form of a light blocking screen, and the light blocking screen may be formed in a bellows form. The light blocking screen in bellows form may maintain the interval between the virtual reality display (4350) and the ocular plate (4320) by changing itself. In different cases, the screen member (4340) equipped with the virtual reality display (4350) may be attached at the rear surface of the main body (4310). In this case, magnet or physically fixing button may be used. In such structure, the light blocking screen may be formed with an elastic material rather than bellows. Special supportive structure or performance actuator may also be additionally included.

it is appropriate to block the light from outside in all 4 sides entering into the screen member (4340) for user's immersion. However, the dark room (DR) may be partially exposed unless it does not seriously compromises the immersion.

The distance adjustment member (4330) includes the link #1 (4332) and #2 (4334) that connects to one side in a mutually rotatable manner. The 4 combinations including the link #1 (4332) and #2 (4334) may connect the ocular plate (4320) on the 4 edges of the main body (4310). Like the previous embodiment, the link #1 (4332) and #2 (4334) linearly spread or fold in V shape, thereby switching the ocular plate (4320) to an extended or retracted state.

However, as illustrated in FIG. 65, the link #1 (4332) may be provided in a manner capable of adjusting and fixing its length. For this purpose, the link #1 (4332) includes two or more rods (4336, 4337) which can adjust the mutually overlapping length, and at least on one of those rods (4336, 4337) forms a long reception lengthwise. The long reception is equipped with a minutely controllable screw (4338) which can adjust and fix the overlapped length of the rods (4336, 4337).

Otherwise, several raised spots may be formed on the long reception, thereby making capable of adjusting the overlapped length of the rods by moving the raised spots.

By adjusting the overlapped length as explained, minute distance adjustments in needs may be possible. Also, by respectively adjusting the four link combinations, the angle of the ocular plate and the twist of the display may be adjusted.

The technical features explained in this embodiment may be applied to other embodiments, and a user may creatively adjust according to different embodiments.

For reference, though the present statement explains the screen member using a plurality of the screen boxes or bellows form screen, the screen member may be formed using air tube, foldable screen, roll screen, dark screen supported by springs, memory form, etc. as specified in previously applied KIPRIS 10-201600121606, and the ocular plate may have a nose reception.

For example, the screen member may be provided by using pieces connected by folding brackets, and the pieces may connect each other enabling the ocular plate to convert to an extended state or a retracted state. When the ocular plate is in an extended state, the screen member may protrude and implement the virtual reality display function at its end part.

At this part, the screen member may be formed using compound materials of synthetic resin panels, metal sheets, rubber, or using paper. The screen member may flatly retracted as folding box does, and may be extended from the ocular plate in an extended state.

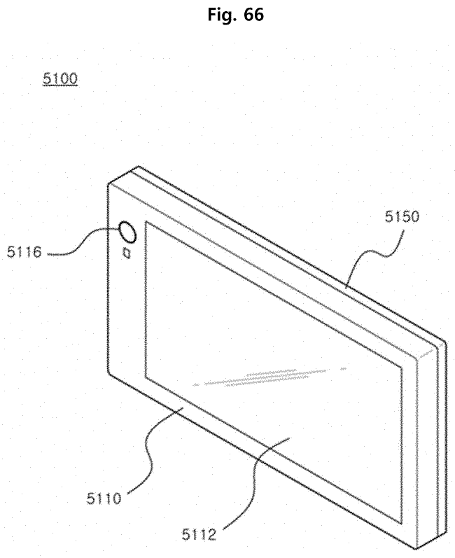

Referring to FIGS. 66 to 74, the following explains the third embodiment of the foldable virtual reality device. Due to the structural feature of the device in the third embodiment, it is designated as ‘hinge virtual reality device’, which is synonymous to ‘foldable virtual reality device’.

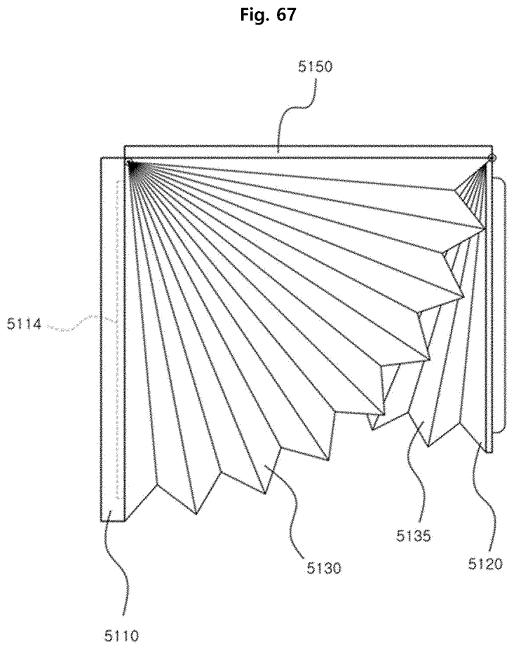

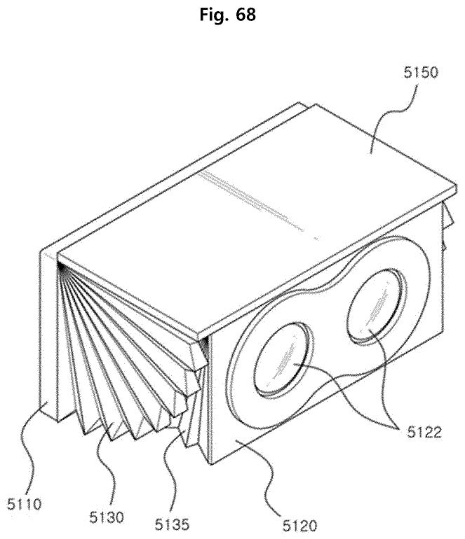

FIG. 66 is a front perspective view to explain the storage mode of the hinge virtual reality device according to the first embodiment. FIG. 67 is a side view to explain the display mode of the hinge virtual reality device in FIG. 66. FIG. 68 is a rear perspective view to explain the display mode of the hinge virtual reality device in FIG. 66.

Referring to FIGS. 66 to 68, according to this embodiment, the hinge virtual reality device (5100) includes a main body (5110), an ocular plate (5120) and a rear cover (5150).

Referring to the first embodiment following FIGS. 66 to 68, the main body (5110) includes a cell phone body and a casing accommodating the cell phone body. The rear cover (5150) illustrated in FIG. 63 connects to the casing included in the main boy (5110) In other embodiments, the main body (5110) may be a computing device including at least one processor and display.

The main body (5110) includes the main display (5112) disposed on the front surface and the virtual reality display (5114) disposed on the rear surface. The ocular plate (5120) includes ocular lenses (5122) for virtual reality function.

The main body (5110) and the ocular plate (5120) are mutually connected by the rear cover (5150). For example, one end of the rear cover (5150) rotatably connects one edge of the rear surface of the main body (5110), and the rear cover (5150) may be laid over the rear surface of the main body (5110) or be spread perpendicularly. Also, the ocular plate (5120) may rotatably connect to the end of the rear cover (5150). The ocular plate (5120) is laid over the rear cover (5150) in a storage mode, and when the rear cover (5150) is in an unfolded state, the ocular plate (5120) may unfold downwards parallel to the rear surface of the main body (5110) or the virtual reality display (5114).

In this statement, the storage mode refers to the state in which the rear cover (5150) and the ocular plate (5120) is laid over on the rear surface of the main body (5110). The display mode refers to the state in which the rear cover (5150) and the ocular plate (5120) unfolds from the rear surface of the main body (5110), forming three-dimensional structure.

As illustrated in FIG. 67, the rear cover (5150) perpendicularly unfolds from the rear surface of the main body (5110), and the ocular plate (5120) hinged on the inner surface of the rear cover (5150) may further unfold downwards under the horizontally unfolded rear cover (5150)

Also, in order to form a dark room (DR) between the main body (5110) and the ocular plate (5120) in display mode, arch screen (5130) in bellows form may be interposed between the rear cover (5150) and the main body (5110). Furthermore, after the arch screen (5130) unfolds, an assistant screen (5135) may be provided between the ocular plate (5120) and the rear cover (5150), thereby forming an extended dark room (DR). The arch screen may be formed using elastic material or others, besides bellows.

In the present embodiment, the main body (5110) includes the main display (5112), but it may include only the virtual reality display (5114) without the main display. When the main body (5110) is formed in an invertible manner, only a single virtual reality display (5114) may provide diverse display functions and utilities.

For example, this hinge virtual reality device includes at least one display, and it may provide functions of conventional cell phones or devices by running diverse applications using that display. Which means, in such storage mode, it may be used as a standard cell phone or multimedia device. Meanwhile, a user may convert it to a display mode which can implement virtual reality by unfolding the rear cover and the ocular plate.

For example, the main display (5112) of the main body (5110) may perform separate function while in a state of implementing virtual reality function. For instance, it can implement a same or related content of a virtual reality display (5114) which a user is using. In this case, the user equipped with the virtual reality device may exchange information or emotion with other users or nearby people through the display (5112).

As illustrated in FIG. 66, a camera module (5116) may be fastened to the main body (5110). The camera module (5116) may be used for a purpose of recording an outside image, or for implementing functions like augmented reality (AR) or mixed reality (MR). One or more camera modules (5116) may be provided, and its directions may also be provided in plurality to simultaneously record not only forward but also on side, upper side, underside, and rearward. It may also be provided in a form of a fisheye lens for 180 or 360 degree angle recording. The adaptations of the camera module (5116) and augmented reality, etc. may be likely applied to other embodiments in this statement.

A user can view an image, displayed on the virtual reality display (5114) via ocular lenses (5122). The ocular lenses (5122) may adjust their focal point by minute rotation control, and adjust their interval to correspond to an interval between eyes. Besides, there may be a facial cushion or additional light blocking structure added to the ocular lenses (5122). For example, an air cushion capable of inflating and deflating may be added as a light blocking structure.

The main body (5110), the rear cover (5150), and the ocular plate (5120) form the upper structure in a ‘⊏’ shape, and the arch screen (5130) covers the bottom surface, thereby making a dark room (DR) inside. Facing the ocular lenses (5122) formed on the rear surface of the main body (5110), a user may utilize virtual reality functions using the virtual reality display (5114) via the ocular lenses (5122).

The technical features explained in this embodiment may be applied to other embodiments, and a user may creatively adjust according to different embodiments.

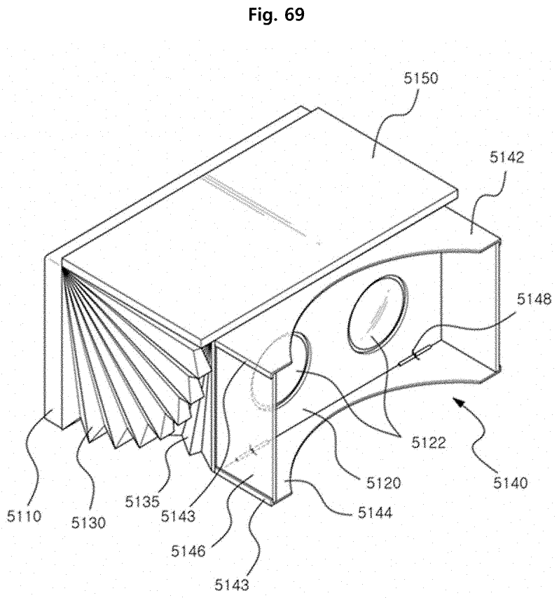

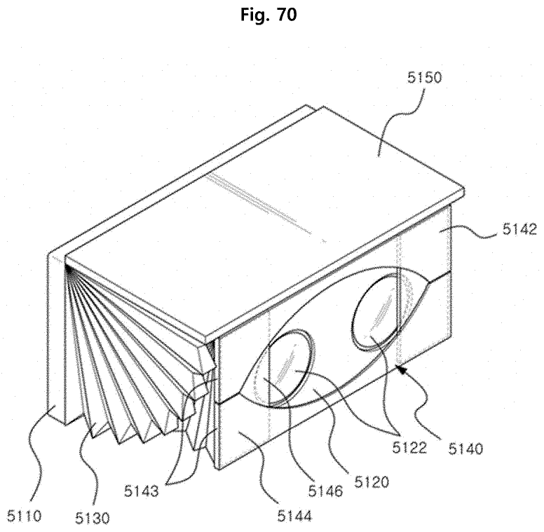

FIG. 69 is a rear perspective view to explain the hinge eye cover in the hinge virtual reality device according to the first embodiment of this invention. FIG. 70 is a rear perspective view to explain the hinged state the hinge eye cover of FIG. 69.

Referring to FIGS. 69 and 70, the hinge virtual reality device may include a main body, an ocular plate (5120), and a rear cover. Additionally, in order to block the light from outside from a user's eyes, the hinge eye cover may be added to the ocular plate (5120). The hinge eye cover (5140) in its unfolded state blocks the light that intrudes around the eyes. It may be provided in diverse forms maintaining its slim state when folded.

In the embodiment of FIGS. 69 and 70, the main body (5110) includes a cell phone body and a casing accommodating the cell phone body. The rear cover illustrated in FIGS. 69 and 70 connects to the casing included in the main body (5110).

In other embodiments, the main body (5110) may be a computing device including at least one processor and device.

As illustrated, the hinge eye cover (5140) includes an upper plate (5142) that blocks the upper part of eyes periphery, side plates (5146) that blocks the sides of eyes periphery, and a bottom plate (5144) that blocks the bottom part of eyes periphery. The upper plate (5142) and the bottom plate (5144) is equipped with a torsion spring (5148) on its hinge part, thereby making it tend to elastically be laid over the back surface of the ocular plate (5120).

The side plate (5146) may lift up the upper plate (5142) and the bottom plate (5144) as it unfolds, and may form three-dimensional structure of the hinge eye cover (5140) by supporting the upper plate (5142) and the bottom plate (5144) using its protrusion and reception structure when it is fully unfolded.

The two edges of each of the upper plate (5142) and the bottom plate (5144) may have raised edges (5143) in order to prevent side plates (5146) from separating. The surface of the side plates (5146) may have protrusion or reception structure to fix the upper plate (5142) and the bottom plate (5144) when retracted to the raised edges (5143).

The features of the hinge eye cover explained in this embodiment may be applied to virtual reality devices of other embodiments, and a user may creatively adjust according to different embodiments.

FIG. 71 is a side view to explain the hinge virtual reality device of the first embodiment of this invention.

Referring to FIG. 71, according to the present embodiment, the hinge virtual reality device includes a main body (5110), an ocular plate (5120-1), an arch screen (5130), and a rear cover (5150). The specifics of the compositions designated by the same number may refer to the previous embodiments.

Referring to the first embodiment of FIG. 71, the main body (5110) includes a cell phone body and a casing accommodating the cell phone body. The rear cover (5150) illustrated in FIG. 71 connects to the casing included in the main body (5110).

In other embodiments, the main body (5110) may be a computing device including at least one processor and display.

However, unlike the previous embodiments, the edge of the ocular plate (5120-1) does not rotatably equip to the rear cover (5150), but rather be provided to the arch screen (5130) in an elastically transformable way. For this, the ocular plate (5120-1) may be provided using elastic rubber materials like silicon, or etc. In a storage mode, as illustrated by broken lines, it may be indented into the screen (5130). In a display mode, as illustrated by full lines, it may protrude outside the screen (5130). The ocular lenses (5122) in such display mode may be provided parallel to the virtual reality display.

In the present embodiment, the ocular plate (5120-1) is provided with closed side and bottom surfaces, thereby able to provide the function of the assistant screen (5135) of FIG. 67. Besides, within its elasticity, the side or bottom surface of the three-dimensional structure of the ocular plate may be partially opened.

The technical features explained in this embodiment may be applied to other embodiments, and a user may creatively adjust according to different embodiments.

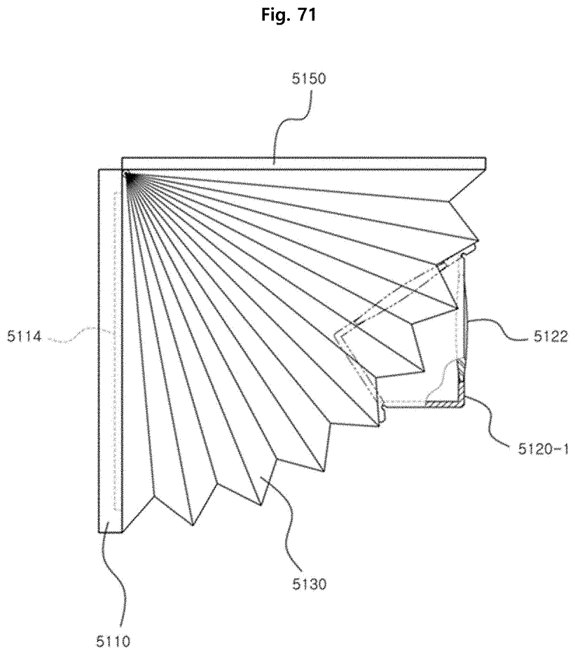

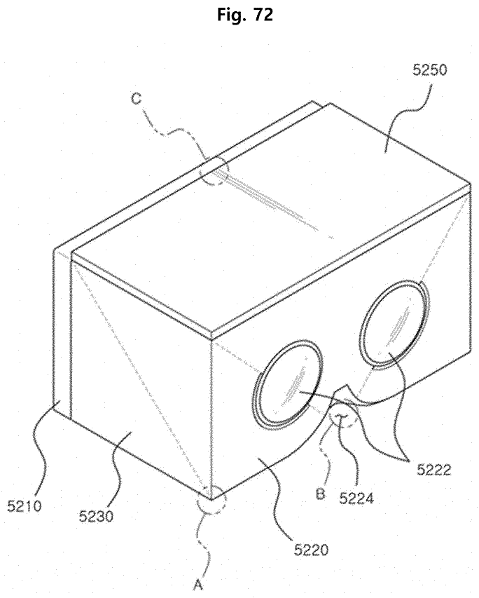

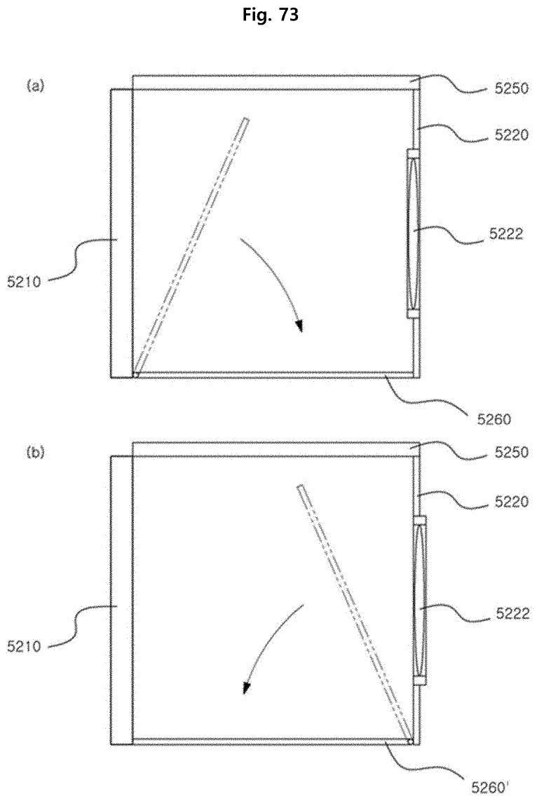

FIG. 72 is a perspective view to explain the hinge virtual reality device of the first embodiment of this invention. FIG. 73 is a cross section diagram to explain the operation of the bottom cover of the hinge virtual reality device of FIG. 72.

Referring to FIG. 72, the hinge virtual reality device (5200) may include a main body (5210), an ocular plate (5220), side screens (5230), a rear cover (5250) and a bottom cover (5260).

Referring to the first embodiment of FIGS. 72 and 73, the main body (5210) includes a cell phone body and a casing accommodating the cell phone body. The rear cover (5250) illustrated in FIGS. 72 and 73 connects to the casing included in the main body (5210). Also, according to the embodiment of FIG. 73(a), the bottom cover (5260) also connects to the casing included to the main body (5210).

In other embodiments, the main body (5210) may be a computing device including at least one processor and display.

The main body (5210) includes the main display disposed on the front surface and the virtual reality display disposed on the rear surface. The ocular plate (5220) includes ocular lenses (5222) for virtual reality functions.

The main body (5210) and the ocular plate (5220) are mutually connected by the rear cover (5250). Specifically, one end of the rear cover (5250) rotatably connects to one edge of the rear surface of the main body (5210), and the rear cover (5250) may laid over or perpendicularly unfold on the rear surface of the main body (5210). Also, the ocular plate may rotatably connect to one end of the rear cover (5250). The ocular plate (5220) is laid over the rear cover (5250) in a storage mode, and when the rear cover (5250) is in an unfolded state, the ocular plate (5120) may unfold downwards parallel to the rear surface of the main body (5210) or the virtual reality display (5214).

The side screens (5230) may cover the rear cover (5250) and the side of the main body (5210). The side screens (5230) are hinged between the rear cover (5250) and the main body (5210) in a slimly storage mode, and as it unfolds for a display mode, they may form a dark room between the main body (5210) and the ocular plate (5220). For this purpose, the side screens (5230) may be provided by using pieces connected by folding brackets, and the pieces may connect each other guiding the main body (5210) or the rear cover (5250) to mutually retract.

For example, in FIG. 72, as the side screens (5230) folds into between the main body (5210) and the rear cover (5250), the A-marked part of the side screens (5230) gathers on the below center part of the rear cover (5250), and the ocular plate (5220) folds into between the main body (5210) and the rear cover (5250). In effect, the B-marked part of the ocular plate (5220) moves inside and moves to the C-part, the center of where the main body (5210) and the rear cover (5250) connects, thereby converting to a storage mode.

At the same time, the side screens (5230) may connect to the sides of the ocular plates (5220). The ocular plate (5220) and the side screens (5230) may simultaneously unfold as a storage mode moves onto a display mode. In this case, the ocular plate (5220) may be partially hinged by folding brackets, and a half circle shaped slit may be formed around the ocular lenses (5222)

The bottom cover (5260) which covers the bottom surface of a dark room (DR) in a display mode may be additionally included. As illustrated in FIG. 73 (a), one end of the bottom cover (5260) may rotatably connect to the main body (5210) facing the rear cover (5250). It may block the bottom surface of a dark room (DR) as it supports the interposition between the ocular plate (5220) and the main body (5210) by its one side hung to the ocular plate (5220).

The below center part of the ocular plate (5220) may have a nose reception (5224), and the bottom cover (5260) may have a reception according to the nose reception (5224).

Though one end of the bottom cover (5260) rotatably connects to the below edge of the main body (5210) in the present embodiment, as illustrated in FIG. 73 (b), one end of the bottom cover (5260) may rotatably connect to one edge of the ocular plate (5220) facing the rear cover (5250). It may block the bottom surface of a dark room (DR) as it supports the interposition between the ocular plate (5220) and the main body (5210) by its one side hung to the ocular plate (5220).

Though the ocular plate (5220) hinges between the main body (5210) and the rear cover (5250) in the above embodiment, it may retract to the inside surface of the rear cover in a flat state without hinging in different cases.

The technical features explained in this embodiment may be applied to other embodiments, and a user may creatively adjust according to different embodiments.

FIG. 74 is a perspective view to explain simultaneously hinging side screens, ocular plate, and bottom cover of the hinge virtual reality device of the first embodiment of this invention.

Referring to FIG. 74, the hinge virtual reality device may include a main body (510), an ocular plate (5220), side screens (5230), a rear cover (5250) and a bottom cover (5260-1). The specifics of the compositions designated by the same number may refer to the previous embodiments.

Referring to the first embodiment of FIG. 74, the main body (5210) includes a cell phone body and a casing accommodating the cell phone body. At least one of the rear cover (5250) and the bottom cover (5260-1) illustrated in FIG. 74 connects to the casing connected to the main body (5210).

In other embodiments, the main body (5210) may be a computing device including at least one processor and display.

However, the bottom cover (5260-1) also connects to the bottom edge of the side screens (5230). Similar to the ocular plate (5220), it is hinged between the rear cover (5250) and the main body (5210) in a slimly storage mode, and as it unfolds for a display mode, it may form a dark room along with the side screens (5230) and the ocular plate (5220). For this purpose, the bottom cover (5260-1) may be provided by using pieces connected by folding brackets, and the pieces may connect each other guiding the main body (5210) or the rear cover (5250) to mutually retract.

Therefore, while unfolding the rear cover (5250), the bottom cover (5260-1) may simultaneously unfold with the ocular plate (5220) and the side screens (5230), and unlike the previous embodiment, it may skip the separately unfolding process.

The following explains the embodiment of the portable virtual reality device including a flexible display, referring to FIGS. 75 to 88.

FIG. 75 is a diagram to explain the shape of the portable virtual reality device following the first embodiment of this invention. FIG. 76 is a diagram to explain the transforming process of the portable virtual reality device of FIG. 75. FIG. 77 is a diagram to explain the interior structure of the portable virtual reality device of FIG. 75.

Referring to FIGS. 75 to 77, according to the present embodiment, the portable virtual reality device (6100) includes a main body (6110), an ocular plate (6120), and a connecting body (6130).

The main body (6110) includes the flexible display (6112) disposed on the front surface and the virtual reality display (6114) disposed on the rear surface. It is 3-dimensionally transformable along with the flexible display (6112). The ocular plate (6120) includes ocular lenses (6122) for virtual reality functions. It may maintain the extended state with a certain distance from the virtual reality display (6114), corresponding to the transformation of the main body (6110).

Though it is not illustrated, a camera module may be fastened to the main body (6110). The camera module may be used for a purpose of recording an outside image, or for implementing functions like augmented reality (AR) or mixed reality (MR). One or more camera modules may be provided, and its directions may also be provided in plurality to simultaneously record not only forward but also on side, upper side, underside, and rearward. It may also be provided in a form of a fisheye lens for 180 or 360 degree angle recording. The adaptations of the camera module and augmented reality, etc. may be likely applied to other embodiments in this statement.

As does in FIG. 75, a user can view an image, displayed on the virtual reality display (6114) via ocular lenses (6122). The ocular lenses (6122) may adjust their focal point by minute rotation control, and adjust their interval to correspond to an interval between eyes. Besides, there may be a facial cushion or additional light blocking structure added to the ocular lenses (6122).

The connecting body (6130) connects the main body (6110) and the ocular plate (6120) on its both sides. Therefore, one side of the ocular plate (6120) foldably connects to one side of the main body (6110) in general, and as the virtual reality display (6114) of the main body (6110) transforms 3-dimensionally, bending the main body (6110), to make the ocular plate (6120) and the ocular lenses (6122) to face each other, the ocular plate (6120) and the connecting body (6130) along with the main body (6110) may form a hollow square pillar with an empty center.

As the main body (6110), the ocular plate (6120) and the connecting body (6130) forms the hollow square pillar, the ocular lenses (6122) on the rear surface of the main body (6110) faces, and a user may utilize virtual reality functions using the virtual reality display (6114) via the ocular lenses (6122).

As illustrated in FIG. 76 (a), the ocular plate (6120) and the connecting body (6130) retract on the rear surface of the main body (6110) when in portable mode. A user may transform the virtual reality device which includes the main body (6110), the ocular plate (6120), and the connecting body (6130), into the hollow square pillar form by pressing the sides of the device or firmly grabbing the device, in order to implement virtual reality functions.

A user may use the virtual reality device (6100) of the present embodiment for diverse purposes. The portable virtual reality device (6100) includes the flexible display (6112), is able to run diverse applications and may provide functions of conventional cell phones or devices. The user can transform the device into the 3-dimensional form.

Also, the flexible display (6112) may perform a separate function while in the 3-dimensional form for implementing virtual reality function. For example, it can implement a same or related content of a virtual reality display which a user is using. In this case, the user equipped with the virtual reality device may exchange information or emotion with other users or nearby people.

The technical features explained in this embodiment may be applied to other embodiments, and a user may creatively adjust according to different embodiments.

FIG. 78 is a diagram to explain the hinge eye cover on the ocular plate of the portable virtual reality device, following the first embodiment of this invention. FIG. 79 is a diagram to explain the hinged state of the hinge eye cover in FIG. 78. FIG. 80 is a diagram to explain the support structure of the hinge eye cover in FIG. 78.

Referring to FIGS. 78 to 80, the portable virtual reality device may include a main body, an ocular plate (6120), and a connecting body. Additionally, in order to block the light from outside from a user's eyes, the hinge eye cover (6140) may be added to the ocular plate (6120). The hinge eye cover (6140) in its unfolded state blocks the light that intrudes around the eyes. It may be provided in diverse forms maintaining its slim state when folded.

As illustrated, the hinge eye cover (6140) includes an upper plate (6142) that blocks the upper part of eyes periphery, side plates (6146) that blocks the sides of eyes periphery, and a bottom plate (6144) that blocks the bottom part of eyes periphery. The upper plate (6142) and the bottom plate (6144) is equipped with a torsion spring (6148) on its hinge part, thereby making it tend to elastically be laid over the back surface of the ocular plate (6120).

The side plate (6146) may lift up the upper plate (6142) and the bottom plate (6144) as it unfolds, and may form three-dimensional structure of the hinge eye cover (6140) by supporting the upper plate (6142) and the bottom plate (6144) using its protrusion and reception structure when it is fully unfolded. In order to convert into a portable mode in which the plates lay over the rear surface of the ocular plate (6120), the side plate (6146) may undo supporting the upper plate (6142) and the bottom plate (6144), thereby making the upper plate (6142) and the bottom plate (6144) lay over together.

The two edges of each of the upper plate (6142) and the bottom plate (6144) may have raised edges (6143) in order to prevent side plates (6146) from separating. The surface of the side plates (6146) may have protrusion or reception (6145) structure to fix the upper plate (6142) and the bottom plate (6144) when retracted to the raised edges (6143).

The features of the hinge eye cover explained in this embodiment may be applied to virtual reality devices of other embodiments, and a user may creatively adjust according to different embodiments.

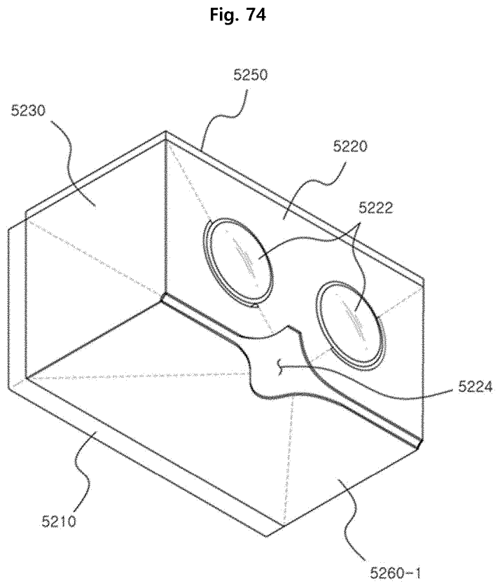

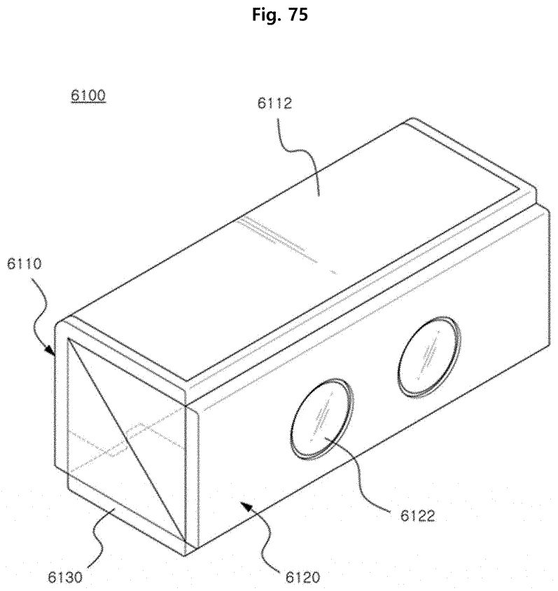

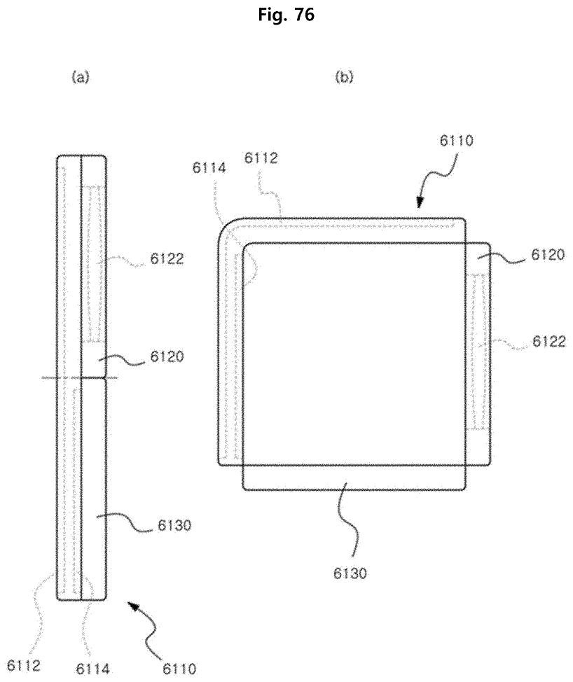

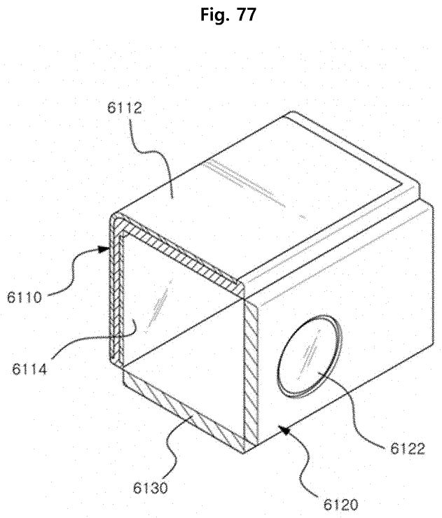

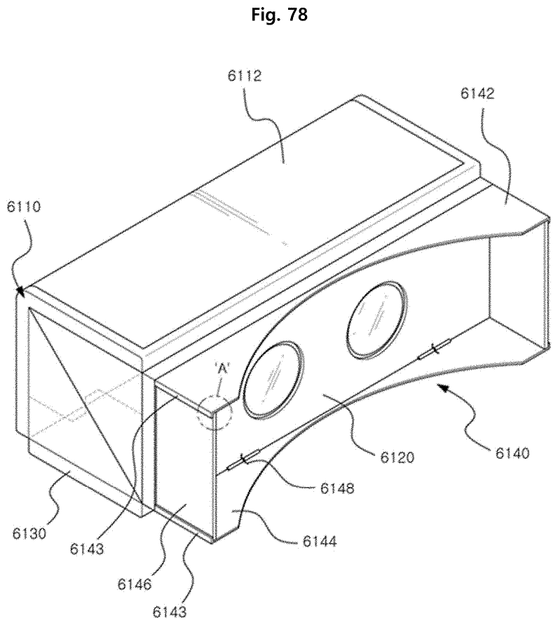

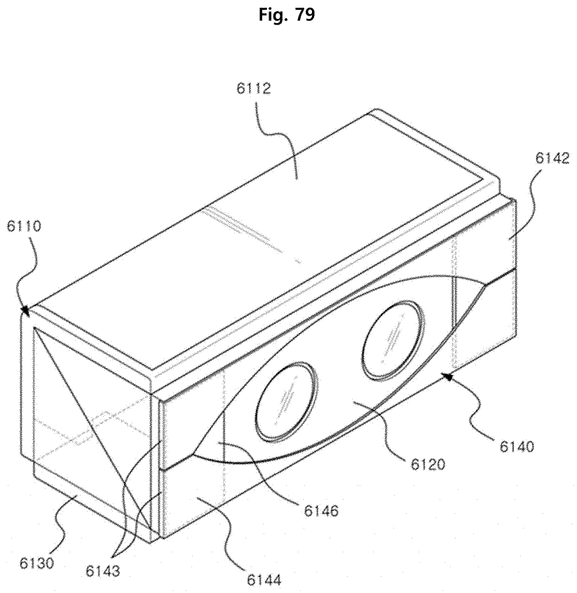

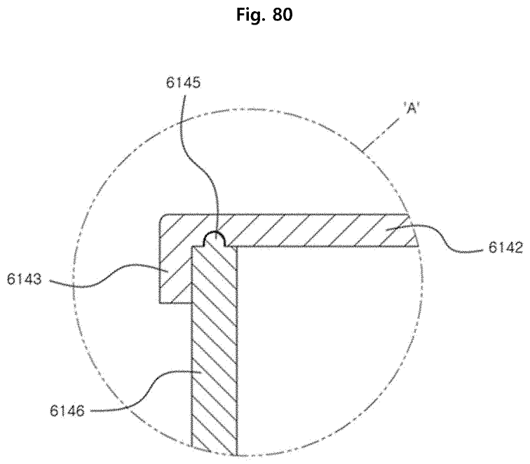

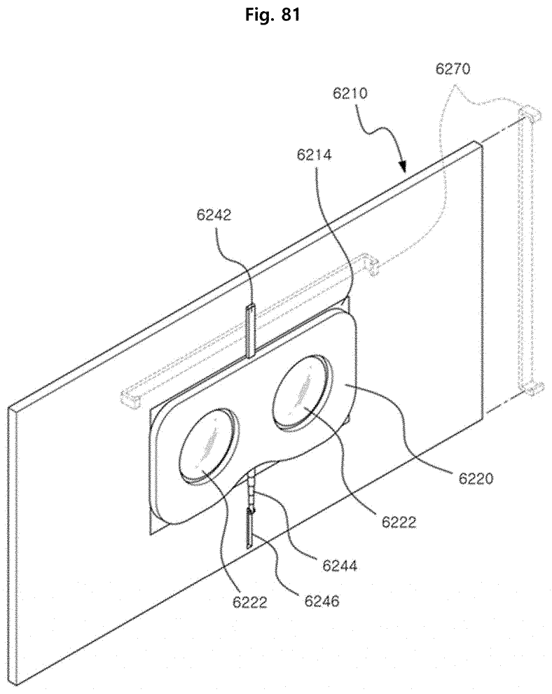

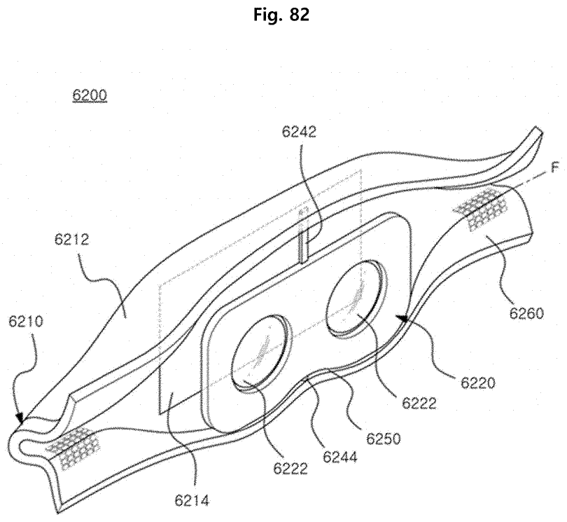

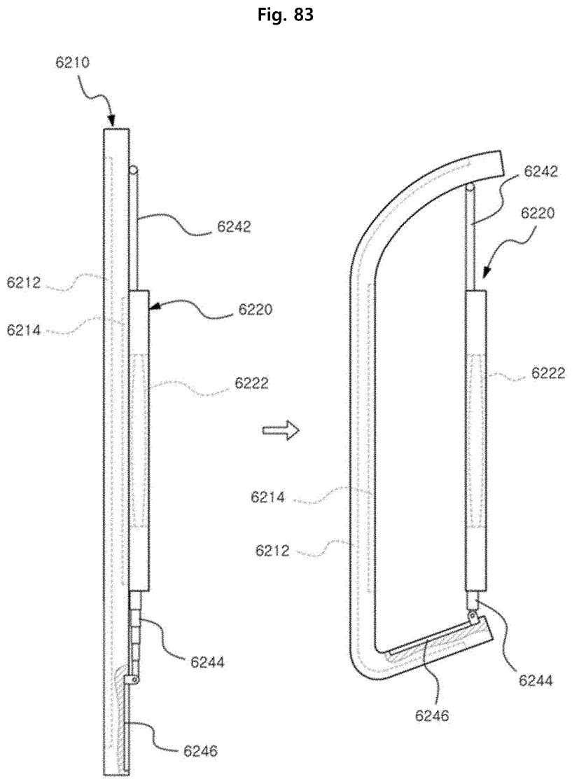

FIG. 81 is a diagram to explain the portable mode of the portable virtual reality device, following the first embodiment of this invention. FIG. 82 is a diagram to explain the 3-dimensional state of the portable virtual reality device in FIG. 81. FIG. 83 is a diagram to explain the transformation process of the portable virtual reality device in FIG. 81.

Referring to FIGS. 81 to 83, the portable virtual reality device (6200) includes a main body (6210) and an ocular plate (6220). The main body (6210) includes the flexible display (6212) disposed on the front surface and the virtual reality display (6214) disposed on the rear surface. It is 3-dimensionally transformable along with the flexible display (6212). The ocular plate (6220) includes ocular lenses (6222) for virtual reality functions. It may maintain the extended state with a certain distance from the virtual reality display (6214), corresponding to the transformation of the main body (6110).

The main body (6210) may transform along with the flexible display (6212) to form an overall curb. Specifically, in 3-dimensional state, the main body (6210) transforms in a concave manner to form a rear space (RS) on the virtual reality display (6214). It may form a nose reception (6250) corresponding to a user's nose on below part of the virtual reality display (6214), and a side reception (6260) to cover sides of a user's face on sides of the virtual reality display (6214). The nose reception (6250) and the side reception (6260) may maintain overall curbs corresponding to a shape of a user. The main body (6210) and the flexible display (6212) may also transform corresponding to a shape of a user's face.

In portable mode, the ocular plate (6220) retracts on the virtual reality display (6214). In 3-dimensional state for virtual reality functions, the ocular plate (6220) may extend away from the virtual reality display (6214) and be located at the end side of a rear space (RS).

For such purpose, a fixed link (6242) which connects the upper part of the ocular plate (6220) and the upper part of the main body (6210), and an alterable link (6244) which connects the below part of the ocular plate (6220) and the below part of the main body (6210) may be used. The fixed link (6242) has a fixed length. Also, the alterable link (6244) may transform to extend or contract as cylinders of an antenna does. In this explanation, the below part of the alterable link (6244) may be equipped in a manner which it could slide along the moving guide (6246) interposed between the virtual reality display (6214) and the nose reception (6250). Therefore, in 3-dimensional state for virtual reality functions, the ocular plate (6220) may maintain an extended state distanced from the virtual reality display (6214), guided by the fixed link (6242) and the alterable link (6244).

Also, as illustrated in FIG. 81, in order to unfold the main body (6210) from 3-dimensional state to portable mode, flat tool (6270) may be additionally provided. The flat tool (6270) may penetrate the main body (6210) horizontally or vertically while receiving part of the main body (6210). As a result, it may straighten the main body (6210) to be flat in portable mode. The flat tool (6270) may be equipped in part of the side of the main body (6210), or it may be inserted into a hole inside the body like a stylus pen.

The technical features explained in this embodiment may be applied to other embodiments, and a user may creatively adjust according to different embodiments.

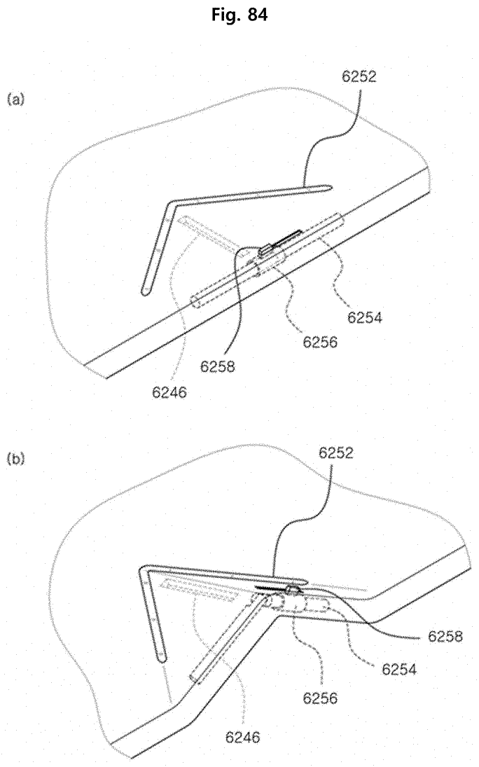

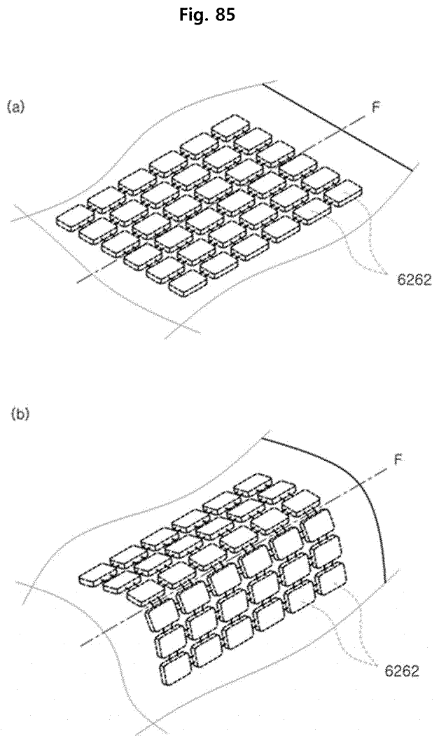

FIG. 84 is a diagram to explain the nose reception of the portable virtual reality device, following the first embodiment of this invention. FIG. 85 is a diagram to explain the side reception of the portable virtual reality device, following the first embodiment of this invention.

Referring to FIG. 84, the main body (6210) may include a V-structure (6252) disposed at the front of the nose reception (6250) in order to maintain convex form of the 3-dimensional nose reception (6250). The V-structure (6252) basically presses parts of the main body (6210) in order to form the nose reception (6250) in a convex shape. Provided there is no limitation from outside, the nose reception (6250) forms a convex shape by the V-structure (6252) that tends to decrease the included angle.

Adjacent to the V-structure (6252) and corresponding to the nose shape of a user by the edge of the main body (6210), a plastic link (6254) for bending the rear part of the nose reception (6250) in opposite V-shape and a hollow fixer (6256) for partially covering the connecting part of the plastic link (6254) to maintain a linear state of the plastic link (6254) may be included.

The plastic link (0254) may be formed in opposite V-shape or linearly, but may basically tend to bend in opposite V-shapes due to the pressure from the V-structure (6252). Therefore, the hollow fixer (6256) may slide within the main body (6210) by an exposed button (6258). When the hollow fixer (6256) covers the connecting part of the plastic link (6254), the linearly arranged plastic link (6254) may be linearly fixed within the main body (6210).

However, when the hollow fixer (6256) evades from the connecting part of the plastic link (6254), the plastic link (6254) bends in opposite V-shape due to the V-structure (6252), and may generally form the shape of the nose reception (6250) corresponding to 3-dimensional state.

Referring to FIG. 85, in order to guide the bend of the main body (6210), plastically changeable pieces (6262) accommodated inside the main body (6210) may be included to the periphery of the bending line (F) of the main body (6210). In the present embodiment, the plastically changeable pieces (6262) may be formed in diverse shapes other than square like hexagon, octagon, or circle and be connected by plastically changeable wire. The plastically changeable pieces (6262) may be formed only around the bending line (F) area wise, but, for free transformation of the main body (6210), they may also form inside the main body (6210) and specifically, all other areas except where the virtual reality display (6214) is disposed.

In such case, the main body (6210) may be equipped with a main board, a battery, an antenna, etc., corresponding to the location of the virtual reality display (6214). For other parts to freely transform, most of the interior components may be focused within or around the area where the virtual reality display (6214) is disposed.

The technical features explained in this embodiment may be applied to other embodiments, and a user may creatively adjust according to different embodiments.

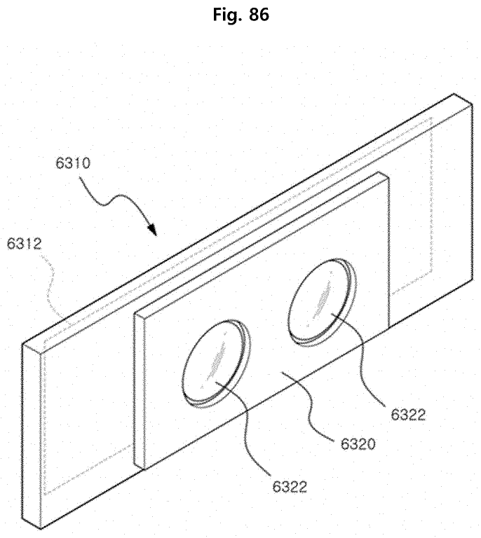

FIG. 86 is a diagram to explain the portable mode of the portable virtual reality device, following the first embodiment of this invention. FIG. 87 is a diagram to explain the 3-dimensional state of the portable virtual reality device in FIG. 86.

Referring to FIGS. 86 and 87, the portable virtual reality device (6300) includes a main body (6310), an ocular plate (6320) and a screen member (6330). The main body (6310) includes a flexible display (6312) disposed on the front surface and a virtual reality device (6314) disposed on the rear surface, and it is 3-dimensionally transformable along with the flexible display (6312). The ocular plate (6320) includes ocular lenses (6322) for virtual reality functions, and may extend, maintain and adjust certain distance from the virtual reality display (6314) corresponding to the 3-dimensionally transformed main body (6310).

The main body (6310) may transform in a bow shape to make a rear space (RS) on the virtual reality display (6314). The concave main body (6310) may form side receptions on sides of the virtual reality display (6314), which covers sides of user's face around outer ends of eyes.

In a portable mode, the ocular plate (6320) retracts over the virtual reality display (6314), and in a 3-dimensional state for virtual reality functions, the ocular plate (6320) extends away from the virtual reality display (6314) and be located on a rear space (RS), guided by the screen member (6330).

The screen member (6330) is additionally included to guide the ocular plate (6320) in a portable mode and a 3-dimensional state. The screen member (6330) may block the upper and bottom part of a user's eye periphery. The screen member (6330) is equipped on the rear surface of the main body (6310), and may include a plurality of screen pieces (6340) configured to slide and be fixed while being laid over each other. The screen pieces (6340) are formed adjacent to the upper and bottom part of the virtual reality display (6314) in order to block the upper and bottom part. The side may be exposed as the main body (6310) could possibly block. In other cases, the screen pieces (6340) may form in square or other shapes corresponding to the shape of the virtual reality display (6314).

In the screen member (6330), as the screen pieces (6340) slides with friction as a metal antenna does, it could be fixed at the random point, or maintain changeable distance. Also, as the screen pieces (3540) is able to screen the light from outside along with the main body (6310).

Though it is not illustrated, the screen pieces (6340) that constitutes the screen member (6330) may be formed in a double wall structure. The screen pieces that constitutes the double wall may include the inner wall and the outer wall. The double wall structure is drastically light weighted and structurally solid compared to a single wall structure with a same thickness.

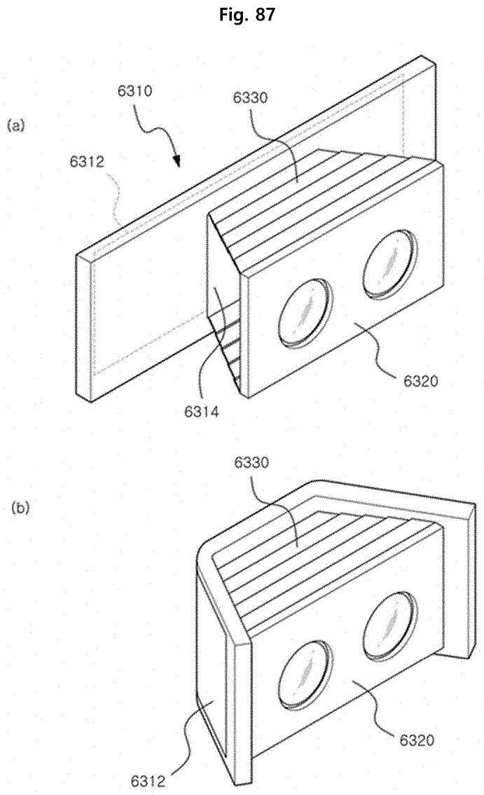

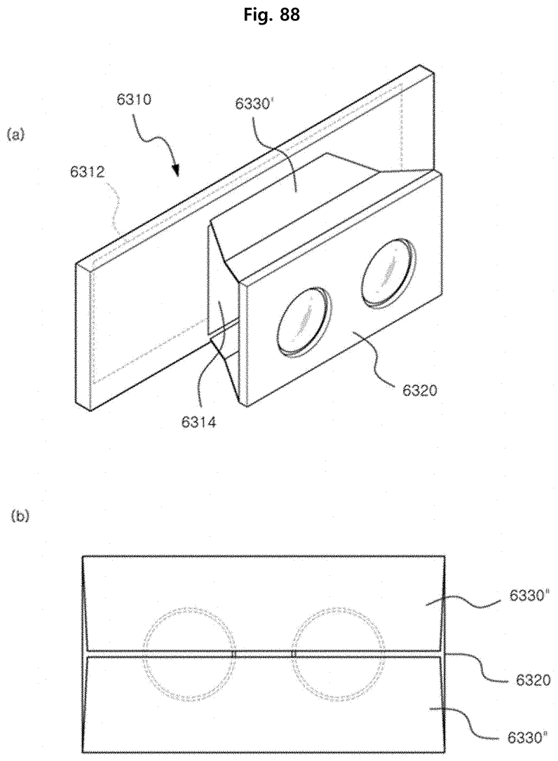

FIG. 88 is a diagram to explain the portable virtual reality device, following the first embodiment of this invention.

Referring to FIG. 88 (a), the screen member (6330′) may be provided by using pieces connected by folding brackets, and the pieces may connect each other enabling the ocular plate (6320) to convert to an extended state or a retracted state. When the ocular plate (6320) is in an extended state, the virtual reality display (6314) of the main body (6310) may implement virtual reality functions.

In the present embodiment, the screen member (6330′) may be formed using compound materials of synthetic resin panels, metal sheets, rubber, or using paper. The screen member (6330′) may flatly retracted as folding box does, and may be extended for an extended state.

In such case, the screen member (6330′) may be formed to block only the upper and bottom part of a rear space on the virtual reality display (6314), or may be formed to block all 4 sides.

Referring to FIG. 88 (b), the screen member (6330″) including a flip cover rotatably equipped to the rear edge of the main body (6310) may be included. The flip cover is equipped on both upper and bottom part of the virtual reality display of the main body (6310). The flip cover in its closing state covers the ocular plate (6320) in a retracted state, and in its blooming state, the flip cover blocks the upper and bottom part of the ocular plate (6320) in an extended state, thereby blocking lights incoming to a rear space.

The technical features explained in this embodiment may be applied to other embodiments, and a user may creatively adjust according to different embodiments.

For reference, though the present statement explains the screen member using a plurality of the screen boxes, the screen member may be formed using air tube, foldable screen, roll screen, dark screen supported by springs, memory form, etc. as specified in previously applied KIPRIS 10-201600121606, and may also use manual or automatic actuator.

Also, as explained above, though the previous embodiments explain the instances where a main body is directly connected to a converted body or a screen member, a main body may be indirectly connect to a converted body or a screen member via protector frame which is able to accommodate the main body. Other operating mechanisms may be implemented by the protector that includes the same functions as the previous embodiments. Also, a case may additionally include conventional components like flip cover, bumper, earphone jack cover depending on needs.

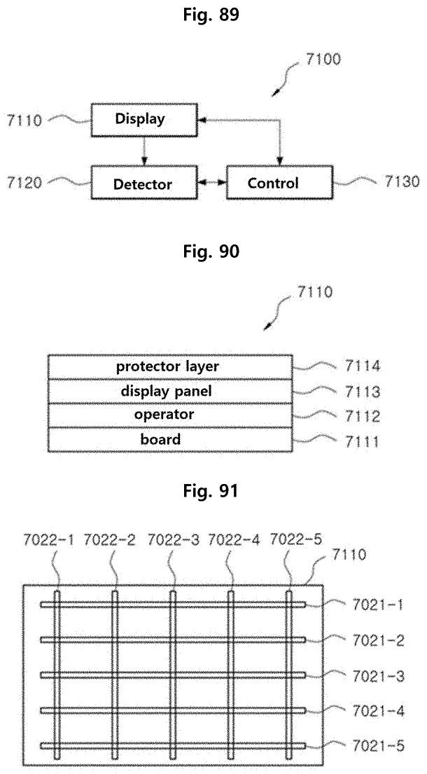

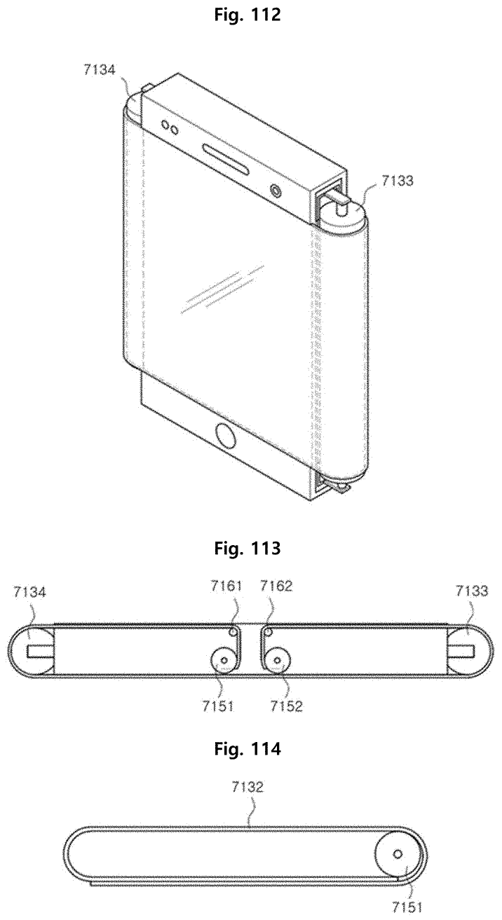

According to another aspect of the suggested embodiments, the following explains the display extendable device referring to FIGS. 89 to 115.

FIG. 89 is a block diagram showing the composition of the flexible device, following the first embodiment of this invention. The device of FIG. 89 may be embodied as a portable device with display function like cell phone, smart phone, PMP, PDA, tablet PC, navigation, etc., or as a stationary device like monitor, TV, kiosk, etc.

Referring to FIG. 89, the flexible device (7100) includes a display (7110), a detector (7120), and a whole or parts of control (7130). In advance to explaining FIG. 89, the specific composition of the display (7110) and its bend detecting process would be explained.

FIG. 90 is a diagram to explain the basic composition of the display that constitutes the flexible device, following the first embodiment of this invention. Referring to FIG. 90, the display (7110) includes a board (7111), an operator (7112), a display panel (7113) and a protector layer (7114).

The flexible device is defined as a device which is able to bend, curve, fold or roll like a paper, maintaining the display features of existing flat devices. Therefore, the flexible device should be designed on a flexible board.

Specifically, the board (7111) may be embodied by a plastic board (e.g. polymer film) which can be deformed by external pressure.

A plastic board is structured as a base film with barrier coating on both sides. The base film may be embodied by diverse resins such as PI(polyimide), PC(polycarbonate), PET(polyethyleneterephtalate), PES(polyethersulfone), PEN(polythylenenaphthalate), FRP(fiber reinforced plastic). The barrier coating is applied on opposite sides of the base film, and may employ organic or inorganic layer to maintain flexibility.

On the other hand, the board (7111) may also employ other flexible materials like thin glass or metal foil other than plastic. The operator (7112) functions to operate the display panel (7113). Specifically, the operator allows operating voltage to a plurality of pixels that constitutes the display panel (7113), and it may be implemented by a-si TFT, LTPS (low temperature poly silicon) TFT, OTFT (organic TFT), etc. The operator (7112) may be embodied in various forms according to the embodiment of the display panel (7113). For example, the display panel (7113) may comprise of organic luminary made of a plurality of pixel cells and electrode layer covering the both sides of the organic luminary. In this case, the operator (7112) may include a plurality of transistors corresponding to each pixel cells. The control (7130) allows electric signals to each gates of the transistors, thereby illuminating the pixel cell connected to it. As a result, an image is displayed.

Otherwise, the display panel (7113) may be embodied by EL, EPD (electrophoretic display), ECD (electrochromic display), LCD (liquid crystal display), AMLCD, PDP, (plasma display panel), etc., rather than organic LEDs.

However, LCD requires a separate backlight as it cannot be luminous by itself. LCD without the backlight uses the lights in vicinity. Therefore, in order to use the LCD display panel (7113) without the backlight, certain conditions with enough lights should be prepared, for example, outside.

The protector layer (7114) protects the display panel (7113). For example, the protector layer (7114) may employ ZrO, Ce02, Th02, etc. The protector layer (7114) in a form of transparent film may cover the entire surface of the display panel (7113).

On the other hand, unlike the illustration of FIG. 90, the display (7110) may be embodied by electronic paper. Electronic paper is a display in which standard ink features are adapted to a paper. It is different from standard flat displays in that it uses reflected lights.

On electronic paper, an image or a word may be changed by using a twist ball, or electrophoresis using capsules.

When the display (7110) comprises of transparent material, it may be embodied as a device which is foldable and possesses transparent feature. For example, if the board (7111) is embodied by polymer materials such as transparent plastic, the operator (7112) by transparent transistors, the display panel (7113) transparent organic luminous layers and electrodes, the device may be transparent.

A transparent transistor is a transistor in which opaque silicon of standard film transistor is replaced by transparent materials like ZnO, TiO2, etc. Also, transparent electrodes may employ new materials like ITO(indium tin oxide) or graphene. Graphene is a transparent material in which carbon atoms are connected in a flat beehive shaped structure. Transparent organic luminous layers may also be embodied by various materials. FIGS. 91 to 93 is a diagram to explain the shape alteration, in other words bending, of the flexible device, following the first embodiment of this invention.

The flexible device (7100) may be altered in its shape, being bent by external pressure. The bending may include normal bending, folding, and rolling. The normal bending means the state in which the flexible device bends. It is different from folding and rolling in that bent surfaces do not touch each other.

The folding means the state in which the flexible device folds. The folding and the normal bending may be distinguished by the extent of being bent. For example, the folding may be defined as a bending over certain degree of curvature, and the normal bending may be defined as a bending under that certain degree of curvature.

The rolling means the state in which the flexible device is rolled. The rolling may also be defined with a standard of curvature. For example, the rolling may be defined as a continuative bending detected with certain degree of curvature over certain degree of radius, and the folding may be defined as a bending detected with certain degree of curvature in smaller degree of radius. However, such definitions on various alterations are examples, and are open to different definitions depending on the kind, size, weight, features of the flexible device. For example, if the flexible device (7100) can bend to the extent where the surfaces touch each other, the folding and the normal bending can both defined as a state in which surfaces of the device touch each other. On the other hand, the rolling may be defined as a state in which the front and the rear surface of the device touch each other by bending.

For convenient explanation, the present statement designates bending as a comprehensive concept including all these various forms of bending. The flexible device (7100) may detect bending in various ways.

For example, the detector (7120) may include bend sensor which is disposed on one surface on the front or the rear, or on both surfaces. The control (7130) may detect bending through the Figure sensed by the bend sensor of the detector (7120). The bend sensor here means a sensor which can itself bend and possess different resistance Figure depending on its curvature. The bend sensor may be embodied by a strain gauge. The strain gauge employs metal or semiconductor which drastically changes in its resistance depending on applied force. The change of a surface of object is detected through the change of the resistance. Normally, materials like metal increases in its resistance as it is extended in its length by external force, and decreases in its resistance as it is contracted in its length. Therefore, the bending may be judged by detecting the change in resistance.

The detector (7120) detects the resistance Figure by using the voltage rate allowed to the bend sensor or the amount of electricity that flows through the bend sensor. The bending state on the bend sensor location can be detected according to the resistance Figure.

Though the bend sensor is inside the front surface of the display (7110) in FIG. 91, this is one example of embodiment. The bend sensor may be inside the rear surface of the display (7110), or inside both the front and the rear. Also, the shape of the bend sensor and its number, locations may vary.

FIG. 91 illustrates a plurality of bar-shaped bend sensors arranged horizontally and vertically in a grid form. Referring to FIG. 91, the bend sensor includes the sensors arranged in direction #1 (7021-1 to 7021-5) and the sensors arranged in direction #2 (7022-1 to 7022-5) perpendicular to #1. Each sensor can be arranged with certain distance.

Though FIG. 91 illustrates each 5 sensors (7021-1 to 7021-5, 7022-1 to 7022-5) in each direction, this is one example of embodiment. The number of the bend sensor may vary depending on the size of the flexible device, etc. Arranging the bend sensor in two directions is to detect bending on entire area of the flexible device. Other devices which are partially flexible or only need to detect partial bending may arrange the bend sensor only on certain parts.

Each bend sensor (7021-1 to 7021-5, 7022-1 to 7022-5) may be embodied in forms of electric resistance sensor, or micro-optical fiber sensor which uses distortion rate of the fiber. The following will explain with a presumption of embodying the electric resistance sensor for convenience.

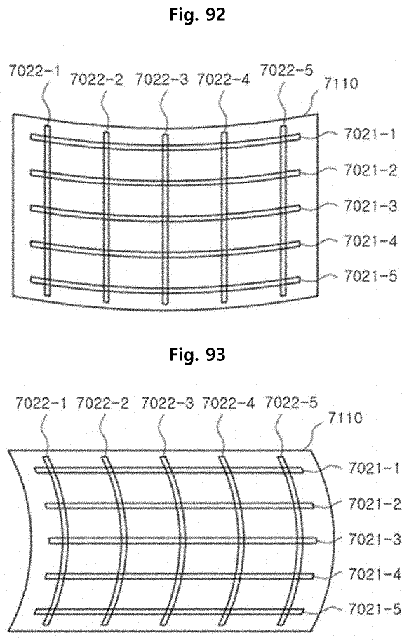

Specifically, as illustrated in FIG. 92, if the flexible device (7100) is bent with its center between left and right edges directed downwards, the tension from the bending is forced on horizontally arranged bend sensors (7021-1 to 7021-5). In response, each of the horizontally arranged bend sensors (7021-1 to 7021-5) differs in its resistance Figure. The detector (7120) detects the outputs from each bend sensor (7021-1 to 7021-5), thereby detects bending horizontal to the display surface center. Though FIG. 92 illustrates the bending downwards perpendicular to the display surface (Z− direction), the bending upwards perpendicular to the display surface (Z+ direction) may also be detected through the change in outputs of horizontally arranged bend sensors (7021-1 to 7021-5-).

Also, as illustrated in FIG. 93, if the flexible device (7100) is bent with its center between upper and bottom edges directed upwards, the tension from the bending is forced on vertically arranged bend sensors (7022-1 to 7022-5). The detector (7120) detects the outputs from each bend sensor (7022-1 to 7022-5), thereby detects bending vertical to the display surface center. Though FIG. 93 illustrates the bending in Z+ direction, the bending in Z+ direction may also be detected through the change in outputs of vertically arranged bend sensors (7022-1 to 7022-5).

Meanwhile, diagonal bending by which the tension is forced on both horizontally and vertically arranged sensors may also be detected through the change in outputs of both horizontally and vertically arranged bend sensors.

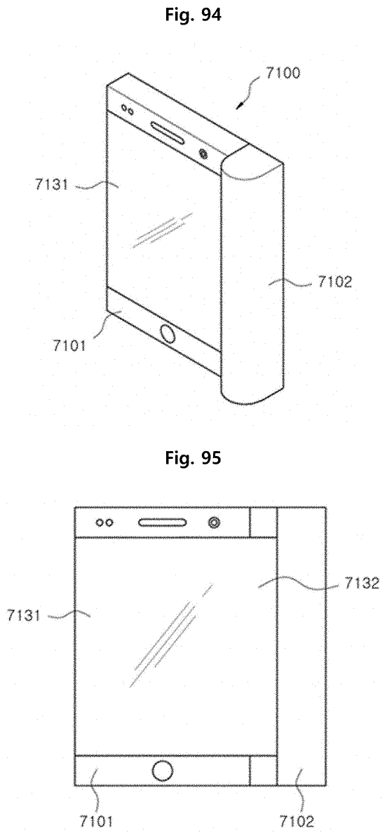

FIGS. 94 and 95 is a diagram showing an example of the device, following the embodiment of this invention.

Referring to FIGS. 94 and 95, the device (7100) of this invention includes a device body (7101) that comprises of the display #1 (7131) and its circuits providing image signals, and a roll depot (7102) which receives the previously explained display #2 (7132) or enables extension or expansion of the display #2 (7132).

The device following the present embodiment of this invention features physical size control of the screen.

Meanwhile, the mentioned display #1 also may be composed as a roll or flexible display.

Also, the roll depot (7102) forms an entry of the display #2 (7132) to enable screen extension by the display #2 (7132) rolling inside or unwinding. The both sides of the roll depot (7102) may have an interval member (7201) to correspond to the height of the device body (7101).

The display #2 (7132) can be combined with the display #1 (7131) in connected form. The display #2 (7132) composed by flexible display may be bent or folded to be accommodated into the roll depot (7102).

In other words, certain parts of the device (7100) of this invention are designed to be fixed on the device body (7101). The others are designed as flexible displays able to bend or fold. When the flexible display #2 (7132) is accommodated inside the roll depot (7102), the display #2 (7132) does not display anything on screen as standby mode.

On the other hand, the display #2 (7132) slipping out of the role depot (7102) thereby increasing the extension connected to the display #1 (7131) may operate as a screen extension function.

When the display #2 (7132) is accommodated inside the roll depot (7102), it may turn to standby mode to prevent transmitting image signals to the display #2 (7132), or prevent power supply of the display #2 (7132) to save power consumption.

Also, when the roll depot (7102) moves away from the device body (7101), the display #2 (7132) slips out of the roll depot (7102), thereby increasing the area of exposed display. As following, the image or screen on the display #1 (7131) may be temporarily or progressively extended by using the display #2 (7132).

For example, when the display #2 (7132) is in standby mode, the display #2 (7132) displays images or screen, performing smart phone mode. When the display #2 (7132) increases its exposure area, the display #2 (7132) may display screen, performing tablet mode. If there are 15 applications displayed on smart phone mode, tablet mode may display 30 or more applications, or the same number of applications may display in expanded size.

In other words, in accordance to the movement of the role depot (7102) or the increase on the display #2 (7132) exposure, the image or screen displayed on the display #1 (7131) may be extended to the display #2 (7132).

Also, in the present embodiment, a screen split function may be implemented thanks to the screen expansion of the display #2 (7132). A user may use the display #1 (7131) and the display #2 (7132) as separate screens. For example, the display #1 (7131) may display image or screen, while the display #2 (7132) displays assistant tools like virtual keyboard.

In accordance to the roll depot (7102) movement, the image or screen exposure of the display #2 (7132) accommodated inside the roll depot (7102) increases. The device body (7101) may detect the movement of the roll depot (7102), detect the bending of the display #2 (7132), detect a user's body temperature on the roll depot (7102), receive a user's iris using camera, receive voice command, perform vocal identification, or measure the vibration or pressure on the roll depot (7102).

The structure of the display #2 (7132) which is extendable from the display #1 (7131) and bendable, and the structure of the roll depot (7102) which accommodates the display #2 (7132) will be further explained in the following.

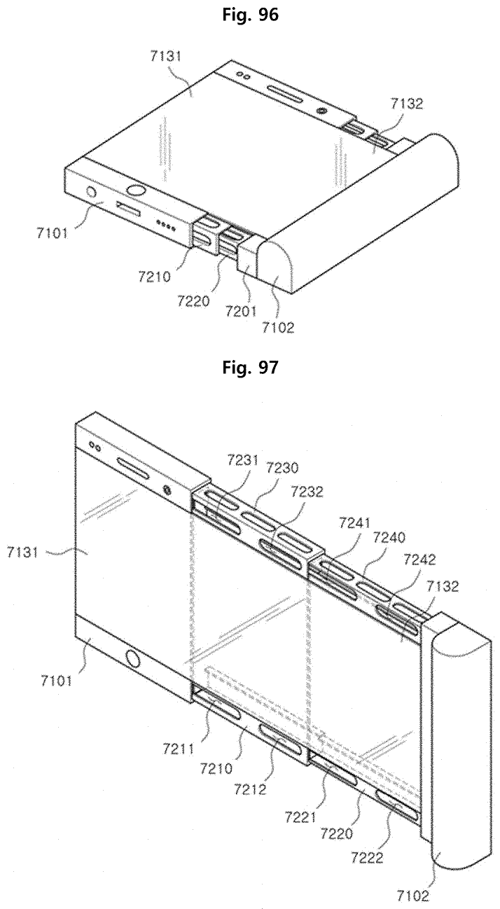

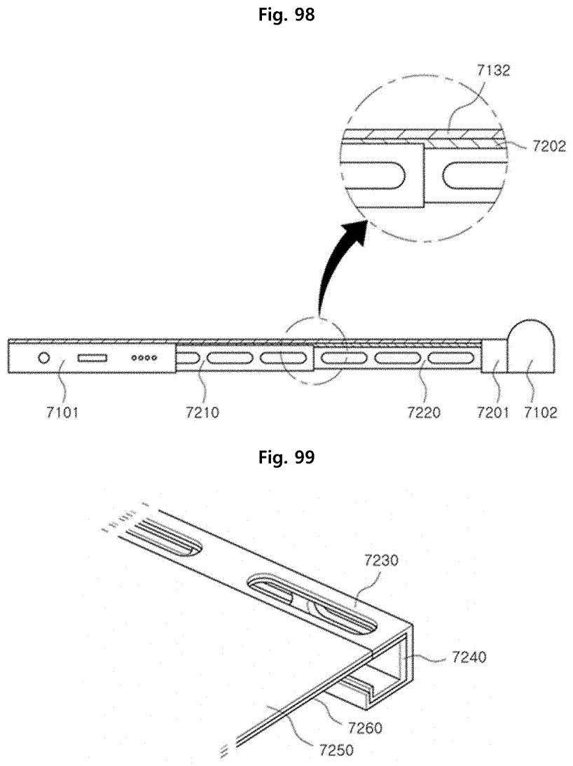

FIGS. 96 and 98 illustrate a case where a display extension is performed in the terminal device of the present invention.

FIGS. 96 and 98, sliding members (7210, 7220, 7230, 7240) that can be drawn out are formed inside the terminal (7101), and these sliding members are moved together with the function of moving the second display and the roll storage (7102), thereby reducing the bending that may occur in the second display (7132) and flattening the display area.

In detail, if the first upper sliding member (7230) and the second upper sliding member (7240) are formed to be pulled out from the upper portion of the terminal main body (7101), the first lower sliding member (7210) and the second lower sliding member (7220) may be formed to be pulled out from the lower portion of the terminal main body (7101).

Since these sliding members (7210, 7220, 7230, 7240) are accommodated in the single portion of the main body (7101) and then pulled out, holes are formed in each portions of the sliding members. For example, a sliding member may have a ‘ r’ shape, two holes may be formed on the upper surface, and three holes may be formed on the side surface. These holes are meant to provide space to normally operate structures such as a camera, speaker, and home button that are formed on the front surface of the terminal main body (7101), but it can be arranged not form holes in some cases and is not limited by shape or quantity. Holes (7211, 7221, 7231, 7241), which are shaped one-side opened, are formed on the left side of each sliding member, and the sliding member that is inserted inside the left side of the terminal main body (7101) is designed to form an accommodating space for electronic components that minimize interference within the smartphone components.

Also, support plates that control the power of the second display (7132) of the flexible in which screen is expanded are placed on the space between the first upper sliding member (7230) and the first lower sliding member (7210) and on the space between the second upper sliding member (7240) and the second lower sliding member (7220). This will be described later with the attached Figure.

Meanwhile, as shown in FIG. 98, a step occurs between the second display (7131) of the flexible and the sliding members. When such occurs, the back side of the second display (7132) is shaped to correspond to the steps that are formed among the sliding members and may be formed with step-preventing member that is slightly elastic like a rubber to avoid the second display (7131) from lifting or flowing. The manner of constituting the step preventing member may be applied to all exemplary embodiments described later.

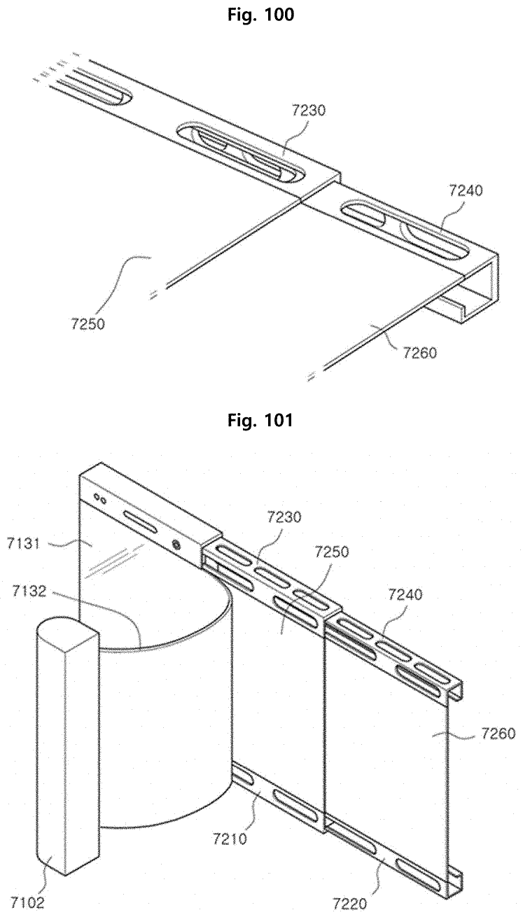

FIGS. 99 and 100 show the support plate that is pulled out together with the sliding member according to an exemplary embodiment of the present invention while FIG. 101 shows the sliding member and the support plate according to an exemplary embodiment of the present invention.

According to this embodiment, when a user pulls the roll storage, the second upper sliding member (7240) and the second lower sliding member (7220) that are connected to the interval member (7201) are pulled together with the second display, and the sliding members are sequentially pulled out from the terminal main body (7101).

At the same time, the support plates (7250, 7260) that are connected to each sliding member are drawn out from the terminal main body (7101), firmly securing the back surface of the second display (7132) of the flexible.

The first support plate (7250) is connected to the upper sliding member (7230) and the lower sliding member (7210), and the second support plate (7260) is connected to the second upper sliding member (7240) and the second lower sliding member (7220).

In a state where the support plates are stored, the support plates are placed on the back surface of the first display (7131) and drawn out when the sliding members are drawn out. Previously explained step preventing member (7202) is shaped to correspond to the step that occurs among the support plates. Also, multiple support plates are formed on the opposite side of the corresponding surfaces, allowing to form a double wall structure, and can be applied to various exemplary embodiments described later.

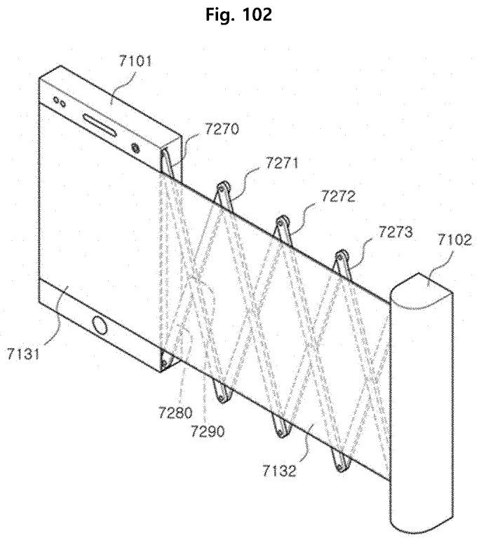

FIG. 102 shows the structure that supports the second display according to the other exemplary embodiment of the present invention.

While the structure that supports the second display of the flexible with the support plates and the sliding members is explained in the above exemplary embodiment, the second display can be secured by the screen because multiple numbers of jig bars are formed to be able to rotate as shown in FIG. 102.

It is formed to extend or reduce a gap from rotation of the jig bars, which may vary depending on the degree of expansion of the second display.

Meanwhile, the first jig bar (7270) and the second jig bar (7280) together may be arranged as well. In this case, a hinge (7290) is constructed to allow the rotation of the first jig bar and the second jig bar.

In another exemplary embodiment, it is possible to secure the second display through the movement of extension or reduction of a gap between the first jig bar (7270) and the second jig bar (7280) because a hinge is arranged in the first jig bar (7270) and the second jig bar (7280). It is also possible to arrange a hinge in the middle of each jig bar and make them rotate in different degree, forming a V-shape for example, while they are separated.

The number and the shape of the rotating rods can vary, and the present invention is not limited to the shown structure.

A case in which a hinge is arranged between several support rods and the support rods to fix their position instead of jig bars is shown in FIG. 116. As shown in FIG. 116, a hinge (7282) is formed between the support rods (7281), and when the exposed area of the second display is reduced, the support rods and the hinge may be stored inside the terminal main body (7101) or in the roll storage (7102). Besides, combining composition of springs, bellows, inflatable tubes, shape alloy wires, and metal plates in a form of roll is possible.

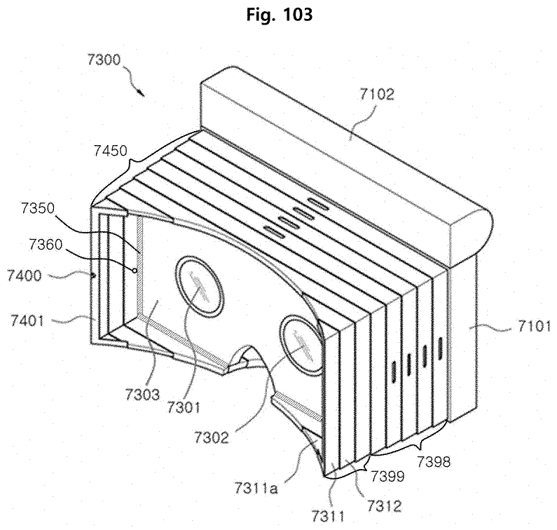

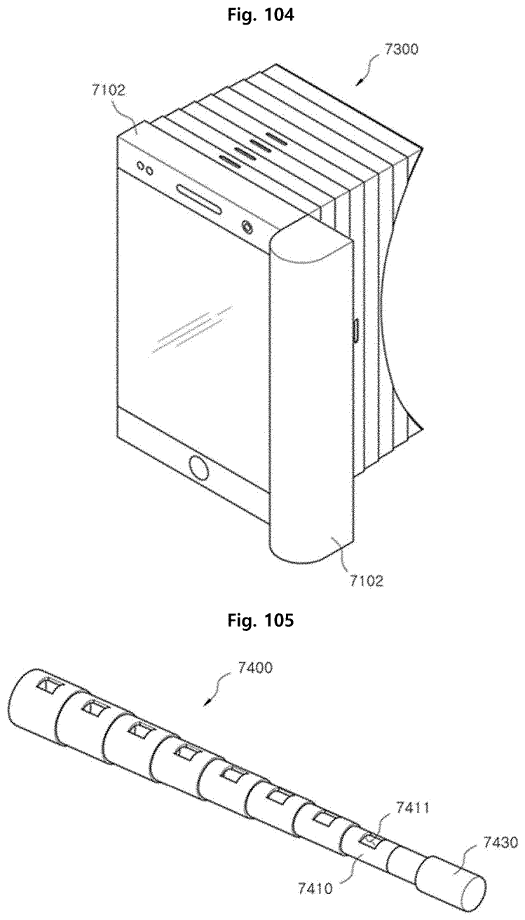

FIGS. 103 and 104 shows a case of VR means according to different exemplary embodiments of the present invention.

As shown in FIGS. 103 and 104, a rear display is provided with a front surface of the terminal display (7101) and the VR mean(7300) may be formed so that a user can use the rear display to watch in VR.

In a case where the rear display is installed on the backside of the terminal main body (7101), the VR mean (7300) can provide various viewing conditions such virtual reality, mixed reality, or augmented reality by displaying the image displayed by the rear display on the eyes of the user.

The VR mean (7300) is consisted of two screen boxes (7311, 7312) and each of the boxes may be comprised of a single, double, or multiple walls. A user can watch in VR by both folding or unfolding because the sizes of the screen boxes are smaller as they are located further away from the terminal main body (7101).

Also, the VR mean (7300) includes an ocular plate (7303) and the first lens (7301) and the second lens (7302) are provided on the ocular plate (7303) where each eye of a user will be placed.

A portion of an outer frame (7401) that touches the user's face functions as a protrusion for letting the ocular plate to isolate the screen boxes from the terminal main body (7101) and has a function of rotating in certain degree. Here, the ocular plate can return to fixed point after isolating the screen boxes.

In addition, as it is arranged to penetrate the screen boxes, more screen fixing means (7400) are provided to prevent the screen boxes from folding while a user is watching in VR.

Refer to FIG. 105 or 109 for the above screen fixing mean (7400).

FIGS. 105 and 109 are figures that explain the screen fixing mean that is provided inside the screen box of the VR mean according to an exemplary embodiment of the present invention.

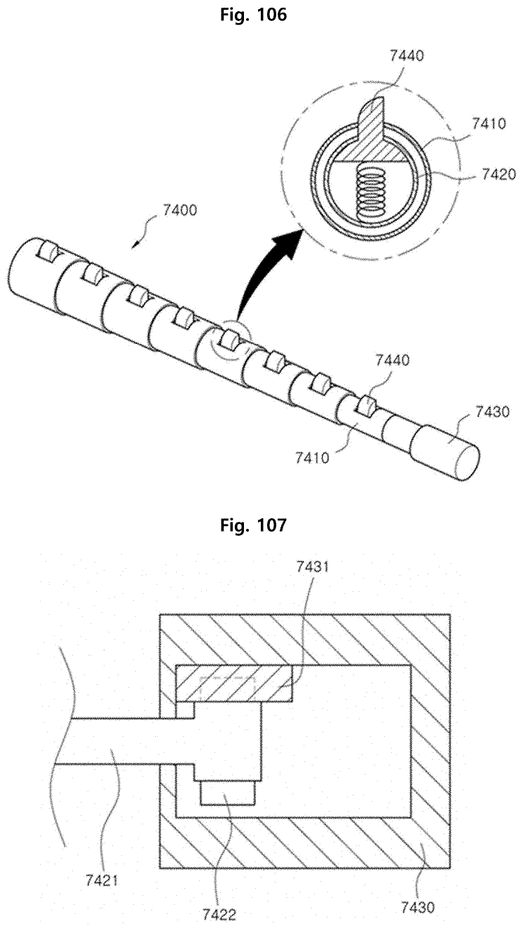

First, according to FIGS. 105 and 106, the screen fixing mean (7400), which is provided inside the screen box of the VR mean according to the exemplary embodiment, allows a user to selectively set the fold or location of the screen box.

The screen fixing mean (7400) is consisted of the same number of folded member (7410) with previously described screen boxes, and each folded member (7410) is provided in either single or double wall, and protrusion accommodation tube (7420) with fixed protrusion (7440) is placed inside the folded members. One side of the fixed protrusion (7440) may be rounded surface with curved shape while the other side may be straight and flat. Also, the end of a fixed selection (7430) can have an inclined surface.

Furthermore, a fixed hole (7411) with size to which a portion of the fixed protrusion (7440) can protrude is formed in each folded member (7410).

The folded members (7410) are formed with the folds of the screen box, and there are the fixed protrusion (7440), the hole with size to which the fixed protrusion can protrude, and the spring that is elastic enough to push the fixed protrusion (7440).

In a state shown in FIG. 106, if a user rotates the protrusion accommodation tube (7420) outside, the bond between each fixed protrusion (7440) and the folded members (7410) will be released as the fixed protrusion (7440) enters inside the folded members (7410). Thus, the user can increase or decrease the length of the screen box as desires.

However, if the user rotates the protrusion accommodation tube (7420) back, making the fixed protrusion (7440) to protrude out of the fixed hole (7411) as shown in FIG. 106, the user will not be able to increase or decrease the screen box for extension or reduction because the length of the screen fixing mean (7400) will be unchanged. In other words, the change in the length of the screen box can be prevented while watching in VR.

Meanwhile, the structure for rotating the protrusion accommodation tube (7420) is shown in FIG. 107 or 109.

At the end of the folded member (7410), a fixed selection (7430) is formed and a user can selectively operate the fixed selection (7430).

A pair of protrusions (7431) extendable from the inner wall is provided inside the fixed selection (7430), and at least one or more may be provided. Also, the protrusion (7431) is formed only on a part of the surface within the fixed selection (7430).

Furthermore, a portion of the end (7421) of the protrusion accommodation tube (7420) is accommodated in the inner part of the fixed selection (7430) and a locking protrusion (7422) protruded with certain thickness is provided at the end (7421) of the protrusion accommodation tube (7420).

In a case where a user pulls the fixed selection (7430) as shown in FIG. 107, the locking protrusion (7422) of the end (7421) of the protrusion accommodation tube (7420) will be touching or blocking the protrusion (7431) of the inner portion of the fixed selection (7430) and if the user rotates the fixed selection (7430), the protrusion accommodation tube (7420) rotates with the fixed selection (7430), allowing the fixed protrusion (7440) to pass through the fixed hole (7411) to be fixed or the fixed protrusion (7440), that was half way through the fixed hole (7411), to enter inside the folded member (7410). Here, the user can change the length of the screen box.

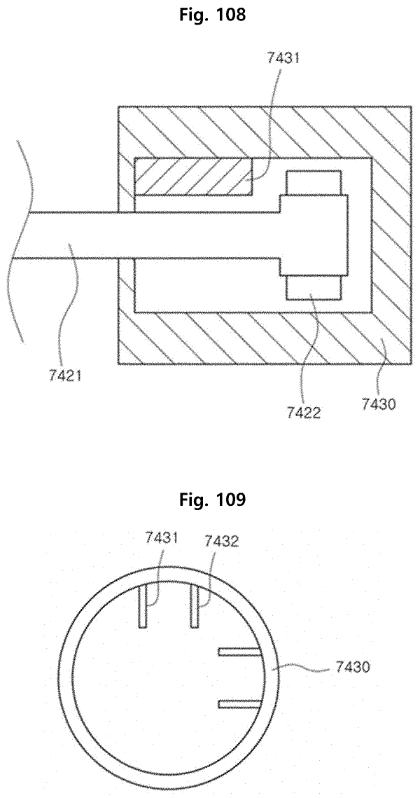

On the contrary, if a user pushes the fixed selection (7430) to the protrusion accommodation tube (7420) as shown in FIG. 108, the locking protrusion (7422) of the end of the protrusion accommodation tube (7420) will not be in contact with the protrusion (7431). In other words, the locking protrusion (7422) and the protrusion (7431) are not mutually restricted. In this case, the protrusion accommodation tube (7420) will not be rotated even if the user rotates the fixed selection (7430).

Thus, the protrusion accommodation tube (742) can be rotated together with the fixed selection (7430) depending on whether a user push or pull the fixed selection (7430), and whether the length of the multiple folded members (7410) can be changed or not varies through the rotation of the protrusion accommodation tube (7420). This structure allows the user to keep the screen boxes folded when he/she wishes them to be folded because the VR means are not used. Also, when the user places his/her face to the ocular plate (7303) and lenses to use the VR means, the structure allows the screen boxes to be kept unfolded.

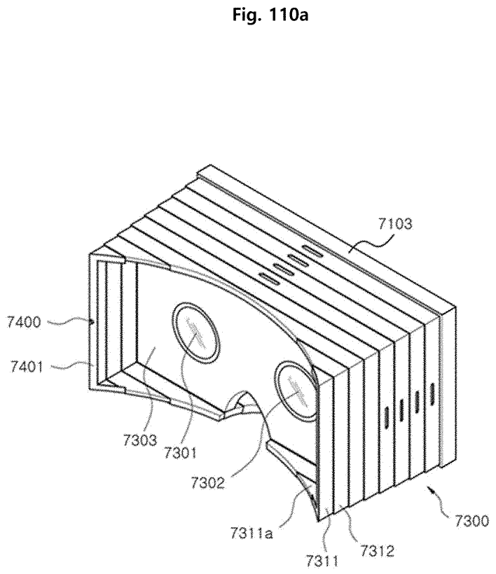

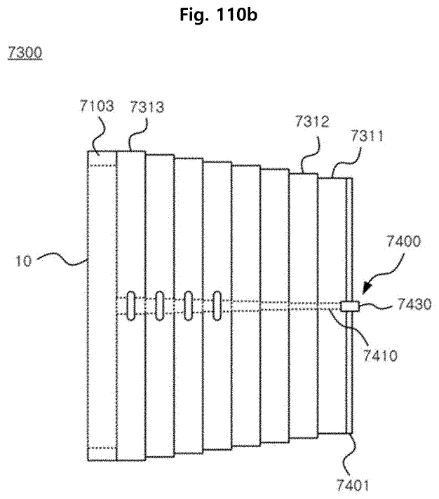

FIG. 110(a) shows a virtual reality cell phone case that includes screen fixing means according to an exemplary embodiment of the present invention.

FIG. 110(a) is another exemplary embodiment of VR mean that is shown in FIG. 103. Thus, even if a content is omitted regarding FIG. 110(a), content described in relation to VR mean of FIG. 103 applies to the virtual reality phone case of FIG. 110(a).

According to FIG. 110(a), VR mean (7300) may be a virtual reality phone case that can accommodate and fix a cell phone (10). In the first exemplary embodiment, VR mean (7300) includes casing (7103) that can accommodate and fix the phone (10).

FIG. 110(b) shows a side of the virtual reality phone case that is shown in FIG. 110(a).

According to FIG. 110(B), VR mean (7300) includes the casing (7103) that can accommodate and fix a phone (10). VR mean (7300) have multiple screen boxes (7311, 7312, 7313) and an end of one (7313) of the screen boxes (7311, 7312, 7313) is connected to casing (7103).

A screen fixing mean (7400) is provided in the screen box to let a user to selectively fold the screen or fix the position.

The fixed selection (7430) of the screen fixing mean (7400) is exposed outside of the screen box, allowing a user to control the screen fixing mean (7400) using the fixed selection (7430) as described in FIG. 105 or 109.

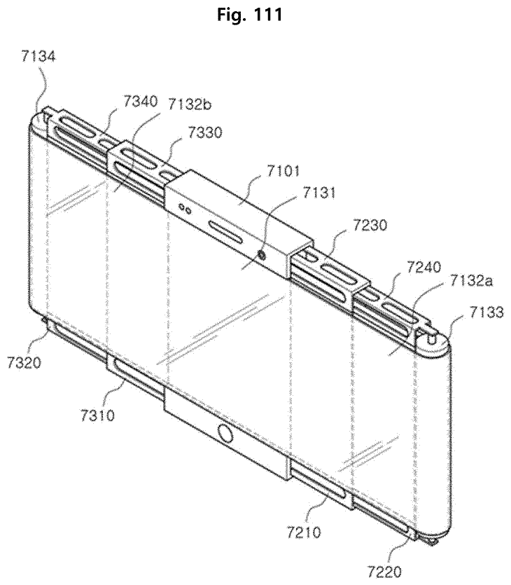

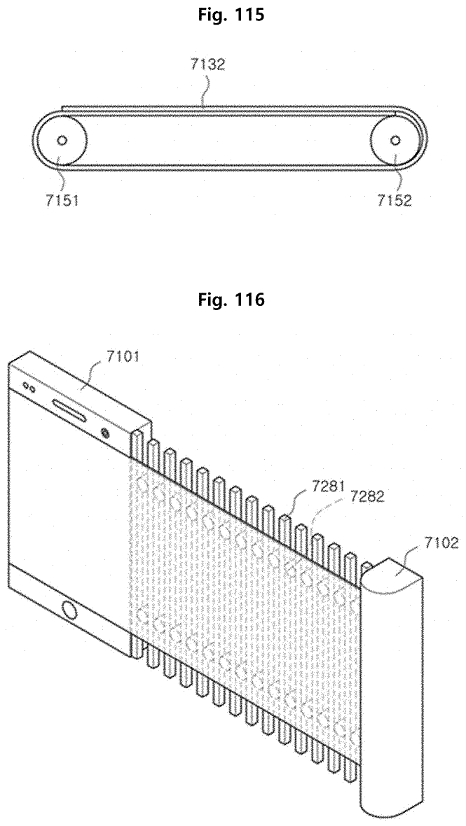

FIGS. 111 and 115 are to show various exemplary embodiments of the present invention.

According to FIGS. 111 and 113, each sliding member slides in and out from the left and right sides of the terminal main body (7101).

In an exemplary embodiment, the first lower sliding member (7210), the second lower sliding member, (7220), the first upper sliding member (7230) and the second upper sliding member (7240) can slide in and out from the right side of the terminal main body (7101) while the lower sliding members (7310, 7320) and the upper sliding members (7330, 7340) can slide in and out from the left side of the terminal main body (7101). In this case, however, each sliding member may be provided with a shorter size than the horizontal length of the sliding members shown in FIG. 97 and the outer sliding members (7240, 7340) may be shorter than the size of the inner sliding members (7230, 7330).

Here, the first display (7131) formed on the front surface of the terminal main body (7101) may extend to the left and right sides and may extend to a second display (7132a) on the right and a second display (7132b) on the left.

Also, on the left and right sliding members, the first (7133) and second rollers (7134) can be formed to allow the extending right and left second displays to gently curve and enter the inside of the terminal main body (7101), and they can slide in and out of the terminal main body (7101).

Meanwhile, inside the terminal main body (7101), rotation means (7151, 7152) are formed for the purpose of fixing a left second display extending from both sides of the first display (7131) with the end of the second display on the right portion, extending the second display so that screen expansion can occur, or using the bending and warping motion so that screen reduction can occur. On the rotation means, some end portions of the second display are bound, and they can be wound or unwound by elasticity generated by the inner spring or others.

Bosses (716, 7162) may be formed to guide the movement so that the second displays are not abruptly bent or warped, and they can form smooth bends.

On the other hand, if the end of the second display is fixed to the terminal main body (7101) or the second display, the flexible, gradually leaves so that screen expansion can occur, or if the second display enters the terminal main body (7101) by the user, rotation means can be formed in a greater variety as the structure to allow smooth bending and warping motion.

For instance, as shown in FIG. 114, a single rotating means (7151) is formed inside the terminal main body (7101), and one end of the second display (7132) is separated from the rotating means (7151) and moves to the outside of the terminal main body, expanding the screen, or it may enter inside, reducing the screen in the form shown in FIG. 114.

Also, as shown in FIG. 115, a pair of rotation means (7151, 7152) is arranged with a small interval, moving both ends of the second display (7132) to the outside of the terminal main body, thereby expanding the screen, or they can move inside in a mutually overlapping form, thereby reducing the screen.

Also, in the previous embodiments, the display may be used exclusively for virtual reality or generally for general display as well, and one or more displays may be provided depending on the purpose and structure.

In addition, in the previous embodiments, the folding virtual reality device may include cell phone function by adding voice communication module to the main body, but may be connected externally via another wired or wireless network without a voice communication module, or it may include only virtual reality of augmented reality functions. Moreover, the folding virtual reality device can store and operate various applications such as communication, messaging, multimedia, maps, and games even if it is not related to the virtual reality function. When operating general applications, it can also modify and operate according to virtual reality or augmented reality.

Hereinafter, various embodiments will be described in detail that can utilize virtual reality device according to the embodiment.

As described above, in the embodiment described below, virtual reality device refers to various forms of devices such as computing device that includes at least one processor and a display, device for viewing virtual reality image displayed on a display, combined device that integrates a computing device and a device for viewing virtual reality image, device for viewing virtual reality image configured to a separate case, with a case that is formed to house a computing device, and a case that includes at least one display.

For example, the methods of utilizing virtual reality device described below are operated by at least one of either an application that runs on at least one sensor included in a computing device or a case that houses a computing device and at least one processor included in a computing device or a case that houses a computing device, or an application that runs on the server connected to the virtual reality device.

In this specification, the virtual reality and the virtual reality images are not limited to the VR (Virtual Reality) and the VR images but may be include virtual reality (VR) and virtual reality image, augmented reality (AR) and augmented reality image, mixed reality (MR) and mixed reality image, and all kinds of virtual images and virtual and reality mixed images.

Furthermore, the virtual device described below or the server connected with the virtual reality device learns and operates using artificial intelligence, and the learning method described below can be applied to each embodiment. However, this is provided as an example, and the learning method applied or applicable to the present embodiment is not limited to what is described below.

Artificial intelligence techniques include machine learning techniques and specifically include deep learning techniques that are widely used among machine learning techniques for image analysis.

Deep learning is defined as a series of machine learning algorithms that attempt to achieve high levels of abstractions (a task that summarizes core content or functions in large amounts of data or complex data) through a combination of several nonlinear transformation techniques. Deep learning can be viewed as a field of machine learning that teaches computers how people think in a large frame.

There is much research in progress on how to represent data in a form that the computer can understand (for example, pixel information is represented by a column vector in the case of an image) and how to apply it to learning (how to make better expression techniques, and how to create models to learn them). As a result of these efforts, various deep learning techniques have been developed. Deep learning techniques include Deep Neural Networks (DNN), Convolutional deep Neural Networks (CNN), Recurrent Neural Networks (RNN), and Deep Belief Networks (DBN).

Deep Neural Networks (DNN) is an artificial neural network (ANN) composed of a plurality of hidden layers between an input layer and an output layer.

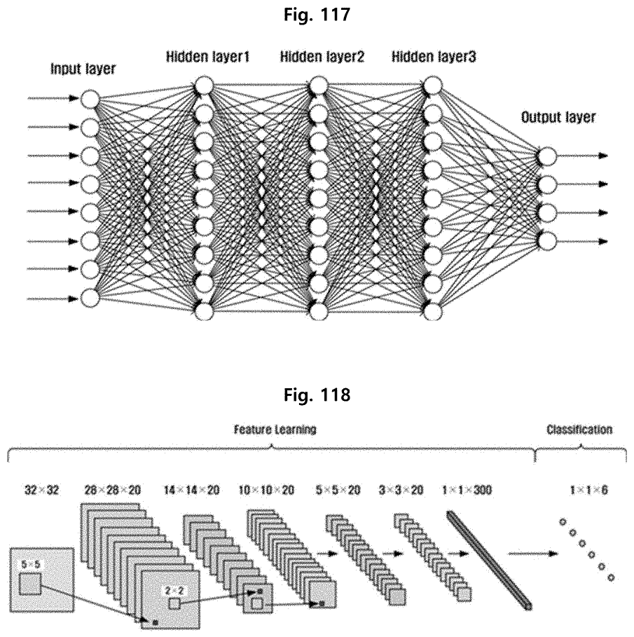

FIG. 117 is a diagram illustrating a structure of a deep neural network. In FIG. 117, each circle represents one perceptron. A perceptron consists of multiple input values, a processor, and a single output value. The processor multiplies the multiple input values by their respective weights. Then, all the input values multiplied by the weights are added. The processor then substitutes the summed value into the activation function to produce one output value. If a specific value is desired as the output value of the activation function, it is possible to modify the weight multiplied by each input value and recalculate the output value using the modified weights. In FIG. 117, each perceptron may use different activation functions. Also, each perceptron receives the outputs from the previous layer as input, and then uses the activation function to obtain the output. The resultant output is passed as the input for the next layer. Following the process described above, several output values can be finally obtained.

Returning to the description of deep running techniques, Convolutional deep Neural Networks (CNN) is a type of multilayer perceptrons designed to use minimal preprocess. The convolutional deep neural network consists of one or multiple convolutional layers and general artificial neural network layers stacked on top and also utilizes additional weights and integrated pooling layers. This structure allows the convolutional deep neural network to fully utilize the input data of two-dimensional structure. In addition, the convolutional deep neural network can be trained through standard back propagation. Convolutional deep neural networks are more easily trained than other feedforward artificial neural network techniques and have the advantage of using fewer parameters.

The convolutional deep neural network extracts features from the input image by alternately performing the convolution and sub-sampling on the input image. FIG. 118 is a diagram illustrating a structure of a convolutional deep neural network. According to FIG. 118, the convolutional deep network includes multiple convolution layers, multiple subsampling layers (Subsampling layer, Lacal pooling layer, Max-Pooling layer), and a fully connected layer.

The convolution layer is a layer that performs a composite product on an input image. The subsampling layer is a layer for extracting a maximum value locally for an input image and mapping it to a two-dimensional image, enlarging a local region, and performing sub-sampling.

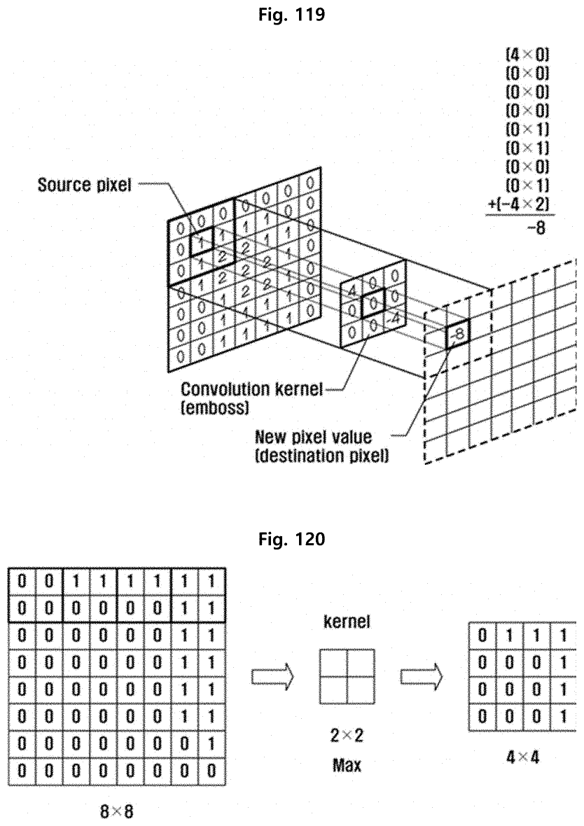

In the convolution layer, information such as the kernel size, the number of kernels to be used (i.e. the number of maps to be generated), and a weight table to be applied for convolution operation are required. For example, consider the case in which the size of the input image is 32×32, the size of the kernel is 5×5, and the number of kernels to be used is 20. In this case, applying a 5×5 kernel to a 32×32 input image makes it impossible to apply a kernel to two pixels at the top, bottom, left, and right of the input image. It is because as shown in FIG. 119, when a kernel is placed on the input image and convolution is performed, the resulting value, ‘−8’, is determined as the number of pixels corresponding to the center element of the pixels of the input image included in the kernel. Therefore, if a 5×5 kernel is applied to a 32×32 input image and convolution is performed, a 28×28 map is generated. Since it was previously assumed that the number of kernels to be used is 20 in total, a total of 28×28 maps are generated in the first convolution layer (see “C1-layer” in FIG. 7).

In the subsampling layer, information on the size of the kernel to be sub-sampled and information on whether to select the maximum value or the minimum value among the values in the kernel region are required. FIG. 120 is a diagram illustrating a sub-sampling process. In FIG. 120, it can be seen that the size of the kernel to be sub-sampled is set to 2×2, and the maximum value among the values included in the kernel area is set to be selected. By applying a 2×2 kernel to an 8×8 input image, a 4×4 output image can be obtained. That is, an output image whose size is reduced to ½ of the input image can be obtained.

Returning to the description of the deep learning techniques, the Recurrent Neural Network (RNN) refers to a neural network in which the connections between the units forming an artificial neural network constitute a directed cycle. Recurrent neural networks can utilize memory inside a neural network to process arbitrary inputs, unlike feedforward neural networks.

Deep Belief Networks (DBN) is a generative graphical model used in machine learning. In deep learning, it is a deep neural network composed of multiple layers of latent variables. There is a connection between layers, but there is no connection between units in the layer.

The deep belief networks can be used for pre-learning due to the nature of generation model, and it can learn the initial weight through pre-learning and then fine-tune the weights through back propagation or other discrimination algorithms. This characteristic is very useful when the training data is small, because the smaller the training data, the more the initial value of the weight affects the resulting model. The pre-learned weight initial value is closer to the optimum weight than the arbitrarily set initial weight value, which enables the performance and speed improvement of the fine-tuning step.

In one embodiment, the virtual reality device may be used to control an external device including at least one power device.

For example, a virtual reality device can be used to control robots (including all terrestrial, underwater, and aerial moving robots), RC cars, drones, and others. The external device including robots, RC cars, and drones is equipped with at least one camera, and the user can view the image filmed by the external device using the virtual reality device and transmit the control command to the external device.

The method through which a virtual reality device acquires a control command from its user and transmits the command to an external device will be described in detail below, and all possible means other than those described below can be used.

As an example, a user may use the virtual reality device to steer a drone, and further control can be performed using additional parts provided in the drone. For example, the drone can be equipped with additional parts for spraying pesticides, and the user can control the drone, determine the location to spray the pesticides based on the image received from the drone, and transmit the pesticide-spraying command to the drone to spray pesticides.

There are various ways in which the virtual reality device acquires commands for control from the user. The following embodiments may be applied, for example.

For example, a virtual reality device may recognize the user's finger movement or the shape of a finger to acquire commands for controlling an external device. In addition, the virtual reality device can recognize the user's voice, recognize the user's pupil movement using the camera equipped in the virtual reality device, or acquire the user's input by recognizing the head movement of the user.

In one embodiment, the virtual reality device can further recognize the user's fingernail in finger recognition. For example, a virtual reality device may recognize a user's fingernail location based on at least one of either the user's nail shape or color features, recognize at least one fingernail from the image being filmed, and obtain user input based on the location and movement of each.

When the virtual reality device recognizes the location of the user's fingernail, it then traces the movement of the user's fingernail. Therefore, even when the user's hand is turned or folded so that the finger nail is not visible, the location of the user's fingernail can be estimated based on the previous location and movement. Therefore, the virtual reality device can obtain the user input according to the movement of the user's fingernail.

In one embodiment, the virtual reality device may initially ask the user to show at least one fingernail of either a hand or both hands. For example, the user wears the virtual reality device and opens both hands before the eyes so that the back sides of the hands are filmed. Then, the virtual reality device acquires the characteristics of the user's hands and fingernail shape and starts tracking the location of the fingernails so that the location of each fingernail of the user can be estimated regardless of what shape the user's hands are in.

In addition, the virtual reality device can acquire user input by recognizing the location and movement of various objects in addition to fingers, hands, or fingernails.

For example, a virtual reality device can be used to recognize a specific object, such as the user's ring, wristwatch, or fist and obtain user input.

In one embodiment, the virtual reality device may determine the objects that are utilized to acquire the commands according to the user's choice. For example, a virtual reality device may track the location and movement of a user-specified object within the image and acquire user input.

In another embodiment, the virtual reality device may automatically select an object that has a trackable feature on the user's body or the objects that the user is wearing, track the location and movement of the selected object, and acquire user input. The virtual reality device may transmit information about the selected object to the user, and may induce the user to consciously perform input using the specific object.

In one embodiment, the virtual reality device may acquire the user's brain waves, acquire user input using the user's brain waves, and control the external device.

The above-described method of acquiring input according to the user's movement can be used to provide various kinds of simulations. For example, the virtual reality device can provide the user with practical experience such as virtual driving, assembling, and production based on the virtual reality image and the input according to the user's movement. For example, when the fingernail recognition is used, it is possible to determine the movement of the user's hands with a small load, it is possible to easily provide a variety of practical experiences to the user.

Also, the virtual reality device can use the user's body parts that are being filmed to automatically estimate the shape, location, and state of the remaining body of the user that is not outside the camera angle.

In one embodiment, the virtual reality device additionally includes at least one camera to film at least a portion of the user's body. For example, the virtual reality device may additionally include at least one camera directed downward on the floor surface so that at least part of the user's body is filmed while the user wears the virtual reality device.

In one embodiment, the virtual reality device may request the user to scan the user's body during initial use. For example, when a user presents his or her body to a camera equipped in the virtual reality device, the virtual reality device scans the user's body to acquire information about the user's body. For example, a virtual reality device acquires a user's height and body shape.

The virtual reality device uses the acquired information of the user's body and at least one part of the user's body filmed using at least one camera equipped in the virtual reality device to automatically estimate the rest of the body shape, location, and state of the user's body.

Therefore, the virtual reality device can display the entire body of the user that is not actually filmed as an image in the third-person point-of-view. In addition, the virtual reality device can provide more various virtual experiences to the user based on the estimated body state of the user. For example, when a user plays a fighting game using a virtual reality device, the interaction with the user's body not displayed in the camera angle can be calculated and reflected in the game.

The virtual reality device estimates the entire body of the user that is not actually being filmed and can be used to guide the user's posture in weight training, yoga and other sports based on the estimated figure of the entire body of the user. For example, a virtual reality image may display a certain posture, and the user may be evaluated when the user moves according to the displayed posture, and the evaluation result may be presented.

Furthermore, in recognizing the user's voice, the virtual reality device can enhance the recognition rate by learning different voices and pronunciation characteristics of each person. For example, even when someone uses a dialect or when someone incorrectly knows a certain word or habitually mis-pronounces, a database corresponding to the language habit of each user is additionally acquired to the existing database and can be used to accurately judge what the user is trying to say.

Therefore, the virtual reality device learns the language habits of the user, like how there are slang used between close friends or family, so that even if the user does not care about the virtual reality device and commands in the user's average daily language, it can accurately determine what the user means.

In addition, the virtual reality device can automatically acquire a voice or image in the user's surroundings by using a feature that the user can carry. For example, a virtual reality device can record the surrounding voice around a user, or take videos or pictures of the surroundings.

The virtual reality device classifies the acquired voice or image and uses it to record the daily life of the user.

For example, just as a person's brain fragmentarily remembers important events during the day and forgets unnecessary or passing memories, the device may classify information that are determined to be significant by certain criteria among acquired information such as a space that the user spent a long time in, the voice of a person whom the user talked to for a long time, or an object that the user looked at for a long time, and store that information for a longer period of time than information that is determined to be relatively insignificant. Information that is determined to be not significant may be deleted immediately.

In addition, the virtual reality device can be equipped with a location measuring means such as a GPS to perform a lifelogging function of storing the user's movement and important records according to each location for one day or a specific period.

In addition, the virtual reality device can organize information based on another criteria. For example, in the case of frequently-met people (judged based on location or voice characteristics, image characteristics, etc.), most of the conversations will be daily conversations, so the percentage of information to be stored can be decreased. For people that are met infrequently or for the first time, it can be judged that the probability of information exchange is high, as in a business meeting, so the percentage of information to be stored can be increased.

As described above, the criteria by which the virtual reality device classifies, stores, and deletes information can be variously set, and are not limited to the above-described examples.

In one embodiment, the virtual reality device can classify the types of other users registered or not registered with the phonebook using the classification method described above. For example, the types of users that can be classified include, but are not limited to, family members, friends, co-workers, and business partners.

The virtual reality device can set different telephone ringtones or text message notification sound according to the classified type, without additional settings, so that the user can easily hear the melody of ringtone or the test message notification sound and easily judge the type of person that has contacted.

In addition, the virtual reality device can search recorded contents based on clues provided by the user. For example, since the memory of a person is often fragmented, if a person provides little recalled information, the virtual reality device can perform a search based on the provided information and assist the user's memory.

In one embodiment, the virtual reality device may be utilized in conjunction with a drone.

For example, a small drone can be configured to communicate with a virtual reality device and continue to follow above the user's head that is wearing the virtual reality device and film the user.

As a result, the user can record and confirm his/her location, movement, and daily life in the third-person point-of-view as well as in first-person. The user can change the distance or direction of the third-person point-of-view by controlling the location or height of the drone.

For example, when the user looks at himself/herself above his/her own head in the third-person point-of-view, he/she can control his/her own motion with the sense of being the main character in a game having the third-person point-of-view. Using this, various entertainment services can be provided by combining with survival game, augmented reality, mixed reality game, and others.

In addition, this can be utilized for athletes to observe and correct their movement or posture real-time by observing themselves in the third-person point-of-view.

In one embodiment, the virtual reality device may generate an image at a different viewpoint than the viewpoint of the image that is actually filmed. For example, a virtual reality device can generate an image that appears to be viewed from a higher angle from the image that is viewed at the front, and display the generated image as a virtual reality image. In this process, the virtual reality device can digitize the image and render the image viewed from another angle.

It is preferable that the drones used in the above-described embodiment are small-sized around the size of a table tennis ball. However, it is needless to say that the size of the drones used in the above-described embodiments is not limited thereto.

In addition, the drones used in the above-described embodiments may include a protective case for preventing breakage or user injury due to a fall. For example, the protective case can house a drone and can be formed as a sphere consisting of a mesh allowing air flow.

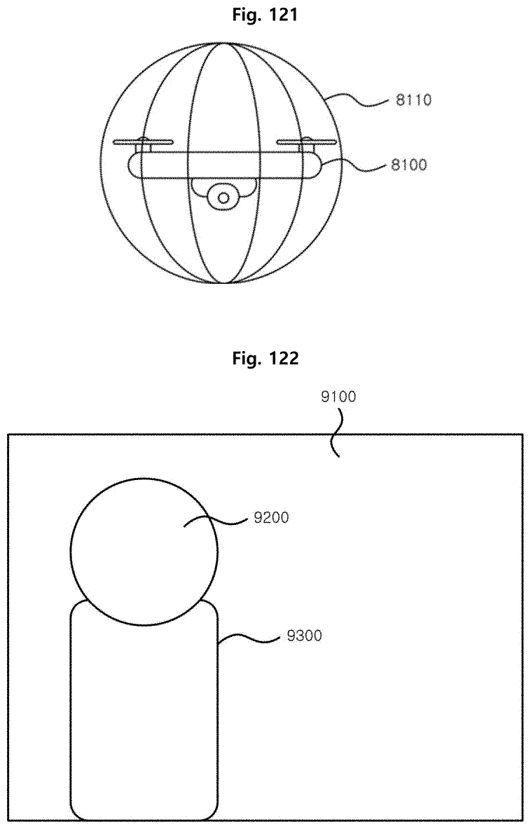

For example, in FIG. 121, a drone (8100) and the drone protective case (8110) housing the drone (8100) is shown. However, this is provided as an example, and the shapes of the drones (8100) and the protective case (8110) are not limited thereto.

In one embodiment, the drone (8100) or the protective case (8110) housing the drone (8100) includes at least one light source for easily locating the drone in the dark.

In one embodiment, the virtual reality device can interconnect with a drone in another location and present the image filmed on the interconnected drone as a virtual reality image. For example, a virtual reality device is linked to a drone in an oversees tourist spot, and the drone moves according to the movement speed and direction of the virtual reality device and transmits the image of the tourist spot to the virtual reality device. The virtual reality device can display the image of the received tourist spot as a virtual reality image. To do this, a drone dealer to rent a drone that can interconnect with the virtual reality device at a tourist spot may be required. The drone dealer can receive a drone renting request through a network and can lend the drone when the settlement is completed.

It should also be noted that the drone shown in the embodiment includes automatic navigation function that allows it to avoid or divert to another direction when determined that there is another drone or an obstacle within a small distance from the drone. For example, the drone can fly while maintaining a state in which no other object exists within a small safety distance.

In addition, the virtual reality device can perform a transaction function by communicating with another virtual reality device. For example, a virtual reality device can exchange information related to virtual currency or card settlement using near-field or network communication with other virtual reality devices and perform transaction functions such as exchanging virtual currency or performing card settlements.

In the embodiment, virtual currency is understood as a concept that includes all forms of information that can represent a designated promised value as a trading means, such as electronic currency or points.

Also, the virtual reality device can be used to pay for public transportation or taxi fare using the transaction function or can perform a payment function for the POS device provided in stores.

When the user performs settlement using the virtual reality device, the virtual reality device stores the settlement history and automatically creates a ledger based on the stored settlement history. In addition, the virtual reality device can provide users with advice on consumption patterns, monetary management, and investment techniques.

In one embodiment, the virtual reality device may provide payment agency services. For example, if a child purchases an item on a parent's errand, the parent's virtual reality device can make the payment through the child's virtual reality device. For example, the virtual reality device of the parent may transmit the money or card information to the child's virtual reality device to make the payment, or the payment information of the store may be transmitted to the virtual reality device of the parent through the virtual reality device of the child so that the virtual reality device of the parent may perform settlement using the received payment information.

In addition, the virtual reality device according to the embodiment can also perform living-convenience functions. For example, a virtual reality device films a part of a house or a room, and when it judges that there is a part that is dirty or requires cleaning in the filmed image, it can communicate with the robot cleaner, which can be controlled to automatically clean the part that is dirty or requires cleaning. As in the above-described embodiment, the user can check the images filmed by the robot cleaner using the virtual reality device and transmit control commands to the robot cleaner which is filmed in the virtual reality device or seen with their own eyes.

In one embodiment, the virtual reality device can automatically determine a dirty part by comparing the collected image with the image of the house in a clean state.

Moreover, the virtual reality device can determine the location of the obstacle that has not been previously there based on the previously filmed home images or the map of the house saved in the robot cleaner. The virtual reality device can transmit the location, size, and shape of a new obstacle to the robot cleaner, so that the robot cleaner can avoid it while cleaning.

In addition, the user can specify the location of the obstacle by using the virtual reality device or set a virtual obstacle or a limited space in order to control the robot cleaner to avoid a specific location.

In addition, the virtual reality device can detect the sound of a pest such as a mosquito or a fly and control a small drone or a robot to catch the pest. The drone can attack pests by using electric shocks and display the images filmed by the camera mounted on the drones to the virtual reality device, so that the user can feel the experience of tracking and attacking pests by riding the drone.

In one embodiment, the virtual reality device can control a small drone or a robot to kill or trap pests. For example, a small drone or a robot may be equipped with additional devices such as a mesh to trap the pests.

In one embodiment, the virtual reality device can determine the location of pests and automatically attack or trap them by controlling a small drone or a robot.

In one embodiment, a small drone or a robot may itself determine the location of the pests and automatically attack or trap the pests.

In addition, the virtual reality device can detect the pollution degree of the surrounding air and guide the user to a clean area with relatively low degree of air pollution. Also, the virtual reality device can visualize the location of the detected contaminants or the components in the air to provide to the user.

In addition, besides air pollution, the virtual reality device can acquire information on the ozone concentration in the air, the current state of light (e.g. ultraviolet ray concentration, etc.), and visualize the acquired information through virtual reality image.

In addition, the virtual reality device can communicate with the air cleaner to control the operation of the air cleaner according to the degree of pollution of the surrounding air. In addition, the air cleaner is equipped with a power unit, so the virtual reality device can move the air cleaner to the place where contaminated air is present, and control the operation of the air cleaner to purify the contaminated air.

In addition, it can detect risk factors contained in the air such as carcinogenic substances or atopic substances and control the ventilator, air cleaner, air conditioner, humidifier, or dehumidifier to purify the air and guide the user to a clean area.

In one embodiment, the virtual reality device may be used to provide a dating service function. For example, if a user stores information about his/her ideal type, the virtual reality device acquires the location of another user close to the user's ideal type through communication with another virtual reality device or analysis of the acquired image and share that information about the acquired location to the user. In addition, the virtual reality device can guide the user to the acquired location.

In addition, the virtual reality device presents one or more candidate groups. Candidate groups include information about different users and the location of each user. The virtual reality device extracts and presents one or more candidates from other users located within a designated distance.

The virtual reality device can guide the user to the location of the other person selected by the user.

Also, the virtual reality device can select a pair of users that match each other's types by a designated reference value or higher via communication with different virtual reality devices and transmit information about the other person to each user.

In one embodiment, each user can use the above-described dating service by entering information about his/her ideal type and his/her own personal information. The virtual reality device or server can acquire candidate groups that fit well with the user or acquire optimal user based on the entered personal information and the information about the ideal type of each user. The virtual reality device or server can list up the obtained candidate groups in the order of goodness of fit and provide to the user.

In addition, each user can communicate with each other using the virtual reality device, and exchange intentions for meeting.

In addition, the virtual reality device may display the actual appearance of the other user or the avatar character of the other user by using virtual reality image, and the user may decide whether to meet the other user by using virtual reality image or talk with the other user displayed on the virtual reality image.

Using the above-described method, the virtual reality device can acquire information about whether Koreans are in a foreign country and allows Korean users to share their locations between their virtual reality devices.

Likewise, the virtual reality device acquires the location of people wearing ankle monitors, such as sex offenders, and can display the location of ankle monitor bearers when determined that one is in the vicinity.

In one embodiment, the virtual reality device is associated with a satellite or other observation device to acquire the location of fish or prey (animal) and display the acquired information of the virtual reality device so that the user can be informed of the location of the fish or prey during navigation, hunting, or fishing.

In one embodiment, the virtual reality device may determine the type of object recognized based on the form of object being recognized or the pattern of motion. For example, a virtual reality device can determine a fish species included in a fish group aquatic life group that includes fish, or the species of the game (animal) to provide the information to the user.

In addition, the virtual reality device can acquire and provide information about the location of nearby infected persons, the distance from the infected person, and the density of the infected persons according to the area by acquiring the information of the related organizations when legal communicable diseases break out. In addition, the virtual reality device can identify the locations of hospitals and the saturation of each hospital according to the type of the infectious disease, display it using a map, or automatically brief the situation to the user.

Likewise, the virtual reality device can acquire and provide information about a person who owns a dangerous weapon or information about the type of weapon, along with information about the location. For example, a virtual reality device can work with an external system to acquire terror information and provide information about dangerous weapons in the vicinity. This information is preferably provided by the governmental system, but in some cases, the virtual reality device may scan the dangerous weapons in the surroundings using at least one camera or sensor and provide information according to the scan result.

In addition, the virtual reality device can film a user's eye using the equipped camera and analyze the eye image of the user to determine the user's eye fatigue. The virtual reality device can judge the user's eye movement, capillaries, redness, etc. based on the user's eye image and determine the user's eye fatigue accordingly.

The virtual reality device can change the screen to black-and-white or transmit an abnormal signal to the user such as blinking the screen according to the eye fatigue of the user. Alternatively, the virtual reality device can change the display method in a manner that reduces the fatigue to the eye according to the user's eye fatigue.

In addition, when the user's eyes are closed over a certain period of time, the virtual reality device can judge that the user is asleep and automatically turn off the screen. Also, if the eyes of the user who was walking are closed for more than a certain period of time, it can be recognized as an emergency and automatically report to 119. Moreover, the virtual reality device can detect the user's health condition such as pulse or respiratory state in real time, and automatically report to 119 when judged as an emergency situation.

In one embodiment, the virtual reality device can determine a person's health condition using at least one camera or sensor.

For example, the virtual reality device can collect and analyze information including fingernails, toenails, skin color, pupil, breathing, and pulse to infer disease or health conditions and provide appropriate advice.

In addition, the virtual reality device can sense the user's breath and judge inflammation or other diseases of the body and the health condition of the user. When the virtual reality device periodically or irregularly measures the user's breath for a short period of time or longer, various health information such as changes in the health condition of the user, aging, brushing teeth, number of brushing teeth, and the frequency of brushing teeth can be obtained.

In one embodiment, the virtual reality device can determine whether the user is smoking or drinking by using at least one sensor capable of detecting odors as described above.

In one embodiment, the virtual reality device may notify the surrounding people when the user collapses or in an emergency by light or sound, apart from the 119 report.

In one embodiment, the virtual reality device recognizes the user's eyes closing and can wake up the user. For example, if the user's eyes keep closing while driving, the virtual reality device can wake the user using at least one of light, sound, and vibration.

In one embodiment, the virtual reality device determines the eye movement of the user using at least one camera or sensor even when the user is not wearing the virtual reality device, and it can recognize the closing and blinking pattern of the user's eyes so that when it is determined that the user is sleeping, it can wake up the user.

In one embodiment, the virtual reality device is interlocked with a motor vehicle to perform autonomous driving, stop the vehicle, or perform a control operation of moving the vehicle to the shoulder by autonomous driving and stopping when it is determined that the user is drowsy or asleep.

In addition, the virtual reality device may perform an alarm function to awaken a user that is asleep in the above-described manner at a predetermined time.

In addition, the virtual reality device recognizes the user's eye movements and can learn eyelid movements, eye movements and pupil movements when the user is sleepy or tired. The virtual reality device can determine the state of the user according to the movement of at least one of the movements of the user's eyelids, eyeballs, and pupils based on the learned results.

For example, the virtual reality device detects blinking of the user's eyes and determines whether the user is tired or whether the user is drowsy or asleep, to perform sleep-driving prevention function such as providing a notification.

In addition, the virtual reality device may be equipped at least one odor generator to provide the user with an odor in cooperation with the virtual reality image, or to generate a perfume scent upon user's request. The smell provided to the user can include coffee aroma or tobacco smell. In some cases, it can eject electronic cigarette liquid containing liquefied nicotine so that the user can conveniently smoke electronic cigarettes. In the present embodiment, the kind of smell that can be generated by the odor generator is unlimited.

Also, the virtual reality device can communicate with other virtual reality device to determine their locations. It is possible for a virtual reality device to detect the malfunction of other virtual reality devices. For example, if a particular virtual reality device is constantly following in a certain distance, it may inform the user about the other virtual reality device, and send a warning to the other virtual reality device or send information about the other virtual reality device or rescue signals to an external server (such as the police) since there is a danger of stalking.

In addition, the virtual reality device can be interconnected with one or more cameras installed in the house and the IoT system, to view the house filmed using the camera and control the household appliances in the virtual reality screen. For example, by operating a control panel of the air conditioner in the virtual reality screen, the air conditioner at home can be actually controlled. The camera installed in the house can be moved or rotated by the user's pupil or head movement so that the user can naturally watch or move in the house in the virtual reality.

In addition, when a moving object that is not previously set is filmed or detected, the user's virtual reality device can receive information and display the inside of the house.

In one embodiment, the virtual reality device may interconnect with the IoT system to measure the power consumption of each appliance in real time. The virtual reality device can display the power consumption of each appliance in real time on the virtual reality image. In one embodiment, the virtual reality device may display real-time power consumption, cumulative power consumption, real-time electricity charge, and cumulative electricity charge of each appliance.

In addition, the virtual reality device can be equipped with a microscope module, capable of optical or digital zooming, via hardware or software, and can display a microscope image on the virtual reality device.

When a virtual reality device is equipped with a microscope module, it can observe and determine things that are incapable with an average person's eyes, such as dental cavities, dandruff, hair loss, skin disease, residual pesticide of agricultural products, radioactivity, and substance analysis.

In addition, it can be equipped with a module capable of night vision function via hardware or software, and night vision images can be displayed on the virtual reality device. For example, the virtual reality device is further equipped with an infrared camera module to display the infrared ray image on the virtual reality device.

In addition, the virtual reality device can be used to detect surrounding temperature using an infrared camera module or another sensor and to provide notification when an object with a temperature equal to or higher than a predetermined temperature is detected in order to prevent a fire. Also, it can be used to determine the temperature of the place the user is looking at by using the infrared camera and to determine the state of the fire in places that cannot be seen with the naked eye in case of fire.

For example, when a person evacuating from a fire or a rescuing firefighter wears a virtual reality device according to the present embodiment, it is possible to judge the location of the fire, avoid or extinguish it when it is not visible to the naked eye. It is also possible to know the temperature beyond a door or the hallway, which allows prevention of dangerous situations such as back drafts.

In addition, the virtual reality device can display the surroundings or the road by virtual reality using pre-saved images or the infrared image even when the surroundings are dark or smoky and can guide the user to a specific location or exit.

In addition, the virtual reality device can measure the body temperature of surrounding people using an infrared image or a sensor and can judge emotional changes or health condition of the wearer or those in the wearer's sight.

A person's emotional changes can include, but are not limited to, joy, anger, calmness, indifference, curiosity and joy. The virtual reality device recognizes the facial expressions of other users according to the image analysis obtained in the infrared ray as well as the visible ray region and can judge the emotional state and emotion change of other users based on the recognized facial expression.

Also, the virtual reality device can detect the internal temperature of the house using a sensor installed in the house, and if there is a fire hazard, display a filmed image of the current situation so that the user can judge the situation.

In one embodiment, the virtual reality device may assign a particular theme or skin to a surrounding image. For example, a virtual reality device can display an image of ghosts and buildings in ruins if it is given a horror concept theme on an ordinary street image. Moreover, it is possible to display a mixed image that can make a barren path appear like a flowery road. A mixed image of various skins of different themes can be provided to the user by combining actual images with skins of various concepts according to the user's selection. Also, by adding a gaming function, the user can play a game using game elements displayed on an image filming actual space.

In addition, the virtual reality device can digitize the filmed actual images. For example, a virtual reality device can render and transform an actual image into a digital (e.g., 3D) image, and modify or move the objects contained in the image according to the user's control.

For example, a virtual reality can render and digitize a filmed image of a street viewed by a user and show a virtual reality image in which the user can change the location of an electric pole, break buildings, and lift buildings to build blocks according to the user's movements.

In one embodiment, a virtual reality device may zoom in on a selected object when the user selects an object located far away from the user in the digitized image.

In addition, when a user makes a gesture of holding an object located far away from the user, the virtual reality device may ignore the perspective and allow the object to be caught by the user's hand, and the captured object may move to the user's hand location and displayed in a large scale.

In addition, when a virtual reality device films a specific object, and a specific object is selected by the user, the selected object can be stored in the virtual reality device and may be added to another virtual reality space or a virtual reality image.

For example, when a virtual reality device films a tree and a user selects the filmed tree, the information about the filmed tree is digitized and stored in the virtual reality device. The image of the tree that has been digitized by using the information about a tree saved in another virtual reality space can be rendered and added.

Likewise, the virtual reality device can acquire information filmed in advance for one or more objects and backgrounds, and combine the acquired information to generate a virtual reality image. The virtual reality device determines the direction and brightness of the light, the position and length of the shadow, the concentration of the overall color, and more based on the actual or virtual date, time, and weather in which the virtual reality image is displayed. Based on the determined information, virtual reality images can be generated.

In one embodiment, the virtual reality device can display the generated virtual reality image by changing the weather, time, and date on the filmed image by applying the above-described analysis method to the image filmed using the camera.

In addition, the virtual reality device can be used to adjust the position of furniture in the house or simulate the interior of the house within the virtual reality image using image digitization function.

In addition, the virtual reality device can detect the gas using the gas sensor installed in the house or equipped on the virtual reality device and can display the location or shape of the detected gas on the virtual reality device.

In addition, when the virtual reality device acquires an image including a signboard of a restaurant, it is possible to check the number of available seats and location of the restaurant and display the menu by interconnecting with the system of the restaurant. The user can make a reservation of the restaurant using the virtual reality device or order the menu in advance. The virtual reality device can transmit information about the current location to the restaurant's system so that the food is cooked according to the arrival time of the user.

In one embodiment, the virtual reality device obtains information about the store that the user is searching for and acquires the location of the store to create and display a virtual reality store in which the particular store appears large or brightly lit, or only shows that store by eliminating images of other stores. For example, when a user searches for a karaoke, the virtual reality device can display a virtual reality image that allows only the karaoke to be seen or emphasized on the street. Also, it is possible to guide the directions to each karaoke or the karaoke selected by the user.

In addition, besides searching for a specific store, the virtual reality device acquires and displays a list of one or more stores by using a filter such as the type of store and price range that the user is looking for according to user input. It can also display the internal structure as a virtual reality, reserve the selected store according to user input, or guide the user to the selected store.

In addition, the virtual reality device can determine how many virtual reality device users are located in which surrounding stores and provide the determination result.

In one embodiment, the virtual reality device can display not only the internal structure of the restaurant, but also images in which one or more menus are laid out on each table. The user can order the food by selecting the cooked menu displayed on the virtual reality image. Accordingly, the user can select the dish using the actual cooked appearance, order dishes even if they do not know the name by using the image, and it will be much easier for foreigners to choose and order food.

In one embodiment, the virtual reality device can display the interior of various objects on a virtual reality image.

For example, a virtual reality device acquires the internal structure for a variety of objects that have an internal structure such as model house, motor vehicle, airplane, house, or household appliances. Using the virtual reality device, the acquired image can be displayed as a virtual reality image.

For example, when the outside of the object is filmed using at least one camera equipped on the virtual reality device, or when a specific object is selected by the user of the virtual reality device, the virtual reality device can acquire internal structure of the selected object by network and display the acquired internal structure by using virtual reality image.

In one embodiment, the virtual reality device is capable of communicating with a motor vehicle's electronic system. The motor vehicle communicates with the virtual reality device using the electronic system, determines the location of the virtual reality device even when the virtual reality device and its user cannot be seen. It also displays the location of the virtual reality device on the display provided on the front window to prevent accidents in dark places. For example, a virtual reality device displays the location of the virtual reality device on the front window as a luminous human figure in a specific color using the motor vehicle's electronic system, allowing the driver to perceive that there is a person in that specific location in order to prevent accidents.

Furthermore, when applied to connected cars, the virtual reality device and the connected car can communicate with each other to prevent accidents.

Also, the virtual reality device can be used to communicate with an external server using a location confirmation module, and to call a taxi to the location of the virtual reality device.

In addition, the virtual reality device can communicate with an external server managing the road system to obtain information about the road ahead when walking or driving. For example, information about the road ahead may include information on construction and bypass roads, accident information, ice, and falls.

In addition, the virtual reality device can communicate with a small chip capable of near field or network communication. A small chip can be attached to an object, and the virtual reality device can communicate with the small chip to determine the location of the chip. Virtual reality device visualizes and displays the location of the small chip on a virtual reality device. For example, if a bag with a small chip is in the closet, the virtual reality device may display a flashing image of the small chip over the closet door, allowing the user to confirm that the bag is in the closet. In one embodiment, the virtual reality device may store information about each small chip in advance. For example, the ID of each chip and the information about the objects attached to each chip may be stored. So, if the user wants to find a specific item, the location of the corresponding chip may be provided to the user in various ways. For example, a virtual reality device can provide a user with a virtual reality image, as if the user looking through a wall or a door to look for the item he/she is searching for.

In one embodiment, a small chip may also be used to identify a child's location by being mounted on a child's shoe, clothing, body, or others.

In addition, the virtual reality device can provide notifications to the user when the distance between a specific small chip and the virtual reality device becomes greater than a predetermined reference value.

In one embodiment, the virtual reality device can be used to determine a user's movement using at least one sensor and to measure and provide pedometer function or user's movement distance, work rate, and others.

In addition, the virtual reality device can automatically specify an item that matches the user's taste by using user input or user information or automatically purchase within a preset price range. The process of searching for, selecting, and paying for goods may be performed entirely automatically, or request for at least one confirmation or review by the user in the entire process.

Likewise, the virtual reality device can automatically book a restaurant or accommodations, such as a hotel, according to the user's request (including gesture, voice input, and request based on input using at least one input device). That is, the virtual reality device can automatically book accommodations or a restaurant and make the payment using at least one of the user's taste, the user's location, or the user's request.

In addition, the virtual reality device can perform display and guidance functions according to the above-described embodiment for not only stores but all objects capable of acquiring locations such as bathroom and trashcan.

In one embodiment, the virtual reality device can provide directions service by using a virtual reality image that composes a real image and a route guidance image for foreigners unfamiliar with Korean or elderly and children that are not used to electronic devices. The user can move to a destination by moving along a virtual path or arrow displayed on the virtual reality image.

In one embodiment, the virtual reality device may provide virtual shopping services.

For example, when a movable camera, a microphone, and a speaker are installed in a specific store, and a user enters the store virtually, the camera, the microphone, and the speaker move in accordance with the user's movement in the virtual reality space, filming surrounding images and providing to the virtual reality device, and allowing the user to communicate with the salesman using the microphone and the speaker.

In addition, when the salesman is also wearing the virtual reality device, the user and the salesman can see and communicate with each other in the virtual reality space.

In addition, the salesman can immediately process shipping of the goods purchased by the user.

For example, delivery may be performed by mail or directly using a drone.

When a purchased product is shipped, a small chip is attached to the product, and the virtual reality device can acquire the location of the product in real time. The virtual reality device calculates the arrival time of the product and can transmit information about where to receive the product or where to request storage.

In one embodiment, if a user enters a category of a desired store via voice or another input method, the virtual reality device displays the corresponding virtual store. A virtual store may be a virtual store of an actual store or a virtual store of an online shopping mall.

The virtual reality device displays virtual stores corresponding to the input categories, and selects at least one virtual store among multiple virtual stores based on the price, rating, and other information to recommend to the user, or it can immediately display the selected virtual store.

Likewise, the virtual reality device can use the user's voice input to automatically launch a web page corresponding to the user's voice input or execute an application corresponding to the user's voice input. In addition, the virtual reality device can search the Internet for a keyword corresponding to the user's voice input and provide search results. Moreover, the virtual reality device can automatically call or send a text message to a contact corresponding to the user's voice input.

In addition, when a user looks at a specific product in a virtual store, information about the product can be displayed on the virtual reality image. Information about the product may include issues relevant to the product or any abnormalities in the product. For example, when a user looks at an egg, the virtual reality device can display information that should be considered or cautioned in purchasing eggs, such as pesticide eggs or avian influenza, on a virtual reality image.

In addition, for products with a history of defective products or recently produce defects, a scan of the product's case or package will allow the virtual reality device to provide information on the defective history of the product.

Likewise, the virtual reality image can film a product that another user has or wears and can search and acquire information about the filmed product. For example, a virtual reality image can acquire information about the price, brand, authenticity, and place of purchase of a product that another user has or wears.

In addition, when a user purchases or orders food at a virtual store or looks at a specific food, the virtual reality device acquires the ingredients of the food and displays information on whether or not the user should consume the food based on previously input information such as physical constitution, information on health and disease, and allergy of the user. For example, if the virtual reality device adds the total calories consumed on that day and the calories of a particular food, it can display information that it exceeds the recommended daily calories.

The embodiments described above regarding methods for providing information about a product can also be performed using a mobile terminal that includes at least one camera that is not a virtual reality device. For example, when a user directs a camera of a mobile terminal to a specific product, the mobile terminal can acquire and provide information about the product included in the image acquired using the camera.

In addition, the virtual reality device can judge whether the user orders food to eat at the actual store or to go and transmit order information to the store accordingly.

In addition, the virtual reality device stores history information about products purchased by the user and stores, automatically manages discount coupons or savings coupons, so when the user repurchases a specific product or revisits the store, relevant information can be provided.

In addition, the virtual reality device stores and manages the user's gates, irises, and other personal information and uses the information of the user stored when the user visits the actual store or virtual store so that it can register the user to the store automatically or with the user's consent.

In addition, the virtual reality device can perform an artificial intelligence consultant function that provides shopping advice to the user by combining the taste of the user previously stored and the previously entered consulting information and user's information (such as body size).

For example, when a user purchases clothes, bags, shoes, or accessories, the virtual reality device combines previously entered beauty consultant information with information about the user's taste or clothes already owned by the user. Therefore, the virtual reality device can perform a beauty consultant function that can provide artificial intelligence advice on shopping to the user.

Also, the virtual reality device analyzes the inventory of household goods owned by the user and the consumption pattern of the user, calculates the consumption cycle of the household goods, based on which it can automatically order the household goods or provide purchase notifications to the user.

In one embodiment, when a virtual reality device films an image of a particular product, it may display a virtual store or a web site where the product corresponding to the filmed image may be purchased.

In addition, the salesman can add a virtual structure to a store using virtual reality device. For example, if a virtual frame is added to an empty wall, the virtual reality device of the user visiting the store via a virtual reality device will display the wall with the frame added.

In one embodiment, the virtual structure can be utilized in the interior as well. For example, a user can add a virtual structure to his/her house and use the virtual reality device to view a virtual reality image of the house with the virtual structure added.

For example, the virtual reality device can add at least one of virtual pictures, wallpapers, patterns, frames, letters and furniture to a wall that is actually empty, and the user can observe the wall with virtual objects added using the virtual reality device.

In one embodiment, the added virtual object is displayed only on a virtual reality device that is given a predetermined privilege or a security clearance such as a password, so that it can be used to share secret information or to protect privacy of an individual.

In addition, the virtual reality device can capture at least a part of the virtual reality image or copy the object included in the virtual reality image. Virtual reality device can add captured images or copied objects to another space. For example, the user may copy at least one object from another store or another person's house or a virtual reality image displaying a virtual space or capture at least a portion of the image and add it as an interior decoration to his or her own home.

In one embodiment, the virtual reality device may be interconnected with at least one filming device equipped on an airplane. For example, a virtual reality device can display an internal image of an airplane by interconnecting with a filming device installed inside the airplane. In addition, it is possible to display an image of passengers on the airplane that have agreed to be filmed.

In addition, the virtual reality device can be used to view the scenery outside the airplane by interconnecting with the filming device installed outside the airplane. For example, a passenger in the airplane can enjoy the images filmed outside the airplane using the virtual reality device.

In addition, depending on the location of the imaging device, the virtual reality device can acquire and display the external image of the plane at various viewpoints. For example, a virtual reality device can display an image filmed at a pilot's viewpoint, or installed at the wing, top of the plane, the bottom, or a position higher than the plane, or in third person's viewpoint using a filming device tracking the airplane. The virtual reality device can provide the aerial route image using the actual filmed image by combining the filmed external image and the aerial route image of the airplane.

In one embodiment, one or more virtual reality devices may share virtual reality images with one another and view them together. For example, when a teacher wants to show a specific image to the students in a lecture, the same image can be viewed by sharing the image using the virtual reality device.

In one embodiment, the virtual reality device may record the lecture content of the teacher during class, reconstruct it as text, store, and present it. Virtual reality device is able to recognize the speech of each teacher more accurately by conducting learning based on the teacher's voice, pronunciation and other language habits.

In addition, the virtual reality device analyzes the recorded lecture contents of the teacher, and later, it can search and acquire answers corresponding to the user's question from the recorded and analyzed teacher's lecture contents to provide the answers to the user.

For example, even if a student does not understand the teacher's speech during a foreign language class, if the user asks the virtual reality device at a later time, the virtual reality device can provide the recorded teacher's speech along with the interpreted information of the teacher's speech

In one embodiment, the virtual reality device may provide a translation function. The virtual reality device acquires information about the user's voice through voiceprint analysis of the user's voice and can reproduce the translated language with the voice of the user by using the acquired information about the voice of the user.

On the contrary, the virtual reality device can use the information about the voice of another person to modulate the user's voice to another person's and reproduce or deliver it.

In addition, the virtual reality device can transmit text messages or voice between different virtual reality device wearers. For example, during class, students can use the virtual reality device to send and receive secret conversations or notes without the teacher knowing.

Furthermore, the virtual reality device can make other virtual reality device users see the virtual reality device wearer in a different state from the reality. For example, when a student wearing a virtual reality device is sleeping, a teacher wearing other virtual reality device may display a virtual reality image as if the student is listening to the class.

Likewise, a virtual reality device can remove a specific object from an actual image. For example, a virtual reality device can display a virtual reality image in which a certain person or object is removed.

Likewise, the virtual reality device can remove some tones, such as a specific song or a specific person's voice, and provide the cleared voice to the user.

In addition, the virtual reality device can quantitatively or qualitatively collect and analyze data including a student's attendance time, learning concentration, activity amount, calorie consumption, total conversation with friends, conversation contents, conversation time, relationship with friends, intimacy, and sociability. It can also generate and provide a report on the corresponding data.

In addition, the virtual reality device can change the location of the people displayed on the virtual reality image. For example, a virtual reality device can display an image where a person different from the actual person is sitting next to the wearer.

In one embodiment, the virtual reality device may display a virtual reality image that includes a map. The virtual reality device can enlarge the specific location of the map according to the user's gesture or selection input, move the virtual location to the selected location, and display the virtual reality image of the selected location. The virtual reality device can perform the navigation simulation function using the virtual reality image including the map.

In one embodiment, the navigation simulation image can be displayed rapidly like a fast-forward image. For example, when a user selects a specific destination on a map, the simulated image of moving along the route to the destination can be quickly reproduced so that the user can roughly grasp the route to the destination.

In one embodiment, the virtual reality device may display a virtual password entry screen. For example, a virtual reality device, interconnected with a password door lock, displays a virtual keypad with a random rearrangement of numbers placed on the keypad of the password door lock.

The user enters the password using a virtual keypad displayed on the virtual reality image, the virtual reality device transmits the inputted password to the door lock, and the door lock releases the lock if the received password is correct. Alternatively, the virtual reality device may transmit information on the position of each number of the randomly rearranged keypad to the password door lock, and the password door lock can obtain the password that the user presses using the rearranged positions of the keypad.

In this case, security can be maintained because the virtual keypad arrangement viewed by the user can not be known even if another person sees the user pressing the password or films with a device such as a camera.

In addition, a virtual keypad including various symbols and characters as well as numbers may be displayed irrespective of the keypad of the actual password door lock, so that the password may be entered.

In addition, it is possible to use a virtual reality device to create passwords in various patterns using not only a password but also user's hand movements or gestures. Various combinations are possible. For example, a user can restrict the shape of the hand pressing the password, or a specific hand gesture can be required after pressing the password.

In one embodiment, the virtual reality device may use multiple cameras to measure the distance to the point that the user is viewing. For example, a virtual reality device can measure the distance to a point that the user is viewing using the triangulation method. In addition, if the virtual reality device can acquire information about the actual size (e.g., the actual height of the building) of the object that the user is viewing, it can calculate the distance based on the difference between the actual size and the size seen on the image.

In one embodiment, the virtual reality device may calculate the size, height, area, or distance to the object using at least one of the one or more cameras and one or more sensors. The object may be selected by the user. For example, the virtual reality device can acquire a filmed image and calculate the size, height, area, or distance to the object of the object in the acquired film selected by the user by a gesture or voice. The types of values that can be calculated by the virtual reality device are not limited thereto, and the virtual reality device can perform various measurement and survey operations or calculation of the estimates.

Also, the virtual reality device may calculate the travel time to the point that the user is viewing based on the calculated distance, and guide the direction for travel.

In addition, the virtual reality device compares the actual size of each object included in the filmed image with the size of each object displayed on the virtual reality image, calculates the distance to each object, and adjust the contrast and color density of each object according to distance. For example, it is possible to display objects that are determined to be far as blurry and objects that are determined to be near as dark. For instance, the virtual reality device automatically determines the perspective and distance of the objects included in the image using the learned artificial intelligence, adjusts the pixels according to the perspective and distance of the object based on the result of the determination, thereby creating a virtual reality image that makes farther objects look blurry and closer objects look dark and clear. In addition, it is possible to determine the location of the sun according to the position and time of the virtual reality device, render the shadow or light angle differently depending on the location of the sun, and display the virtual reality image closer to reality. It is obvious that the above-described embodiment can be applied to various kinds of images such as VR (Virtual Reality), AR (Augmented Reality) and MR (Mixed Reality).

In one embodiment, the virtual reality device identifies at least a portion of an image filmed according to a user's gesture, recognizes an object included in the specified portion, and searches information about the recognized object to provide the results. For example, a user's gesture may include, but is not limited to, drawing a circle, or selecting a particular object by hand.

In addition, the virtual reality device recognizes the user's voice and can recognize the object corresponding to the user's voice in the captured image. For example, if it is recognized that the user is looking at one side and saying “tree”, the virtual reality device selects the object corresponding to tree in the image being filmed.

In one embodiment, when the image to be filmed includes food (e.g., agricultural products, livestock products, aquatic products, etc.), or the food is selected by the user's gesture or voice, the virtual reality device can display the recipes and the country of origin corresponding to the selected food.

For example, when the selected food is an agricultural, aquatic, or livestock product, the virtual reality device can acquire and provide information on whether the selected food is domestic or imported.

As described above, the virtual reality device displays information about the object included in the filmed image on a virtual reality image. The type of information displayed by the virtual reality device can be automatically selected by the virtual reality device or can be designated by the user. For example, even if the same food is filmed, the recipe of the food or the history of the food may be displayed according to settings.

In another example, when a historic site or a building is included in an image filmed by a virtual reality device and the object is selected by a user, the virtual reality device displays related information so that the user can study the history corresponding to the selected object.

Likewise, when the virtual reality device films specific letters in a book or on a street, the virtual reality device can search for and display information corresponding to the filmed letter. For example, if the letters “Bulguksa” are filmed and selected by the user in the virtual reality device, the virtual reality device can search and display the history of Bulguksa.

In one embodiment, the virtual reality device may be used to film the face of the first wearer in real time or use the face image of the first wearer. Then, when the second wearer wearing another virtual reality device sees the first wearer, it can remove the virtual reality device from the first wearer and display the first wearer's face where the virtual reality device is removed.

For example, the virtual reality device may transmit the face image of the filmed first wearer to a different virtual reality device or server so that on the display of another virtual reality device, it is possible to substitute and display at least a part of the first wearer's face wearing the virtual reality device with the filmed face of the first wearer.

In addition, the virtual reality device recognizes a comb, pen, brush, driver, and other tools or extensions used by the user in a filmed image and combines the recognized object with the virtual reality screen, allowing a virtual reality screen capable of assisting the user with using the tools or extensions. For example, it is possible to display a guide for facilitating use of a tool, or to display usage methods, precautions, and others. The guide may include a path through which the tool is to be moved and the location and direction where the tool is to be put.

In one embodiment, a summoning function between virtual reality device users can be implemented. For example, a virtual reality device can summon another virtual reality, with the approval of the other virtual reality device user. In this case, the virtual reality screens of the two virtual reality device users display each other.

In another example, hierarchy may exist between different virtual reality device users. For example, a parent can summon a child without approval.

In one embodiment, the summoning function may also be utilized as an invitation function. For example, a user may invite other users to a displayed virtual reality space using virtual reality device, and may view virtual reality images of the same virtual reality space in the same virtual reality space, even if they are actually in different spaces.

The invited user and the inviter user can see each other's actual images or characters (or avatars) of each other to communicate or interact with each other.

In one embodiment, when the user is singing, the virtual reality device can display the lyrics of the song the user is singing or the musical score or notes according to the user's pitch.

The virtual reality device can acquire the pitch and the beat of the music that the user is singing and compare the pitch and beat of the acquired music with the pitch and beat of the user and display the comparison result. The virtual reality device can display an image that corrects the incorrect parts in the pitch and beat that the user sings.

In one embodiment, the virtual reality device may the user's face or another person's face displayed as a different face or a edited face.

For example, the virtual reality device can display the face of another person included in the filmed image as a more beautifully edited face or replace it with another person's face.

In addition, the virtual reality device can edit the user's face more beautifully and transmit the edited information to the server or another virtual reality device so that the user of another virtual reality device can view the edited face.

For the method of editing the face, an editing algorithm, which is based on the methods used by plastic surgeons, can be used.

In addition, at least a part of the user's face can experience virtual plastic surgery, and the user can observe the plastic surgery result in the virtual reality in the third person point of view or through a virtual mirror. In other words, plastic surgery simulation using virtual reality images is possible.

In one embodiment, the virtual reality device can take a face with makeup on, create an image of the same face without makeup, and display it on the virtual reality image. For example, the virtual reality device judges the skin condition of the user without makeup based on the skin color and wrinkles of the user's neck or ear and removes color makeup to create an image of the face without makeup. This can be displayed on the image.

In addition, the virtual reality device can determine whether or not the hair of another user filmed is a wig. For example, a virtual reality device can determine whether or not another user's hair is wig based on the movement of the hair, movement of the scalp, and shape and color of the hair. The judgment result can be provided.

In one embodiment, the virtual reality device may capture the face of the user or another person, and obtain information about the physiognomy of the filmed face. Likewise, the virtual reality device can film someone's hands to acquire information about the palms of the filmed hand.

In one embodiment, the virtual reality device may film the user's skin and provide information about the user's skin disease condition and hygiene, such as a user's skin disease (atopy, infectious disease, other skin diseases, etc.) and wastes (dead skin cells).

In one embodiment, the artificial intelligence equipped on the virtual reality device is characterized, and the characterized artificial intelligence secretary can be displayed on the virtual reality image. Artificial intelligence characters can be displayed in various forms according to the user's choice. For example, a cartoon character or a celebrity can be displayed as a character of artificial intelligence.

In one embodiment, the virtual reality device can utilize artificial intelligence to assist the user's consumption.

For example, when a user desires to purchase a specific item, the virtual reality device can automatically purchase or recommend the item to be sold at the lowest price or the right price through internet search.

In addition, when a user tries to purchase a particular item or food with a previous purchase history, the virtual reality device acquires the satisfaction level of the user's previous purchase, and can give advice to the user.

In addition, the virtual reality device can recommend furniture or interior design suitable for a user's taste or that matches a theme selected by the user and can provide a recommended configuration in terms of the direction of furniture based on the feng shui. For example, if you film a house with the virtual reality device, the virtual reality device recommends furniture, electronics, and accessories that can be placed in the house, and provides information about where to place the recommended products. The virtual reality device can provide simulation information according to recommendation information.

In addition, the virtual reality device can display a simulation image of the user placing the product in the user's house when he/she selects or views a specific product.

The virtual reality device can also use a virtual reality image to acquire information about changing the design of a ready-made product or a custom-made product, and it can be used in a custom order system that transmits the acquired design information to a store.

For example, a virtual reality device displays a car on a virtual reality image, and when a user directly designs a car or selects one of the predetermined designs, information about the selected design can be transmitted to the store so that customized production can be done.

In addition, the virtual reality device can provide the user with information about sales or promotion event products. In addition, the virtual reality device can acquire the user's taste based on the information about books, movies, and concerts used by the user and can provide information (e.g., book release, movie release, etc.) according to the user's taste.

In addition, the virtual reality device can provide visibility of each seat of a concert hall, a movie theater, a baseball field, or others using a virtual reality image. For example, if a user enters a concert hall and a seat number, the virtual reality device can provide a virtual reality image of the view from the seat.

In one embodiment, the virtual reality device may recognize movement of the body, such as facial expressions, gestures, and minute muscle movements, and trembling of the voice, to determine whether the other person is lying.

In addition, various additional modules may be combined with the virtual reality device according to the present embodiments as described above. For example, virtual reality device can incorporate a variety of modules such as speakers, microscopes, alcohol detectors, and air pollution measurement modules.

Also, when a user views a virtual reality image, the virtual reality device can provide a danger signal through a color change or voice of a virtual reality image when the user approaches an obstacle in reality. For example, if an obstacle is present in front of the user, the color of the screen in the direction in which the obstacle is present may be changed to red or the screen can start blinking.

Also, when the user approaches closer to the corresponding direction, the virtual reality image display may be stopped at least in a part of the virtual reality image, and the actual image may be displayed so that the user can avoid the obstacle.

In one embodiment, the virtual reality device can recognize the sounds of the animals included in the received voice and provide information about the animals corresponding to the recognized sounds.

In one embodiment, the virtual reality device can film and recognize handwriting. The virtual reality device can analyze the recognized handwriting and analyze the personality and intellectual capacity of the writer. The information entered by experts and the data accumulated through learning may be used as the information utilized in the analysis.

Also, while the virtual reality device wearer is talking another person, the virtual reality device can analyze the language habit and the vocabulary size of the other person, and based on the analysis results, can determine the personality or intellectual capacity of that person.

In one embodiment, the virtual reality device can be interconnected with bedding, including bed or blanket. The virtual reality device can analyze the user's sleep pattern or form of sleep to determine the user's quality of sleep, fatigue, sleeping time, biorhythm or weight change. Based on the judgment results, the virtual reality device can control the temperature, wind and smell, or play music for inducing the user's sleep to create a comfortable sleeping environment.

In addition, the virtual reality device can perform a function of clearing the user's brain by using the above-described environment control function. For example, the virtual reality device can control the surrounding environment to perform functions that help to clear the brain of sleeping or learning users.

The virtual reality device can be interconnected with the IoT system or the IoT device to control the environment of the user's sleeping environment by controlling the air conditioner, fan, and TV.

In addition, the bedding interconnected with the virtual reality device or the virtual reality device itself can be equipped with at least one module used for various purposes such as alarm function using vibration or sound, radio function, function for generating sound waves helping sleep, temperature control function, and wind and smell generating function. In addition, the bedding interconnected with the virtual reality device or the virtual reality device itself is equipped with at least one waterproof sensor in order to sense the humidity of the bedding, the dampness, or the presence of ticks to determine the washing time of the bedding.

In addition, each person's body shape and constitution are different, and body temperature depends on time zone and health condition. So, the virtual reality device can measure the bed temperature and judge the physical constitution, physical condition, and health condition of the user, and provide the optimal sleep environment according to the judgment result.

In addition, the virtual reality device can be utilized to create a suitable sleeping environment for the user by analyzing the user's health, illness, and other physical constitution.

In one embodiment, the virtual reality device may additionally include at least one camera or a sensor equipped behind the wearer's head.

The virtual reality device detects a dangerous situation using at least one camera or one sensor equipped behind the wearer's head. When a dangerous situation is detected, the virtual reality device displays an image filmed by a camera provided behind the wearer's head. For example, when a car is coming from behind a wearer, the virtual reality device can display an image filmed by a camera provided behind the wearer's head on the virtual reality screen.

In addition, when a user is playing a game using the virtual reality device according to the disclosed embodiment, it is possible to provide virtual reality images at various points of view using at least one camera equipped behind the user's head.

In one embodiment, in order to reduce the capacity of the virtual reality image and to reduce the load of the system required to display the image, the virtual reality device can reproduce or render only the portion included in the view of the user in the 360-degree image, and the remaining part can be paused or not displayed.

In one embodiment, the virtual reality device can process images differentially according to the range of view. For example, it can be assumed that there is a first range of view that the user can view and a second range of view that is within the user's field of view but the user is not looking. Since the range of the view may be different for each person, the second range of view may include a certain range beyond the user's field of view.

In one embodiment, the virtual reality device determines the perspective and distance between objects in an image based on a visual line of the user looking at an image. According to the judgment results, pixels can be adjusted so that closer objects can appear clear, and farther objects can appear blurry.

At this time, the virtual reality device allows the virtual reality image included in the first field of view to be displayed with sufficient movement and rendering, and for virtual reality image included in the second range of view to be displayed by decreasing the movement and rendering of the image all together collectively or in decreasing order in the direction away from the field of view.

In this case, the load on the memory and the system can be greatly saved, but the virtual reality image should shift naturally according to the changes in the user's gaze so that the user does not feel any discomfort and naturally appreciate the virtual reality image.

FIG. 122 is a diagram for explaining the method of compositing an object and a background according to an embodiment.

In one embodiment, a different background 9100 and an object 9200 may be composited to produce a virtual reality image.

Here, since the background (9100) and the object (9200) are different in light source from each other, the perspective methods are different from each other, the color density and contrast are different, and the reference size is different, it is possible to feel displacement in the object composited with the background.

Accordingly, the virtual reality device automatically adjusts the density and contrast, the direction of the light, the position and length of the shadow, and others of the background (9100) and the object (9200), so that the background (9100) and the object (9200) can be composited naturally without any sense of displacement.

In one embodiment, when adding an object (9200) to a background (9100), the virtual reality device may determine the intensity and contrast, the direction of light, and the position and length of the shadow of the object (9200) based on the background (9100) as a standard, so that the object (9200) can be composited naturally without any sense of displacement within the background (9100).

In addition, the virtual reality device converts the real image including the background (9100) and the object (9200) into a digital image, so that a composited video can be rendered to reflect changes in the surrounding environment according to time such as sunlight, light, and shadow.

In addition, the virtual reality device can add a blur effect to a boundary line (9300) existing between the background (9100) and the object (9200) to be blurred like mist or adjust the color of the boundary line so that the boundary line (9300) is invisible in order to naturally composite the background (9100) and the object (9200).

In addition, the virtual reality device may perform an out-focusing function by displaying an object (9200) displayed on the virtual reality image clearly and blurring the background (9100) excluding the object (9200).

The steps of algorithms or methods described in relation to the embodiments of the present invention may be implemented directly by hardware, by software modules executed by hardware, or by a combination of the two. The software module may reside in Random Access Memory (RAM), Read Only Memory (ROM), Erasable Programmable ROM (EPROM), Electrically Erasable Programmable ROM (EEPROM), Flash Memory, hard disk, removable disk, CD-ROM, or any form of computer readable recording medium that is well-known in the field of technology of the present invention.

Although the present invention has been described with reference to the desirable embodiments, as explained above, those skilled in this particular field of technology will appreciate that various modification and changes are possible without departing from the scope and spirit of the present invention as defined in the following claims.

1-58. (canceled)

59. A foldable virtual reality device, comprising:
an ocular plate which is capable of maintaining a variable distance from a main body including a virtual reality display;
a screen member interposed between the main body and the ocular plate that moves the ocular plate between a separation state that maintains a predetermined distance and a close-contact state in which the ocular plate is in close contact with the main body; and
a casing for containing the main body so that the main body is detachable,
wherein the screen member is an air tube, whose shape can be changed so that the ocular tube can move to the close-contact state or the separation state via the flow of air, and
wherein virtual reality function can be implemented by the display of the main body if the ocular plate is in the separation state.

60. The foldable virtual reality device of claim 59, wherein the screen member includes a bi-way pump to automatically let air in and out.

61. The foldable virtual reality device of claim 59, wherein the screen member can form the space between the display and the screen member as a closed tube space so that the screen member can expand and contract.

62. The foldable virtual reality device of claim 59, wherein the screen member is formed in a double wall structure and an inner space is formed as a closed tube space to expand or contract.

63. The foldable virtual reality device of claim 59, wherein the screen member forms a frame-shaped air way space into a closed tube space to expand or contract.

64. The foldable virtual reality device of claim 59, wherein the screen member is provided in a shape of binoculars separated by left and right, and the ocular plate is also provided independently from the right and left in correspondence with the separated screen member.

65. A foldable virtual reality device, comprising:
an ocular plate which is capable of maintaining a variable distance from a main body including a virtual reality display;
a screen member interposed between the main body and the ocular plate and which moves the ocular plate between the separation state that maintains a predetermined distance and a close-contact state in which the ocular plate is in close contact with the main body;
a fixed member that includes a horizontal band that extends from a side of the main body or the ocular plate and a central band that is extended from the central portion of the ocular plate or the main body to be partially fixed on a horizontal band; and
a protective case frame for containing the main body so that the main body is detachable,
wherein virtual reality function can be implemented by the display of the main body if the ocular plate is in the separation state.

66. The foldable virtual reality device of claim 65, wherein ends of the center bands branch in a Y-shape to form a first branch line and a second branch line, and ends of the branched first branch line and the second branch line are each fixed to the horizontal band.

67. The foldable virtual reality device of claim 66, wherein the center band includes at least one tension line that transversely connects the first branch line and the second branch line.

68. The foldable virtual reality device of claim 65, wherein the screen member includes multiple screen boxes which overlap on each other and slide-move to the rear and fixed.

69. The foldable virtual reality device of claim 65, wherein the horizontal band and the center band are embedded in the main body or the ocular plate and then drawn out.

70. A foldable virtual reality device, comprising:
an ocular plate which is capable of maintaining a variable distance from a main body including a virtual reality display and can move between a close-contact state with the main body including the virtual reality display and a separation state maintaining a predetermined distance;
a screen member that includes a first sectional body that connects the main body with a section of the ocular plate and a second sectional body that connects the main body with another section of the ocular plate; and
a protective case frame for containing the main body so that the main body is detachable,
wherein the main body, first sectional body, ocular plate, and second sectional body consecutively connect to form a closed folding structure,
wherein when the ocular plate is in close-contact mode, insides of the main body, first sectional body, ocular plate, and second sectional body are in close-contact with one another to maintain a flat shape, and
wherein when the ocular plate is in a separation mode, the main body, first sectional body, ocular plate, and second sectional body form a quadrangular column to maintain a three-dimensional shape, but the virtual reality device can implement virtual reality function through the display of the main body.

71. The foldable virtual reality device of claim 70, wherein the screen member further includes a folding cover for blocking the plane and the bottom surface of the opened quadrangular column in a separation state.

72. The foldable virtual reality device of claim 70, wherein at least one of the first sectional body and the second sectional body has a speaker, supplementary display, or a keyboard installed.
